(19) United States
(12) Patent Application Publication
(10) Pub. No.: US 2010/0010912 A1
(43) Pub. Date: Jan. 14, 2010

(54) METHOD AND SYSTEM OF FACILITATING A PURCHASE

(75) Inventors: Scott A. Jones, Carmel, IN (US); Thomas E. Cooper, Indianapolis, IN (US); Steven M. Kremer, Carmel, IN (US)

Correspondence Address: STAAS & HALSEY LLP, SUITE 700, 1201 NEW YORK AVENUE, N.W., WASHINGTON, DC, 20005, US

(73) Assignee: ChaCha Search, Inc., Carmel, IN (US)

(21) Appl. No.: 12/500,327

(22) Filed: Jul. 9, 2009

Related U.S. Application Data
(60) Provisional application No. 61/079,647, filed on Jul. 10, 2008.
(60) Provisional application No. 61/082,001, filed on Jul. 18, 2008.

(51) Int. Cl. G06Q 30/00

(52) U.S. Cl. 705/26

(57) ABSTRACT

A system and method of facilitating a purchase including using assistance of a search service and redacting data is described. A user may link an account of a search service with an account of a vendor and may use the linked accounts to purchase an item and/or service from the vendor. A human assistant may select information of an item and/or service from a vendor associated with a user and may provide information of the item to the search system in order that an offer for the item and/or service may be provided to a user and a purchase of the item and/or service may be completed by the user.

### CROSS-REFERENCE TO RELATED APPLICATIONS

This application is related to and claims the benefit of U.S. patent application Ser. No. 12/275,864, Attorney Docket No. 1918.1034, inventor Scott A. Jones, et al., titled “METHOD AND SYSTEM FOR IMPROVING UTILIZATION OF HUMAN SEARCHERS”, filed Nov. 21, 2008; and, U.S. patent application Ser. No. 12/472,962, Attorney Docket No. 1918.1052, inventor Scott A. Jones, et al., titled “METHOD AND SYSTEM OF IMPROVING SELECTION OF SEARCH RESULTS”, filed May 27, 2009; and, U.S. patent application Ser. No. 12/434,385, Attorney Docket No. 1918.1036, inventor Scott A. Jones, et al., titled “METHOD AND SYSTEM FOR IMPROVEMENT OF REQUEST PROCESSING”, filed May 1, 2009; and, U.S. patent application Ser. No. 11/835,016, Attorney Docket No. 1918.1014, inventor Scott A. Jones, et al., titled, “ELECTRONIC PREVIOUS SEARCH RESULTS LOG”, filed Aug. 7, 2007. In addition, this application is related to and claims the benefit of U.S. Provisional Application Ser. No. 61/079,647, Attorney Docket No. 1918.1058P, inventor Scott A. Jones, et al., titled “METHOD AND SYSTEM FOR HUMAN ASSISTED SEARCH OF REDACTED INFORMATION”, filed Jul. 10, 2008; U.S. Provisional Application Ser. No. 61/082,001, Attorney Docket No. 1918.1057P, inventor Scott A. Jones, et al., titled “METHOD AND SYSTEM FOR FACILITATING A PURCHASE”, filed Jul. 18, 2008, the contents of which are incorporated herein by reference.

### BACKGROUND

1. Field of the Invention

The present invention is related to search system(s) including human-assisted search system(s), and more specifically to systems for assisting a user to make a purchase. A method and system for facilitating a purchase via an affiliated merchant is disclosed.

2. Description of the Related Art

Search systems may be used to obtain information regarding a purchase of a product and/or service. A user of a search system may be presented with information of a URL, etc., which may allow a user to access information provided by a supplier of an item and/or service. Automated systems have been developed whereby a user may access information regarding available items for purchase from multiple suppliers. For example, web services such as those provided by the Expedia® service for travel, or the Ebay® service for auctioning of item and/or the Amazon® shopping services allow a user to browse and/or purchase item(s) which are provided by individuals and/or entities. Such systems have helped to create an electronic marketplace for diverse products and services.

However, such systems may have a weakness as a user of the system may be unable to access full site functionality due to various reasons. For example, a user of a mobile device may be constrained by bandwidth, display and/or other capabilities. In addition, a user may be unfamiliar with features and/or suppliers of a product and/or service. In such instances, a vendor of a product and/or service may miss an opportunity to sell a product, and/or a user may make a poor buying decision due to the inability to access relevant information relating to a purchase.

A user may have already established an account with a supplier of product and/or service but due to limited functionality of a user device, or unfamiliarity with a product and/or service, a user may be unable to make a purchase from a supplier. Likewise, a user may have established an account with a search service, and may receive information of a products and/or services via the search service, but may be unable to make a purchase using the search service.

In light of this, a method and system of making a purchase including with the assistance of a human assistant or guide by linking a user account with a supplier of an item and/or service with a user account with a search service would be greatly appreciated.

### SUMMARY

A method and system are disclosed to facilitate a purchase including by providing a human assistant who may be able to make a purchase on behalf of a user if the user is registered with a search system and a vendor. A user may submit a request for information, which may be determined to include a request to make a purchase.

These together with other aspects and advantages which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of a system embodiment.

FIG. 2 is a flowchart of a process of associating a search system user account with a vendor system user account.

FIG. 3 is a flowchart of a process of facilitating a purchase.

FIG. 4 is a GUI for registration of a user with a vendor via the search system.

FIG. 5 is a GUI for registration of a user with the search system via a vendor system

FIG. 5A is a GUI for registration of a user with the search system via a vendor system

FIG. 6 illustrates a database record for a request

FIG. 7 illustrates a database record for a purchase.

FIG. 8 illustrates a database record for a user.

FIG. 9 illustrates a database record for a guide.

FIG. 10 illustrates a database record for an advocate.

FIG. 11 illustrates a database record for a vendor.

FIG. 12 illustrates a database record for a user.

FIG. 13 illustrates an exemplary purchase transaction sequence.

FIG. 14 illustrates a user GUI.

FIG. 15 illustrates a message flow diagram for an embodiment.

FIG. 16 is a block diagram of an exemplary system embodiment.

FIG. 17 is a flowchart of a process of creating and editing a database of redacted information.

FIG. 18 is a flowchart of a process for performing a search of redacted information by a guide.

FIG. 19 illustrates a database record for a user.

FIG. 20 illustrates a database record for a guide.

FIG. 21 illustrates a database record for a request.

FIG. 22 illustrates a database record for a redacted data source.

FIG. 23 illustrates a database record for a search result which includes redacted information.

FIG. 24 illustrates a graphical user interface (GUI) for designating information to be included in a redacted information repository.

FIG. 25 illustrates a GUI for identifying information which is to be redacted.

FIG. 26 illustrates a GUI for identifying information which is to be redacted.

FIG. 27 illustrates a GUI for performing a search.

FIG. 28 illustrates a message flow associated with a search which includes redacted information.

FIG. 29 illustrates a database relationship.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate.

A system is provided which allows a user or InfoSeeker™ who may be any person to submit a search request or search query or request to a search service and receive a response to the search request. A system which allows communication to occur between a user, a guide or human assistant, a resource, an advocate or human purchase assistant, a vendor and/or the search system allows requests to be processed. A database comprising information regarding a user, a guide, an advocate, a vendor, a resource, a request, a purchase, a profile, a taxonomy, rating and ranking information, etc. is provided.

A request submitted by a user may receive a response which is produced automatically and/or utilizing assistance of one or more human searchers or guides. In at least one embodiment, a request submitted by a user is compared to a database of request in order to determine if a matching request is found in the database. If a matching request is found, a result associated with the matching request may be presented to a user responsive to a request).

A user may register with the search system, and may create an account with a provider of product and/or service or vendor. A user account of a search system may be associated with a user account of a vendor. Information of a user account with a vendor may be provided to a search system in order that a user may make a purchase with the vendor using the services of a guide and/or an advocate associated with the search system. A guide may determine that a user request includes intent to purchase an item and/or service. Information of a request may be provided to an advocate, who may also be a guide. If a user has been associated with a vendor, an advocate may identify an item and/or service which may be purchased from a vendor and may provide information of the item to the search system. The search system may confirm an offer with a vendor, and may provide information of the offer to a user responsive to a user request. If a user elects to accept an offer, the search system may confirm a purchase with a vendor and may provide information of the purchase to the user.

A user may be provided with a user interface which allows the user to review purchase(s) and/or other request(s) associated with a search system which may allow a user to make a purchase using a first device or service associated with the user, and review information of the purchase using a different device. As multiple communication services may be associated with a user of a search service, a user may make a purchase using any of the services.

A vendor or supplier may be any entity or person that provides a product, information and/or service, including in association with an account data or other identifier of a user.

A method and system are disclosed to facilitate a purchase including by providing a human assistant who may be able to make a purchase on behalf of a user if the user is registered with a search system and a vendor. A user may submit a request for information, which may be determined to include a request to make a purchase. For example, a user might submit a request regarding a type of product, which might indicate intent to purchase a product. A human assistant who may be selected to assist with an information search or ‘guide’ may be provided to respond to a user request. A number of human assistants with relevant knowledge regarding an item and/or service or ‘advocates’, who may or may not be guides, may be identified to respond to a user request. A user is registered with a search system. A user may provide information to the search system regarding a user account with a provider of goods and/or services or ‘vendor’ or ‘supplier’. A user may provide information of one or more communication services associated with the user, which may be linked to a user account associated with a vendor. Alternately, a search system may establish an account with a vendor on behalf of a user.

If a request is received, a unique identifier may be associated with the request and with a user submitting the request. A determination is made as to whether a request includes an indication of the intent to purchase an item and/or service. An advocate, who may facilitate a purchase is selected based at least in part on information indicated in a database which may include information of advocates, users, guides, requests, vendors, resources, etc. An advocate may provide information of a user request to a vendor using a resource provided by the vendor which is accessible using the search system, but which may not be a public resource. A search system may track activities associated with an advocate and/or a guide, and may provide compensation to an advocate and/or a guide based on activity associated with the advocate and/or the guide.

A guide and/or advocate may provide information of an offer for a product and/or service which is available from a vendor, which may be tendered to a user. If a user accepts an offer, a purchase may be made using fulfillment information provided to a vendor by the user based on an identifier of the user which is provided by a search system. Transactions associated with a search system may be tracked using a unique ID associated with a user of the search system and a unique ID of the user associated with a merchant. A search service may be compensated at least in part based on transactions facilitated by the search service. A common identifier shared between a search service and a vendor allows a user of the search service to effect a transaction using the assistance of a knowledgeable person who is provided on an ad hoc basis. A user may access a vendor easily without the need to supply duplicate information to multiple vendors. Purchase and query history and confirmation may be provided which may be used for various purposes.

As a guide or human assistant is involved in making a purchase, it is important that user payment information is not exposed to a guide during the transaction process. A user may provide information to a search service which is associated with a user account and with a vendor which is not exposed to a guide. For example, a user may provide a username and password for an account already established with a vendor to a search service. A guide might locate an item to be purchased and place the item in a checkout ‘shopping basket’ responsive to a user approval. Subsequently a purchase of item(s) associated with a shopping basket designated by a search service and/or a guide may be confirmed using an automated exchange between a user, a vendor system and/or the search service. Alternately, a purchase may be effected by the search service using payment and fulfillment information supplied by a user to the search service which may be used to establish an account with any vendor which is known by the search service.

An interface may be provided by the search service which allows a guide to browse a vendor website and/or other information system which may permit limited access to feature(s) of the purchase system. A search system may, for example, receive a formatted page from a vendor, and provide a subset of that information to a guide which allows the guide to make a selection and otherwise act on behalf of a user. After a guide indicates that a purchase is ready to be confirmed by a user, automated message(s) which may expose precise details of the purchase as needed may be exchanged between a user and the search system. If at any time it is determined that a guide may be needed to facilitate an exchange between a user and the search system, a suitable guide may be selected by the search service. In this way, a user may access purchasing service(s) using any communication services available, but may affect a purchase in a secure environment which also allows a human assistant to participate.

A guide or advocate may be associated with a vendor, and may be able to make a purchase using a vendor system based on information of a user which is stored by the vendor. Purchase information controlled by a vendor may or may not be exposed to an advocate associated with a vendor. In such an embodiment, a guide or an advocate may have an account with a vendor system whereby an advocate may make a purchase using a standard user interface to the vendor system. A purchase or shopping cart item(s) associated with the advocate account is redirected to the account information of a user which is delivered to the vendor system responsive to a confirmation message from the user. In this way, full site functionality is available to the guide, and a modification to the vendor system is associated with receipt of identifying information of a user account and an alias account associated with the advocate. Such a modification is mainly associated with the ‘back-office’ process rather than the user-facing elements of a vendor system.

The terms voice and speech are used interchangeably herein. A user, a resource, an advocate, a vendor, and/or a guide may establish a communication session using a voice service, a messaging service such as Short Messaging Service (SMS), Enhanced Messaging Service (EMS), Multi-media Messaging Service (MMS), Instant Messaging (IM), email, an internet portal or web page, a web service, an API, regular mail or any other type of communication. A connection may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session. A landline phone, a specialized communication terminal, or any other communication device might be used to establish a communication session.

Communication between a guide, a user, a resource, an advocate, a vendor and/or a search system may include conversion of text to speech and speech to text, or other types of information conversion. Any type of media which can be sent or received using a communication system may be part of a communication session. A communication session may be conducted using any or all communication service associated with a user, a resource, an advocate, a vendor and/or a guide.

A resource, a guide, an advocate, and/or a vendor may be rated. Rating information may be obtained from a user, a guide, an advocate, a vendor and/or a search system. Rating information may be used to select a resource, a guide, an advocate, a vendor and/or any item based on information associated with an item indicated in a database. The search service may be compensated by advertising revenue, and/or by payments from a user, an advocate, a vendor and/or a guide.

A “user” is any person or entity which may submit a request or search request. A “request” or “search request” or “query” is any request for information which may be originated by a person and/or a device or system. A user may be referred to as a “requester”, information seeker or InfoSeeker™.

A “guide” is any person who may be compensated and/or may be a volunteer who may respond to and/or assist with a request. An “ambassador” is a guide who may perform processing of a request and/or a search result. A “searcher” is a guide who may perform an information search responsive to a request. A “transcriber” who may also be a guide may convert a spoken portion of a request into text, and/or may otherwise convert information of a request from one form to another. A guide may be referred to as a “human assistant” or “human searcher” or “searcher”. A guide may perform any type of task. Any guide may act in any defined guide role. However, a human assistant who performs a task and a guide who conducts a search may not necessarily be the same. For example, a human assistant may perform a task to facilitate a search which is conducted by another person who is registered as a guide.

An “identifier” or ID may include character, number and/or other type of information which may be used to identify an item including item of a database. Items may include but are not limited to a guide, a user, a resource, an advertisement, a keyword, a category, a search result, a search request, a query, a rating, ranking, a message and/or a profile. A “guided request” is a request which uses the assistance of one or more guides.

A “result” or “search result” or “answer” is any information which may be provided responsive to a request. A result includes, but is not limited to, any of an advertisement, a link to a web page, a message of any sort, image, audio, text, games, interactive media and/or software of any sort.

A “search resource” or “resource” is any source of information which may be used to obtain a search result. A search resource includes automated and/or human-assisted systems, any repository of information, and any type of media and/or systems which may provide information. A resource may be a provider or source of item and/or service. For example, a resource might provide an item such as a ringtone, a media file (e.g., audio, video, images, games, etc.), information such as news, lyrics, song titles, translations or any other type of information. A resource may be automated, and/or may utilize the assistance of a person.

A “profile” is one or more characteristics which may be associated with a person. Profile characteristics include but are not limited to demographic, geographic, personality, affiliations, areas of interest, historical actions, preferences, memberships, associations, etc.

An “advertisement” is any information which may be delivered to a user including to promote a provider, a product, a service, etc. An advertisement may include text, links, audio, video, images, printed materials, interactive media such as a game, or other forms of media which may be provided to a user device.

A “category” or “taxonomy branch” or “categorization” is a unique node within an index which may be associated with any number of items. If a request is associated with a category, items associated with the category may be more likely to be selected responsive to the request.

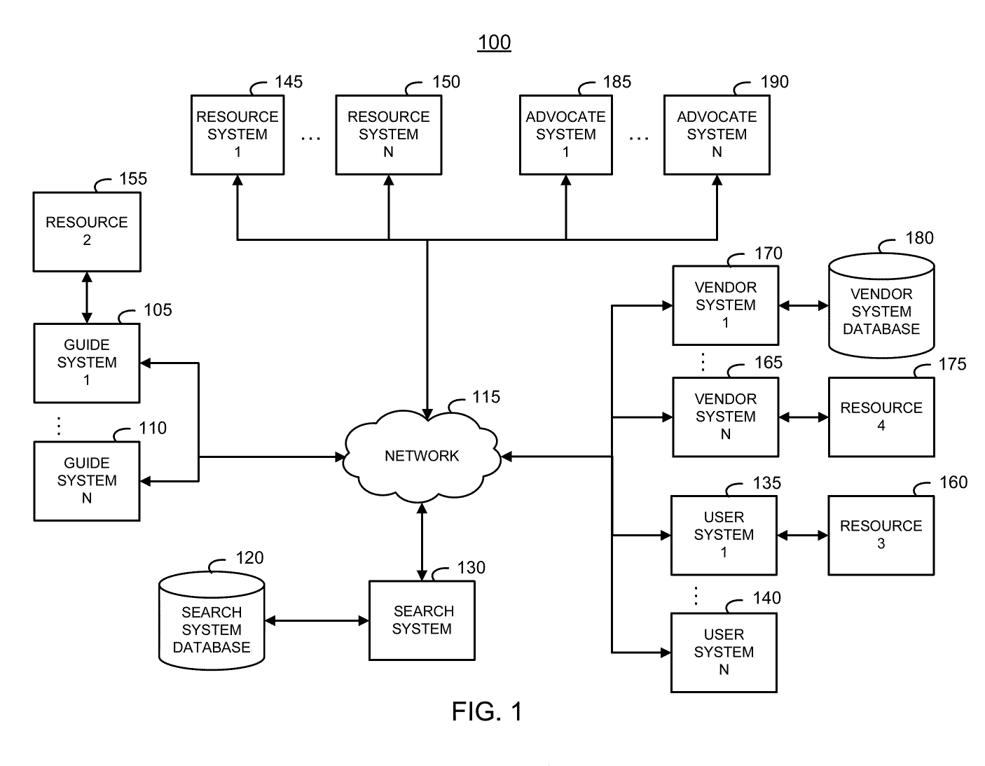

As illustrated in FIG. 1, a system 100 includes guide systems 105, 110, a network 115 such as the Internet, a search system 130, user systems 135, 140, a search system database 120, which may comprise various records, resources systems 145, 150, resources 155, 160, 175, vendor systems 165, 170, a vendor system database 180, and advocate systems 185, 190.

While only a limited number of systems associated with a guide, user, resource, vendor, and advocate and as a search system are depicted in FIG. 1, it is within the scope of the disclosure for multiple systems for guide, resource, user, vendor, advocate and search systems to be utilized. Further, any or all of the system(s) may be integrated and provided as a single system. For example, a resource system may be incorporated with that of the search system.

Any user system (e.g., the user systems 135, 140) can be operated by a user, who may be a person, to submit a request to the search system 130 and/or receive a search result and/or other information. Any guide system (e.g., the guide systems 105, 110) can be operated by a guide to obtain a search result for an information seeker located at a user system (e.g., the user systems 135, 140). Any resource system (e.g., the resource systems 145, 150) may be operated by a human provider of information and/or may be an automated system which may provide a result and/or other information to a guide and/or a user, such as a search engine, a database, a system which may perform tasks such as image recognition, voice recognition, translation, transcription, or other forms of information processing, a local information source of a guide system such as a disk or removable memory, an application and/or database accessible from a user system, and/or a guide system, etc. A resource may not be accessible using the network 115. For example, a resource such as the resource ‘Resource 2’ 155 may be accessible to a guide operating a guide system such as the guide system 105, or a resource such as the resource ‘Resource 3’ 160 may be accessible to a user operating a user system such as the user system 135, or a resource such as the resource ‘Resource 4’ 175 may be accessible to a vendor operating a vendor system such as the vendor system ‘Vendor System N’ 165. A resource might include printed materials, images, video, and/or audio information, a software application, any information accessible to a guide, a vendor, an advocate, and/or a user, a database, and/or any combination thereof.

The network 115 may be a global public network of networks (the Internet) and/or consist in whole or in part of one or more private networks and communicatively couples the guide systems 105, 110 the resource systems 145, 150 the advocate systems 185, 190 the vendor systems 165, 170 and the user systems 135, 140 with the other components of the system 100 such as the search system 130, the search system database 120, and the vendor system database 180. For example, a private network might be provided to enable secure communication between a vendor system such as the vendor system 170 and other elements of the system 100, such as the search system 130, and the advocate systems 185, 190. The network 115 may include one or more wireless networks which may enable wireless communication between the various elements of the system 100. For example, a mobile phone carrier network might be used to connect a user device to the search system 130.

The search system 130 allows interaction to occur among the guide systems 105, 110, the resource systems 145, 150, the vendor systems 165, 170, the advocate systems 185, 190 and the user systems 135, 140. For example, an information search query can be transmitted from the user systems 135, 140 to the search system 130, where a search query can be accessed by the guide systems 105, 110 and/or the resource systems 145, 150. Similarly, a result produced from the resource systems 145, 150 including results produced by search(es) using the guide systems 105, 110 in response to a search query submitted by the user systems 135, 140 may be transmitted to the search system 130, where it may be stored by the search system 130 and/or may be transmitted to the user systems 135, 140.

The search system 130 is communicatively coupled with the search system database 120. As will be described herein in further detail below, the search system database 120 includes data that is processed in association with operation of the embodiments. Although FIG. 1 illustrates the search system database 120 as a separate component of the system, the search system database 120 may be integrated with the search system 130. Further, the records maintained in the search system database 120 may be stored in any typical manner, including in a Network Attached Storage (NAS), a Storage Area Network (SAN), etc. using any typical or proprietary database software such as DB2®, Informix®, Microsoft® SQLServer™, MySQL®, Oracle®, etc., and may also be a distributed database on more than one server. Elements of the search system database 120 may reside in any suitable elements of the system 100. The vendor system database 180 may be composed of similar storage elements and is communicatively coupled with the vendor system 170. While a single vendor system database is depicted connected to a single vendor system, it is envisioned that multiple vendor systems which may be associated with corresponding vendor system databases and/or resources may be utilized.

The user systems 135, 140, the guide systems 105, 110, the search system 130 the resource systems 145, 150, the vendor systems 165, 170, and the advocate systems 185, 190 may include equipment, software, systems and personnel required to send and/or receive message(s) between a user system, a guide system, a resource system, a vendor system, an advocate system and/or the search system using the network 115. The search system database 120 includes information which may allow the search system 130 to establish communication between the other elements of the system 100.

A user system, a guide system, an advocate system, a vendor system and/or a resource may be a desktop or mobile PC or Mac®, a mobile phone, a smart phone, a PDA, a server system, a landline phone, a specialized communication terminal, a terminal connected to a mainframe, or any other communication device and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco®, or other networking companies. After being presented with the disclosure herein, one of ordinary skill in the relevant art will immediately realize that any viable computer systems and/or communication devices known in the art may be used as user systems, guide systems, vendor systems, advocate systems, resources, and/or to implement the search system 130.

A guide may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 105 in order to communicate with the search system 130. Multiple communication services may be associated with a guide and may allow a communication session to be established between a guide system such as the guide system 105 and a user system, a resource system, a vendor system, an advocate system and/or the search system 130. Multiple identifiers of a guide may be associated with each other. Information such as IM credential, an email address, a phone number, a URL, a username, etc. of a guide may be identified which may allow the search system 130 to establish a communication session between a guide system, an advocate system, a vendor system and a user system, a resource system, and/or the search system 130.

When a guide registers with the search system 130 the guide may be associated with one or more keywords, categories, and/or other information. For example, a keyword or category may be selected by a guide, or may be associated with a guide based on a test administered to a guide and/or other information provided during and/or after a registration process. Information associated with a guide may be stored in the search system database 120 and may be used for purposes such as matching a guide to a user request, determining and/or providing compensation for a guide, communicating with a guide, etc. as will be described further herein below. In at least one embodiment, an account may be established with a vendor system associated with a guide.

An advocate may be required to register with the search system 130. As part of a registration process, at least one communication method is associated with an advocate. In at least one embodiment, an advocate may register with the search system 130 and establish a username and password which are associated with the advocate using a browser functionality of the advocate system 185. An advocate may login to the search system 130 using a web browser functionality of the advocate system 185 in order to communicate with the search system 130. Multiple communication services may be associated with an advocate and may allow a communication session to be established between an advocate system such as the advocate system 185 and a user system, a resource system, a vendor system, a guide system and/or the search system 130. Multiple identifiers of an advocate may be associated with each other. Information such as IM credential, an email address, a phone number, a URL, a username, etc. of an advocate may be identified which may allow the search system 130 to establish a communication session between an advocate system and a user system, a resource system, a guide system, a vendor system and/or the search system 130. In at least one embodiment, information of an advocate may be provided by a vendor system, such as the vendor system 170, based on information indicated in for example the vendor system database 180. In at least one embodiment, login account information associated with an advocate may be provided to the search system 130 when an advocate is registered with the search system 130.

When an advocate is registered with the search system 130 the advocate may be associated with one or more keywords, categories, and/or other information. For example a keyword or category may be selected by an advocate, or may be associated with an advocate based on a test administered to an advocate and/or other information provided during and/or after a registration process. Information associated with an advocate may be stored in the search system database 120 and may be used for purposes such as matching an advocate to a user request, determining and/or providing compensation for an advocate, communicating with an advocate, etc. as will be described further herein below. An advocate may be the same as a guide in certain cases.

A vendor may be required to register with the search system 130. As part of a registration process, at least one communication service is associated with a vendor. In at least one embodiment, a vendor may register with the search system 130 and establish a username and password which are associated with the vendor. A vendor may login to the search system 130 using a web browser functionality of the vendor system 170 in order to communicate with the search system 130. Multiple communication services may be associated with a vendor and may allow a communication session to be established between a vendor system such as the vendor system 165 and a user system, a guide system, an advocate system, a resource system and/or the search system 130. Multiple identifiers of a vendor may be associated with each other. Information such as IM credential, an email address, a phone number, a URL, a username, etc. of a vendor may be identified which may allow the search system 130 to establish a communication session between a vendor system and a user system, a resource system, a guide system, an advocate system and/or the search system 130. In at least one embodiment, information of a vendor may be determined by a guide, an advocate, and/or a user. For example, an advocate may identify information of a vendor which may allow communication to be established with the vendor even though the vendor may not have registered with the search system 130.

When a vendor is registered with the search system 130 the vendor may be associated with one or more keywords, categories, and/or other information. For example a keyword or category may be selected by a vendor, or may be associated with a vendor based on a test administered to a vendor and/or other information provided during and/or after a registration process. For example, if an advocate associated with a category utilizes a vendor to complete a purchase for a user the vendor may be associated with the category and may be rated and/or ranked in association with the category. Information associated with a vendor may be stored in the search system database 120 and may be used for purposes such as matching a vendor to a user request, determining and/or providing compensation for a vendor, communicating with a vendor, etc. as will be described further herein below.

A user may be identified by the search system 130 (FIG. 1). When a user system such as the user system 135 establishes a communication session with the search system 130, an identifier of a user system is determined. An identifier of a user system may be associated with other information regarding a user. A user system may be identified using an email address, a telephone number, an IM credential, a username, or any other identifier which may be used to associate information with a user. Multiple identifiers of a user may be associated with each other. Using information of communication services associated with a user, a communication session may be established between a user system such as the user system 135 and a guide system, a resource system, an advocate system, a vendor system and/or the search system 130. Information such as a keyword, a category, a user profile, a previous search request, a search result, etc. may be associated with a user. Information of a user may be stored in the search system database 120.

A resource, which may be a person, an entity, a search engine, a database, a software application, a corpus of one or more types of media such as text or printed information, images, audio, video, etc. or a combination thereof, may be identified by the search system 130. Information of at least one method of communication is associated with a resource system which allows a communication session to be established between the search system 130, a user system, a vendor system, an advocate system and/or a guide system and a resource system such as the resource systems 145, 150. An identifier of a resource system may be associated with other information regarding a resource. A resource system may be identified using an email address, a telephone number, an IM credential, a resource username, a URL or other persistent identifier which may be used to associate information with a resource. Multiple identifiers of a resource may be associated with each other. Using the information of communication services associated with a resource, a communication session may be established between a resource system such as the resource system 145 and a user system, a guide system, and/or the search system 130. Information such as a keyword, a category, a profile, or other information may be associated with a resource. Information of a resource may be stored in the search system database 120.

A resource such as the resource 155, the resource 160, the resource 175 and/or resources accessible via the resource systems 145, 150 may include any system, software, hardware, personnel and/or other facility which may provide information to a guide, a user, an advocate, a vendor and/or the search system 130. For example, a resource may be a search engine, a database system, a library, a personal hard drive and/or other local storage, printed materials, recordings of any sort, a software program, a person or person, an organization, etc. A resource may be freely accessible to any user, advocate, vendor and/or guide and/or may be available on a restricted basis. The resource system 145, 150 may include resources which are available on an unrestricted and/or restricted basis. A resource may not be accessible using the network 115, but may be accessible to a guide, an advocate, a vendor and/or a user. For example, a resource such as the resource 155 may be accessible to one or more guide operating a guide system such as the guide system 105 using any type of communication. For example, a guide may obtain information of an event to provide a search result. Information in any form, such as printed media, audio and/or visual information, software, hardware, etc. which may be accessible to a guide, a user, an advocate, a vendor and/or an operator of a resource system may be a resource. Similarly, a resource such as the resource 160 may be accessible to a user at the user system 135. For example, the resource 160 may be a software application and/or database which may in whole or in part be accessible by the user system 135 or a resource such as the resource 175 may be accessible to a vendor at the vendor system 165. For example, the resource 175 may be a software application and/or database which may in whole or in part be accessible by the vendor system 165. A resource which is not generally accessible to devices associated with the network 115 may be used by the respective systems which are communicatively coupled with the resource for selectively providing a search result mediated by the controlling system.

The search system 130 may establish a communication session between any user system, guide system, advocate system, vendor system or resource system using information indicated in the search system database 120. For example, the user system 135 may establish a voice communication session with the search system 130, the search system 130 may establish a voice communication session between the user system 135 and the guide system 105, and the search system 130 may establish a voice communication session between the user system 135 and the resource system 145. While a voice communication session is used in this example, any type of communication session using one or more services such as SMS, EMS, MMS, email, IM, chat, web based communication, etc. may be established between any user system, guide system, and/or resource system and/or the search system 130.

Information associated with a user, a guide, an advocate, a vendor and/or a resource may be obtained in various ways. For example, a registration process may be performed using a web form provided by the search system 130, information may be obtained from an external database, and/or information may be obtained based on analysis of information indicated by a user, a guide, an advocate, a vendor and/or a resource. A ‘profile’ is one or more characteristics which may be associated with one or more individuals and/or entities. A profile may include geographic data such as a street address, latitude and longitude, etc., may include demographic information such as age, gender, race, income, family size, political affiliations, etc., may include personality information such as results of psychometric testing, subjective evaluations of an individual, etc., may include affiliation information such as employment, club, activity, societal membership information, information of a device, service, transaction or any other information which might be associated with a user, an advocate, a vendor and/or a guide.

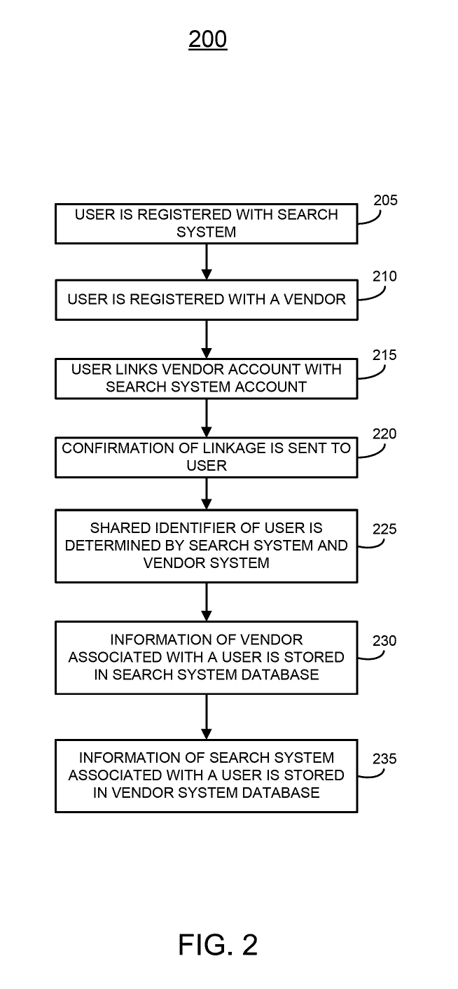

As illustrated in FIG. 2, a process 200 for associating a user account with a search service and with a vendor is provided. The process 200 may be operative at least in part on the search system 130 (FIG. 1) and/or the vendor system 170.

In operation 205 a user is registered with the system 100 (FIG. 1). A user may for example provide a mobile phone number, an email address, a password, and/or other information to the system 100 which may be used to allow the user to utilize search service(s) provided by the search system 130. In at least one embodiment, a web form is provided to a user in order that the user may provide payment information which may be associated with a user. Control is passed to operation 210 and process 200 continues.

In operation 210 a user is registered with a vendor. A user may, for example, register with a vendor using a web form provided by the vendor. In at least one embodiment, a web form provided by the search system 130 (FIG. 1) may be used to register a user with a vendor. For example, a user may select a vendor and may create an account with the vendor automatically using information provided including to the search service. Control is passed to operation 215 and process 200 continues.

In operation 215 a user account with the search system 130 (FIG. 1) is linked with a user account of a vendor. For example, a user may provide information of a user account with a vendor such as a login ID and a password which may allow the search system 130 to obtain access to the user account associated with a vendor. Similarly a request from a vendor system which includes information of a user account with the search system 130 may be used to link a user account with a vendor system with a user account with the search system 130. Control is passed to operation 220 and process 200 continues.

In operation 220 confirmation of a linkage between a user account with a vendor and a user account with the search system 130 (FIG. 1) is provided to a user. For example, an email message, a text message, or other communication service associated with a user account with the search system 130 and/or a user account with a vendor may be used to confirm a linkage between the user accounts. In at least one embodiment, a text message requesting information associated with a user account with a vendor may be sent to a mobile device associated with a user account with the search system 130. Control is passed to operation 225 and process 200 continues.

In operation 225 a shared identifier of a user is determined. If a user confirms the linkage between user accounts, a shared identifier may be selected. For example, if a suitable response is provided to a confirmation message sent in operation 220, a user ID, password, or other information associated with a user by a vendor may be provided to the search system 130. Control is passed to operation 230 and process 200 continues.

In operation 230 information of a vendor associated with a user is recorded. For example, a vendor associated with a user may be recorded in the search system database 120 (FIG. 1). If a vendor ID is associated with a user, information of a vendor associated with a user may be provided to a guide selected to respond to a user request. For example, if a user request expresses interest in an item, and the item is available from an associated vendor, relevant information may be provided to an advocate, an expediter, and/or guide responding to the request. Control is passed to operation 235 and process 200 continues.

In operation 235 information of the search system associated with a user is recorded in a vendor database such as the vendor system database 180 (FIG. 1). For example, an identifier of the search system 130 may be associated with a user. Such information may be used for various purposes including tracking purchases made by a user using the search system 130, confirming security information, etc. Process 200 ends.

The process 200 may be performed by any vendor system and the search system 130. The search system 130 may provide an API which allows a ‘walk-up’ process whereby a vendor may elect to be associated with the search system 130 and may advertise a product and/or service. The search service 120 may allow a user to register with a vendor. Information of a vendor may be associated with a keyword, category, location and/or other information which may allow a user to register with a vendor and associate a user account with the search system 130 with a vendor. In at least one embodiment, an API may be provided by the search system 130 which may allow a user of a vendor system to register with the system 100 (FIG. 1) and associate a user account with the vendor to be associated with a user account with the search system 130.

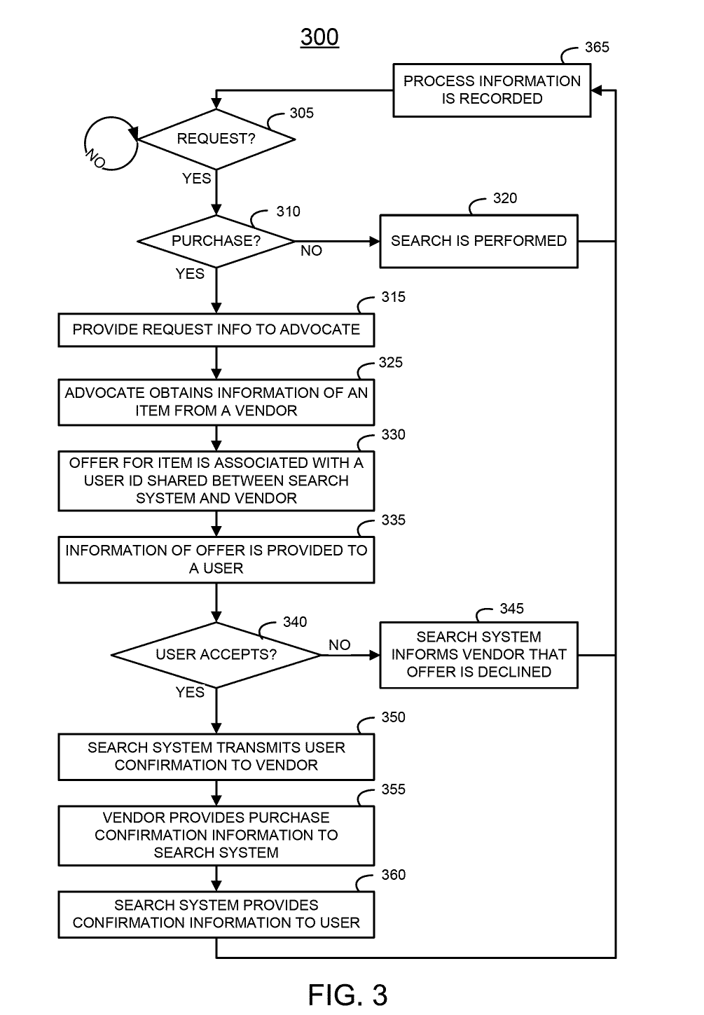

As illustrated in FIG. 3, a process 300 for processing a request is provided. The process 300 may be operative on the system 100 (FIG. 1).

In operation 305 (FIG. 3) a determination is made as to whether a request is received. If it is determined in operation 305 that a request is not received control remains at operation 305 and process 300 continues. If it is determined in operation 305 that a request is received, control is passed to operation 310 and process 300 continues.

The determination in operation 305 may be made based on various criteria. It may be determined that a request is received based on receiving a message at any device associated with the system 100 such as the search system 130 (FIG. 1). For example, a voice message might be received at telephone number, an SMS message might be received, an IM might be received, an email might be received, a web request might be received, and/or a message using any services associated with a search system might be used to determine that a request has been received. In at least one embodiment, a request may be determined to have been received based on a trigger condition which may be indicated in the search system database 120. A request may be received through an API provided in association with the search system 130.

In operation 310 (FIG. 3) a determination is made as to whether there is an intent to make a purchase. If it is determined in operation 310 that a request, for example, does not indicate intent to make a purchase control is passed to operation 320 and process 300 continues. If it is determined in operation 310 that a request indicates intent to make a purchase, control is passed to operation 315 and process 300 continues. It should be noted that the determination in operation 310 may be that both conditions exist, in which case control passes simultaneously to operation 320 and operation 315. Thus a user may receive a search result, and may at some time before, during or after receiving as search result receive an offer to purchase an item selected based on a request and/or an item selected by a guide and/or advocate.

The determination in operation 310 may be made based on various criteria. In at least one embodiment, a guide selected by the search system 130 (FIG. 1) may determine whether a request indicates intent to make a purchase. For example, a request may be routed to a first guide who may be an expediter making the determination in operation 310 including based on contextual information such as previous queries, profile information, vendors, etc., associated with a user. In at least one embodiment, the determination in operation 310 may be made based at least in part on information indicated in the search system database 120. In at least one embodiment, a guide may determine whether an item and/or service requested by a user is available from a vendor associated with the user. Any suitable criteria may be used to determine that a request indicates intent to make a purchase.

In operation 320 an information search is conducted responsive to a user request. Any type of information search may be performed including an automated search and/or a search by a guide on behalf of the user. In at least one embodiment, a human-assisted search may be performed. Control is passed to operation 365 and process 300 continues.

In operation 315 information of a request is provided to an advocate. An advocate who is provided with information of the request may be selected by the search system 130. For example, if an advocate is associated with a vendor, a category, a keyword, etc., of a request, an advocate may be more likely to be selected to respond to a request. In at least one embodiment, a ranking of an advocate associated with purchase(s) by user(s) served by the advocate may be used to select an advocate. For example, an advocate with a higher completion percentage of purchase transactions may be ranked higher. Control is passed to operation 325 and process 300 continues.

In operation 325 an advocate obtains information of an item from a vendor responsive to a user request. For example, an advocate may use a web browser to view information provided by a resource associated with a vendor. In at least one embodiment, an advocate is provided with information of a resource associated with a vendor. An advocate may be able to review inventory, margin, and/or other public or non-public information provided by a vendor which may improve a selection by an advocate. For example, an advocate might access public information from the resource system 145 (FIG. 1) and non public information from the resource ‘Resource 4’ 175 if the advocate is associated with the operator of ‘Vendor system N’ 165. Control is passed to operation 330 and process 300 continues.

In operation 330 an offer for an item is associated with a user identifier which is shared between the search system 130 and a vendor. For example, an advocate may select a number or other indicator of an item from a vendor and may activate a control such as a toolbar button which causes the item to be associated with a user. Activation of a control by an advocate may cause the search system 130 to send a message to a vendor which requests verification of an offer identified by an advocate using account information associated with a user and the vendor. For example, the search system 130 may provide a login ID and password associated with a user account to a vendor and may identify an item selected by an advocate and a vendor system may confirm whether a user may purchase a product based on information available to the vendor system. For example, the vendor system may determine whether an item is available, whether a user payment method is accepted for the purchase, etc. Control is passed to operation 335 and process 300 continues.

In operation 335 information of an offer is provided to a user. If an offer can not be provided to a user, the user may be informed of reason(s) why an offer was declined. For example, if a user account could not be verified, or user payment method was not verified, etc., the information may be provided to the user. In at least one embodiment, user information is not verified until an offer has been provided to the user. If an offer is available to a user, information of the offer is provided to the user. For example, a message may be sent to a user device which may indicate details of an offer for a product and/or service to a user. For example, price, delivery and a way to accept the offer may be delivered to a user device. Multiple messages may be provided to a user regarding an offer. Control is passed to operation 340 and process 300 continues.

In operation 340 a determination is made as to whether an offer is accepted by the user. If it is determined in operation 340 that an offer is not accepted control is passed to operation 345 and process 300 continues. If it is determined in operation 340 that an offer is accepted control is passed to operation 350 and process 300 continues.

The determination in operation 340 may be made based on various criteria. For example, a message may be received by a system associated with the system 100 (FIG. 1) including the search system 130 from a system associated with a user. In at least one embodiment, content of a text message received by the search system 130 from a user system may be used to determine whether an offer is accepted. In at least one embodiment, security information may be required in order to determine whether an offer is accepted. For example, acceptance of an offer may only be originated from a device which is associated with the request, or a response to an offer may require a password, or other security information associated with a user account with a vendor and/or the search system 130 to be provided. In at least one embodiment if a response to an offer is not received before a time interval expires it is determined that an offer is not accepted. In at least one embodiment, if a vendor has declined to provide an offer to a user in operation 335, it may be determined that an offer is not accepted. Any suitable criteria may be used to determine whether an offer is accepted.

In operation 345 the search system informs a vendor that an offer is declined. For example, a message may be sent to a vendor system by the search system 130 indicating that an offer is declined. In at least one embodiment, a vendor system may not be notified of an offer until a user accepts the offer, in which case, no notification is provided to the vendor. Control is passed to operation 365 and process 300 continues.

In operation 350 confirmation information of user acceptance is transmitted to a vendor. For example, security information, product information and/or other information required to complete a purchase may be confirmed by the search system 130 with a vendor system. A purchase transaction may be completed using user account information provided by the search system 130. In at least one embodiment, user information indicated in the search system database 120 and/or information of items selected by a guide is provided to a vendor system via an API associated with the vendor. Control is passed to operation 355 and process 300 continues.

In operation 355 a vendor provides purchase confirmation information to the search system 130. For example, a confirmation code and/or other information associated with a purchase may be provided to the search system by a vendor. In at least one embodiment, a response to a purchase request delivered via an API of a vendor system is received by the search system 130. Control is passed to operation 360 and process 300 continues.

In operation 360 the search system 130 provides confirmation information to a user. In at least one embodiment, a text message including confirmation information associated with a purchase is provided to a user system associated with an acceptance of an offer. Information of a purchase may be provided to a user using any communication service associated with a user. For example, an email, a text message, an IM, a voice message, etc., confirming a purchase may be provided to a user. In at least one embodiment, a user may view information of a purchase using a web page provided by the search system 130. Control is passed to operation 365 and process 300 continues.

In operation 365 information of the process 300 is recorded. In at least one embodiment, the search system database 120 is updated. Information of a purchase, a request, a user, a guide, a resource, an advocate and/or a vendor may be recorded and/or updated. Compensation information for a guide, an advocate, a vendor, and/or the search system 130 may be updated to reflect a completed purchase. If an offer was not accepted by a user, a rating, ranking and/or compensation of a guide and/or an advocate may be affected. A rating of a vendor may be updated to indicate whether an offer was accepted. Control is passed to operation 305 and process 300 continues.

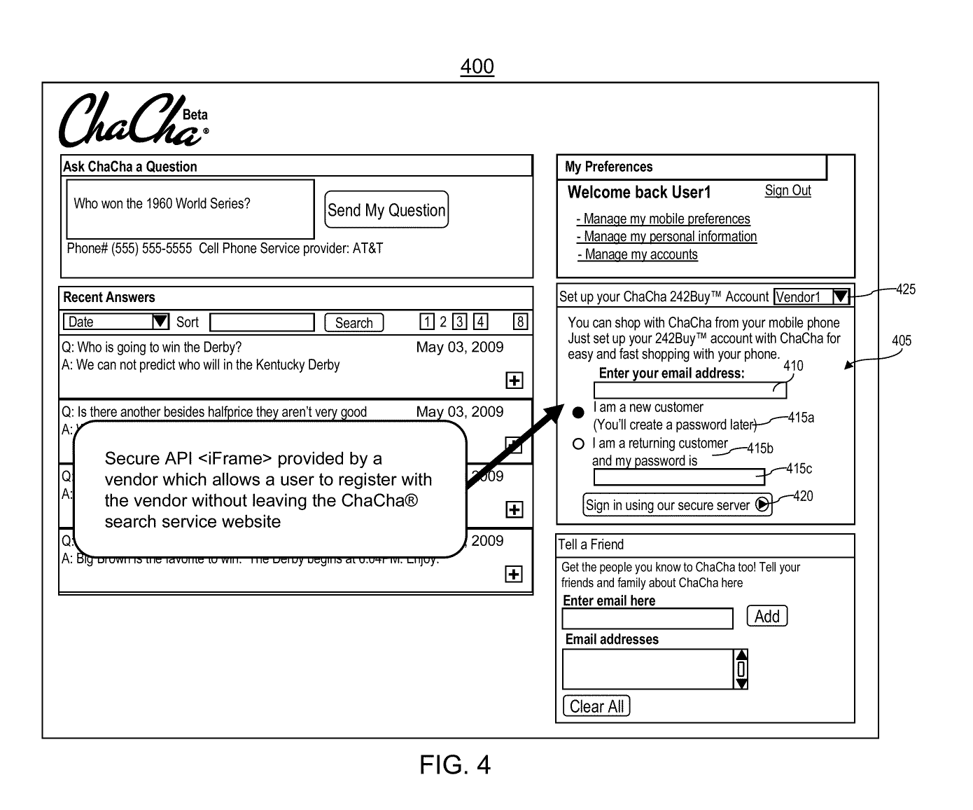

A GUI 400 for registering a user with a vendor via the search system 130 is illustrated in FIG. 4. The GUI 400 may be presented to a user as part of any GUI presented by the search system. In at least one embodiment, a vendor may be selected by a user. In at least one embodiment, a vendor may be presented to a user based on historical information associated with a user such as previous search queries or requests, purchases, or other information associated with a user. The GUI 400 may be displayed on any suitable display device of a user system such as the user system 140 (FIG. 1).

The vendor sign-up window 405 may include a user identifier indicator 410, a user status indicators 415, action button 420 and vendor selection indicator 425. The user identifier indicator 410 may be used to indicate an identifier of a user which is associated with a vendor. For example, a user may provide a current or desired user identifier in the user identifier indicator, or may select a stored value including using typical techniques in the art. The user status indicators 415 may be used to provide information of a user status associated with a vendor. The ‘new customer’ user status indicator 415a is selected as indicated by the filled circle. The ‘new customer’ user status indicator 415a user may be used to indicate a user is a new customer with a vendor. The ‘current customer’ user status indicator 415b may be used to indicate that user has established an account with a vendor indicated in the vendor selection indicator 425. The ‘password’ user status indicator 415c may be used to provide security information associated with a user account with a vendor. The vendor selection indicator 425 may be used to indicate a selected vendor. In at least one embodiment, a vendor may be selected by a user using for example a pull-down list. Alternately, a vendor may be selected by the search system 130. For example, a vendor may be indicated to a user based on advertising payment(s) to a provider of the search system 130, based on targeting information such as a profile, a query history, etc., associated with a user. The action button 420 may be used to submit information provided in the vendor sign-up window for processing.

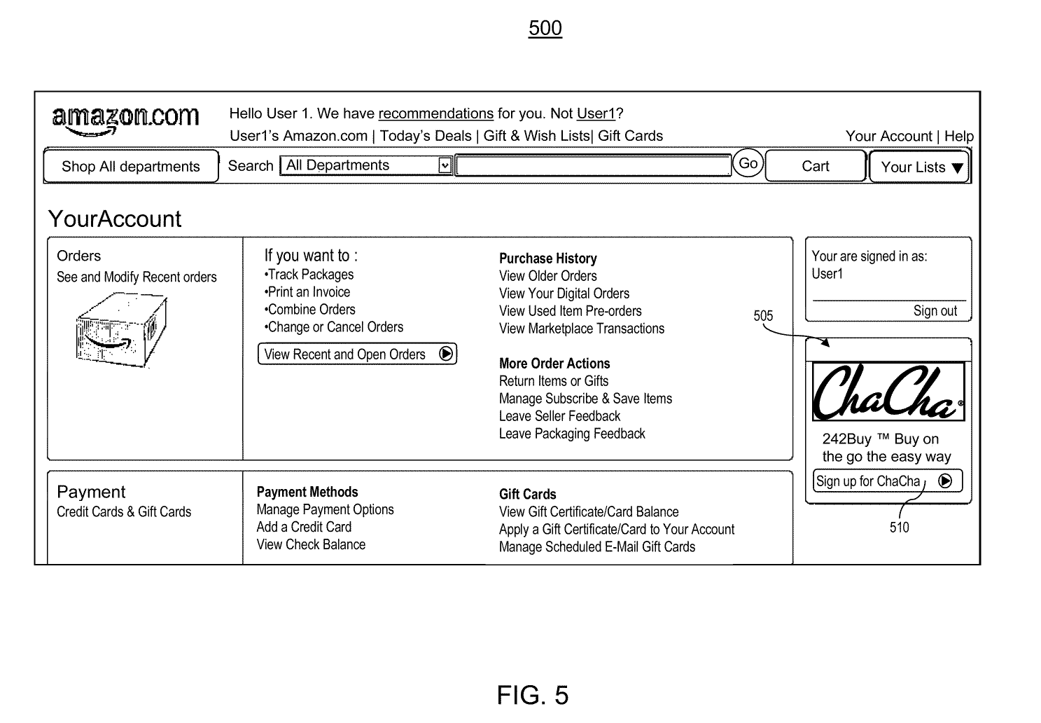

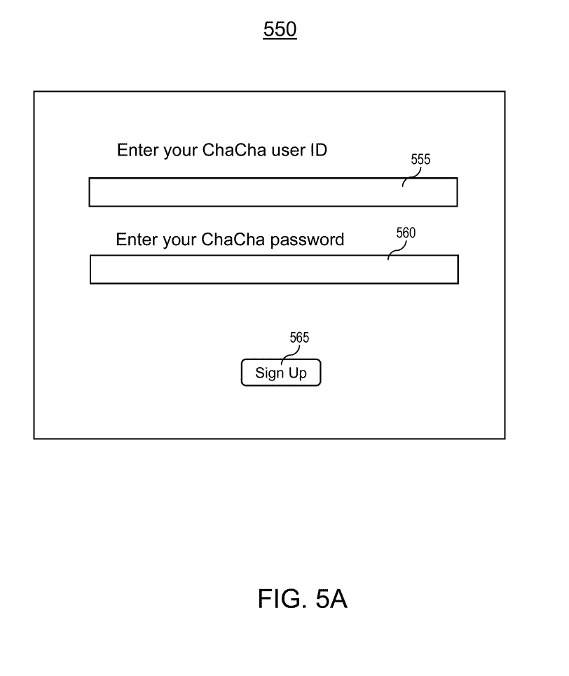

A GUI 500 for registering a user with the search system 130 via a vendor system is illustrated in FIG. 5. The GUI 500 may be presented to a user as part of any GUI presented by a vendor system such as the vendor system 170 (FIG. 1). The GUI 500 may be displayed on any suitable display device of a user system such as the user system 140.

The search system sign-up window 505 may include a ‘sing up for ChaCha’ action button 510. Activation of the ‘sign-up for ChaCha’ action button 510 may cause a GUI such as the GUI 550 illustrated in FIG. 5A to be presented.

A GUI 550 for providing information associated with a search system account of a user to be associated with a vendor account of a user is illustrated in FIG. 5A. The search system user ID box 555 may be used to provide information of an existing or desired user ID associated with an account with the search system 130. The search system security information box 560 may be used to provide security information associated with a user account with the search system 130. The ‘Sign Up’ action button 565 may be used to submit the information in the GUI 550 to a vendor system in order that the vendor system may link a user account with the vendor system with a user account with the search system 130. Additional information may be provided by a user if required using a web form provided by the search system 130 and/or a vendor.

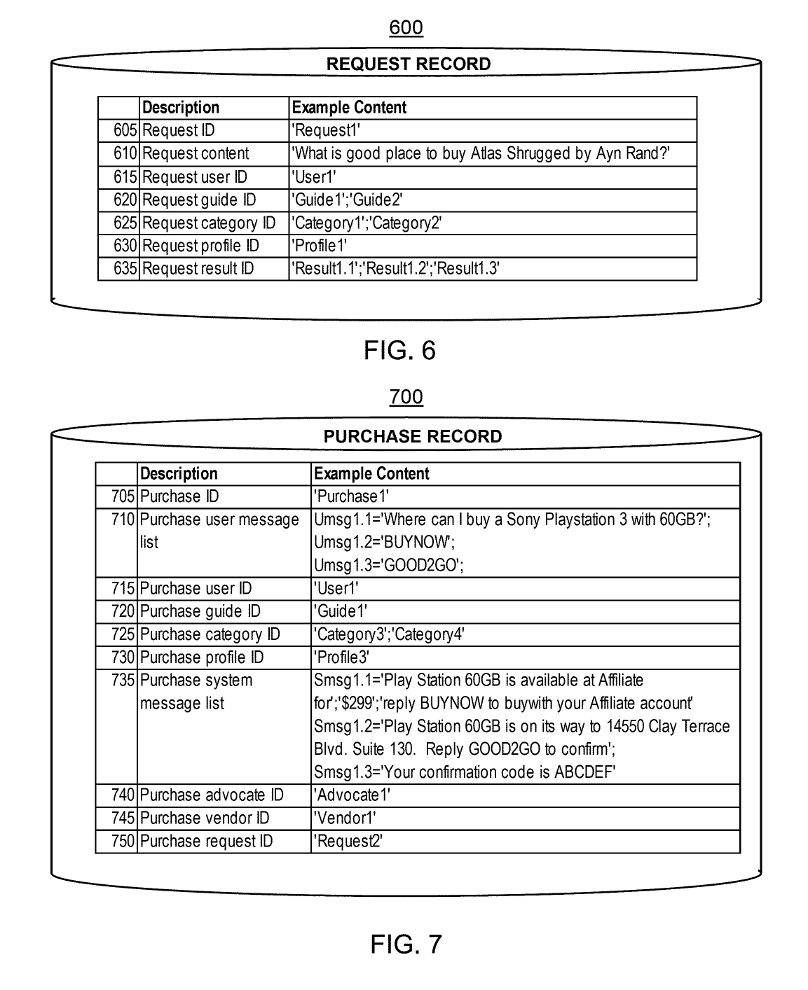

As illustrated in FIG. 6, an exemplary request record 600 is provided, of which one or more may be associated with or resident in the search database 120 (FIG. 1), The request record 600 may include a request ID field 605, a request content field 610, a request user ID field 615, a request guide ID field 620, a request category ID field 625, a request profile ID field 630, and a request result ID field 635.

A request record may be created in various ways. For example, a guided search session, an interactive training session, a non-interactive training session, an automated search session, etc., may cause a request record to be created. A request record may be imported from an external resource accessible to the search system 130. A request record may be created by submission of a search request to a resource such as a search engine, a database, a software system, a human-assisted processing system, etc. In at least one embodiment, a request record is created when a request is received by the search system 130 (FIG. 1).

The request ID field 605 (FIG. 6) preferably contains a unique identifier of a request, which is preferably used consistently. For example, in at least one embodiment, the request ID field 605 can include a randomly generated numerical code, and/or a text string indicating the content of a query. A request ID serves to distinguish the request record associated with a request from a request record associated with other requests. Other unique identifiers of a search request may be utilized without departing from the spirit and scope of the embodiments.

A unique identifier may be assigned to a request when it is entered into the search database 120. If it is determined that a search request is identical to a request in the search database 120, the request may be assigned the same request ID and information of the search request may be added to the request record associated with the request ID. A query or search request may include information that is not explicitly entered by a user/requester. For example, location information, profile information, a categorization, etc., may be associated with a query which might differentiate the query from a query in the search database 120 (FIG. 1). A search request which is determined to be unique may receive a new request ID and an associated request record. As illustrated in FIG. 6, ‘Request1’ is the request ID associated with the request record 600 (FIG. 6).

The request content field 610 may include information regarding the content of a search request. For example, text associated with a query submitted by a user may be indicated in the request content field 610. Content of the request content field 610 may be processed in order to associate a keyword, category and/or other information with a search request. In at least one embodiment, a structured query which conforms to a specific context may be associated with a request and may be indicated in the request content field 610. User queries which are associated with a structured query which may have been submitted by more than one user may be indicated in the request content field 610. Information such as audio recordings, images, etc., which are associated with a search request may be indicated in the request content field 610. Using the example illustrated in FIG. 6, the query ‘What is a good place to buy Atlas Shrugged by Ayn Rand?’ is the query content associated with ‘Request1’. This may indicate that the query ‘What is a good place to buy Atlas Shrugged by Ayn Rand?’ may have been submitted by ‘User1’. Using the same example, a structured query of a request ‘buying Atlas Shrugged by Ayn Rand’ may be the request illustrated at request content 610 in FIG. 6.

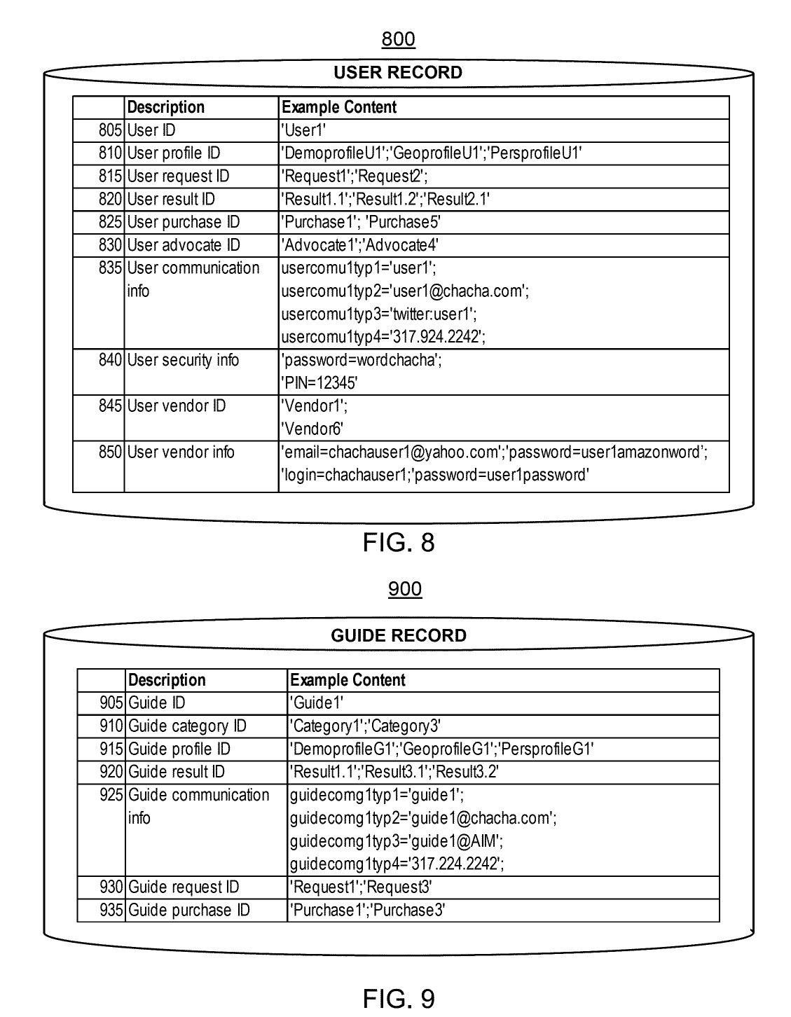

The request user ID field 615 may include information of a user that submitted a query. The request user ID field 615 may be used to associate a user with a query. Multiple users may submit an equivalent search request to the search system 130 (FIG. 1). A search result and/or other item associated with a search request may be presented to a user and/or a guide responsive to a search request in an order based at least in part on a ranking of the item associated with the search request. An identifier of any number of users may be indicated in the request user ID field 615. Information indicated in the request user ID field 615 may be used to obtain information of a user using a record such as the user record 800 (FIG. 8). Using the example illustrated in FIG. 6 the user ‘User1’ has been associated with the request ‘Request1’. This may indicate that ‘User1’ submitted ‘Request1’.

The request guide ID field 620 may include information of a guide who is associated with a search request. For example, if a guide obtains a search result responsive to the search request ‘Request1’, an identifier of the guide may be indicated in the request guide ID field 620. Likewise, if a guide was selected to respond to a search request, an identifier of the guide may be indicated in the request guide ID field 620. Information indicated in the request guide ID field 620 may be used to obtain information associated with a guide using a record such as the guide record 900 (FIG. 9). Using the example illustrated in FIG. 6 the guides ‘Guide1’ and ‘Guide2’ have been associated with the request ‘Request1’. This may for example indicate that ‘Guide1’ and ‘Guide 2’ were selected to respond to ‘Request1’. For example, ‘Guide1’ may have responded to the question ‘What is a good place to buy Atlas Shrugged by Ayn Rand?’ and transferred the request to ‘Guide2’ who may have produced the result ‘Result1.1’ responsive to the request. A result may be automatically associated with a request. For example, if the guide ‘Guide1’ associated a category with the request ‘Request1’, a previous search result may be associated with the request. For example, the result ‘Result1.2’ might be associated with the request ‘Request1’ by the search system 130. An advertisement may be associated with a search request automatically based on a category, keyword, and/or profile, which might for example be ‘Result1.3’.

The request category ID field 625 may include information of a category and/or keyword associated with a request. Content of the request category ID field 625 may be modified by an automated classification of a request. A human may select a category and/or keyword which is associated with a request. For example, a request may be associated with a category based on a keyword indicated in the request content field 610, which might be modified by a guide. A category may be associated with items such as resource (e.g. a search engine, a website, a database, etc.), a guide, an advertisement, a vendor, an advocate, etc. An item associated with a category may be presented to a guide and/or a user if a search request associated with a category is submitted to the search system 130 (FIG. 1). Association of a category with a request may be used to select an item such as a guide, a vendors and/or an advocate associated with the category to respond to a search request. Association of a category with a search request may be used to select a voter associated with the category to vote regarding an item associated with the search request. For example, a guide associated with a category may be requested to provide an opinion regarding items such as a search result, a vendor, etc., associated with a search request. Using the example illustrated in FIG. 6, the categories ‘Category1’ and ‘Category2’ are associated with the request ‘Request1’.

The request profile ID field 630 may include information of a profile which is associated with a search request. A profile may be associated with a search request based at least in part on a profile associated with a user associated with a search request. For example, a geographic profile which is common to one or more users associated with a search request may be associated with a search request, or a guide may determine a profile is to be associated with a search request based on the content of a search request associated with a user. A guide selected to respond to a search request may be selected at least in part based on a profile associated with the search request. A voter may be selected to vote regarding an item associated with a search request based at least in part on a profile associated with a search request. For example, a guide associated with a profile, which may include various information, may be selected to provide an opinion regarding a search result, a vendor, etc., associated with a search request. Using the example illustrated in FIG. 6, the profile ‘Profile1’ is associated with the request ‘Request1’.

The request result ID field 635 may include information of a result which is associated with a request. For example, a result may be associated with a search request when a guide obtains the result responsive to the search request. For example, if a search request is submitted to the search system 130 (FIG. 1), a guide may be selected, and the guide may provide a search result responsive to the request. Alternately, a search result may be associated with a search request if the search request is submitted to a resource such as a search engine, and/or other resource system. Any number of search results may be associated with a search request. Using the example illustrated in FIG. 6, the result ‘Result1.1’, the result ‘Result1.2’, and the result ‘Result1.3’ have been associated with the request ‘Request1’. This may indicate that the results ‘Result1.1’, ‘Result1.2’ and ‘Result1.3’ have been provided responsive to the request ‘Request1’. A search result may include information such as an answer to a query, a URL associated with an answer, an advertisement, an offer, etc.

Any number of users, guides, categories, profiles, and/or search results may be associated with a search request. In at least one embodiment, information of completion of a purchase by a user may be indicated in a request record. A rating of a guide may be based at least in part on a rating of a search result associated with a request. For example, a rating of a search result associated with a guide, a request, a category may affect a rating or ranking of the guide associated with the category.

As illustrated in FIG. 7, an exemplary purchase record 700 is provided, of which one or more may be associated with or resident in the search database 120 (FIG. 1). The purchase record 700 may include a purchase ID field 705, a purchase user message field 710, a purchase user ID field 715, a purchase guide ID field 720, a purchase category ID field 725, a purchase profile ID field 730, a purchase system message field 735, a purchase advocate ID field 740, a purchase vendor ID field 745 and a purchase request ID field 750.

A purchase record may be created in various ways. For example, if an expediter, a guide or an advocate determines that a user request indicates intent or opportunity to make a purchase, a purchase record may be created.

The purchase ID field 705 preferably contains a unique identifier of a purchase, which is preferably used consistently. For example, in at least one embodiment, the purchase ID field 705 can include a randomly generated numerical code, and/or a text string indicating the content of a request which includes a potential purchase. A purchase ID serves to distinguish the purchase record associated with a purchase from a purchase record associated with other purchases. Other unique identifiers of a purchase may be utilized without departing from the spirit and scope of the embodiments. A unique identifier may be assigned to a purchase when it is entered into the search database 120 (FIG. 1). As illustrated in FIG. 7, ‘Purchase1’ is the purchase ID associated with the purchase record 700 (FIG. 7).

The purchase user message field 710 may include information regarding a number of messages received from a user associated with a purchase. For example, text associated with a request which was determined to indicate intent to purchase an item may be indicated in the purchase user message field 710. Content of the purchase use message field 710 may be processed in order to associate a keyword, category, advocate, vendor or other information with a purchase request. Information such as audio recordings, images, etc., which are associated with a purchase request may be indicated in the purchase user message field 710. Using the example illustrated in FIG. 7, the message ‘Umsg1.1=Where can I find a Sony Playstation 3 with 60 GB?’ is a first user message associated with the purchase record 700. This may indicate that the query ‘Where can I find a Sony Playstation 3 with 60 GB?’ has initiated a purchase offer. Subsequent user messages such as the user messages ‘Umsg1.2’ and ‘U msg1.3’ which may be associated with a purchase may be indicated in the purchase user message field 710.

The purchase user ID field 715 may include information of a user that submitted a purchase request to the search system 130 (FIG. 1). The purchase user ID field 715 (FIG. 7) may be used to associate a user with a purchase. Information indicated in the purchase user ID field 715 may be used to obtain information of a user using a record such as the user record 800 (FIG. 8). Using the example illustrated in FIG. 7 ‘User1’ has been associated with ‘Purchase1’. This may indicate that ‘User1’ has requested ‘Purchase1’.

The purchase guide ID field 720 may include information of a guide who is associated with a purchase. For example, if a guide processes a user message associated with a purchase an identifier of the guide may be indicated in the purchase guide ID field 720. Information indicated in the purchase guide ID field 720 may be used to obtain information associated with a guide using a record such as the guide record 900 (FIG. 9). Using the example illustrated in FIG. 7 the guides ‘Guide1’ has been associated with the purchase ‘Purchase1’. This may indicate that ‘Guide1’ was selected to process a user request which produced the purchase ‘Purchase1’. For example, ‘Guide1’ may have responded to the query ‘Where can I find a Sony Playstation 3 with 60 GB?’ and may have transferred the purchase to ‘Advocate1’ who may have facilitated the purchase ‘Purchase1’ responsive to the query.

The purchase category ID field 725 may include information of a category and/or keyword associated with a purchase. The content of the purchase category ID field 725 may be modified by an automated classification of a purchase. A human may select a category and/or keyword which is associated with a purchase. For example, the category ‘Entertainment>Gaming’ might be initially associated with ‘Purchase1’ automatically, which might be changed to ‘Shopping>Electronics’ by ‘Guide1’. A category may be associated with a search resource, a guide, an advertisement, a vendor, an advocate, etc. Association of a category with a purchase may be used to select an item such as a guide, a vendor and/or an advocate associated with the category to respond to a purchase or purchase request. Association of a category with a purchase may be used to select a voter associated with the category to vote regarding an item associated with the purchase. For example, a guide may provide an opinion regarding an item previously purchased responsive to a request to purchase a similar item. Using the example illustrated in FIG. 7, the categories ‘Category3’ and ‘Category4’ are associated with the purchase ‘Purchase1’.

The purchase profile ID field 730 may include information of a profile which is associated with a purchase. A profile may be associated with a purchase based at least in part on a profile associated with a user associated with a purchase. For example, a personality profile which is common to one or more users associated with a purchase may be associated with a purchase, or a guide may determine that a profile is to be associated with a purchase based on the content of a search request associated with a user associated with the purchase, etc. An advocate and/or a guide selected to respond to a purchase may be selected at least in part based on a profile associated with the purchase. A voter may be selected to vote regarding an item associated with a purchase based at least in part on a profile associated with a purchase. For example, a guide associated with a profile, which may include various information may be selected to provide an opinion regarding an advocate, a vendor, etc., associated with a purchase. Using the example illustrated in FIG. 7, the profile ‘Profile3’ is associated with ‘Purchase1’.

The purchase system message field 735 may include information of system messages which may be provided to a user associated with a purchase. For example, one or more messages provided by the search system 130 to a user in order to process a purchase transaction may be indicated in the purchase system message field 735. An automated response to a user message and criteria for providing a response by a user may be indicated in the purchase system message field 735. A message provided by a guide responsive to a user request may be indicated in the purchase system message field 735. Using the example in FIG. 7, the system message ‘Smsg1.1=Play Station 60 GB is available at Vendor1 for’; ‘$299’;‘reply BUYNOW to buy now with your Vendor1 account” may be transmitted to a user responsive to actions of an advocate by the search system 130, which may append information such as the offer price (i.e., ‘$299) provided by a vendor, and may append a user response condition (i.e., ‘reply BUYNOW to buy’). Any number of system messages and/or conditions associated with a message may be indicated in the purchase system message field. For example, the message ‘Smsg1.2’ may be transmitted based on receiving the user message ‘Umsg1.2’, etc. Content of the purchase system message field 735 may be used to determine if a purchase has been completed successfully. Information of a purchase such as item number, price, etc., may be indicated in the purchase system message field 735.

The purchase advocate ID field 740 may include information of an advocate which is associated with a purchase. For example, an advocate may be associated with a purchase if the advocate has been selected to respond to a user message associated with the purchase. An advocate may be rated and/or compensated based at least in part on success and/or content of a purchase associated with an advocate. For example, if a purchase is completed, a rating, ranking, and/or compensation of an advocate and/or a guide associated with the purchase may be affected. Content of the purchase advocate ID field 740 may be used to ‘lookup’ information of an advocate using an advocate record such as the advocate record 1100 (FIG. 11).

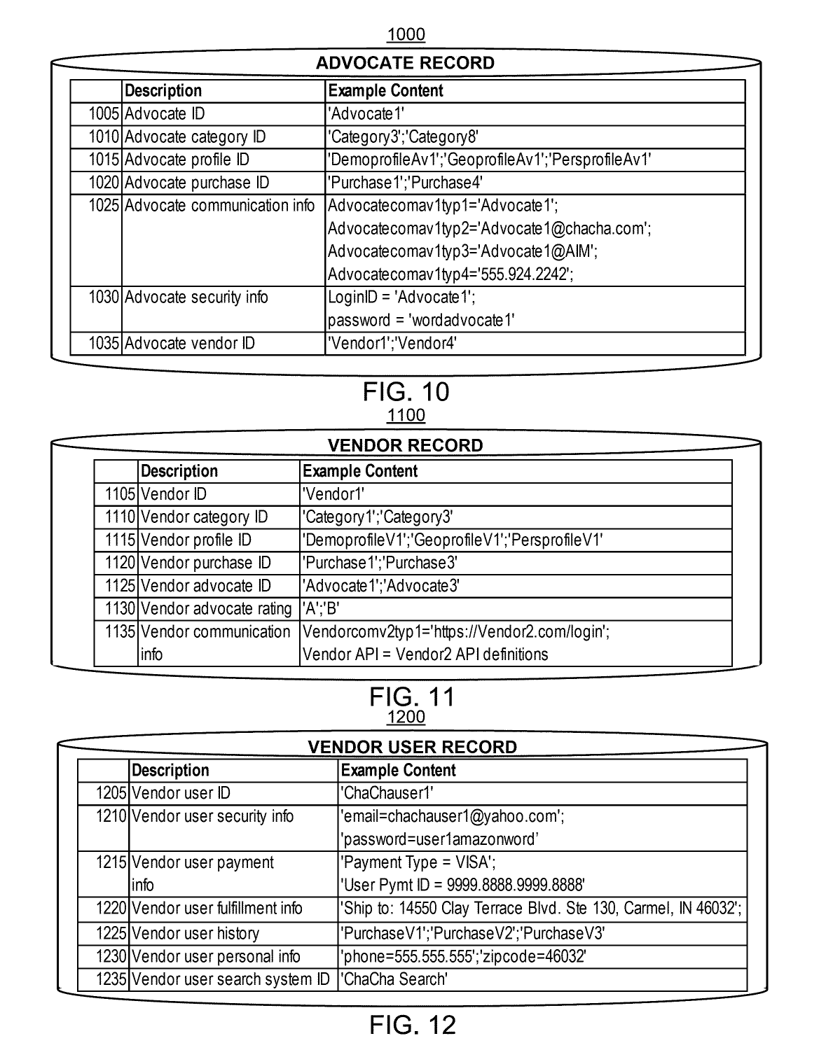

The purchase vendor ID field 745 may include information of a vendor which is associated with a purchase. For example, a vendor may be associated with a purchase if the vendor has been selected by an advocate to provide an offer to purchase to a user. A vendor may be rated based at least in part on success and/or content of a purchase associated with a vendor. For example, if a purchase is completed, a rating, ranking, and/or compensation of a vendor associated with the purchase may be affected. Content of the purchase vendor ID field 745 may be used to ‘lookup’ information of a vendor using a vendor record such as the vendor record 1000 (FIG. 10).

The purchase request ID field 750 may include information of a request which is associated with a purchase. For example, if a search request is determined to indicate the intent to make a purchase by a guide, an identifier of the request may be added to the purchase request ID field 750. The content of the purchase request ID field 750 may be used to ‘lookup’ information of a request using a request record such as the request record 600 (FIG. 6).

Compensation of a guide, advocate, vendor, and/or the search system 130 (FIG. 1) may be affected by completion of a purchase by a user. For example, an advocate may be compensated based on purchases, and/or repeated purchases by a user. Likewise, if an advocate, a vendor and/or a guide are associated with purchase by a user, a rating and/or ranking of the advocate, vendor, and/or guide may be increased, which may increase the probability of selection of the advocate, vendor and/or guide including responsive to a request. For example, a guide who refers a request to an advocate which results in a purchase may be more likely to be selected to respond to future requests.

As illustrated in FIG. 8, an exemplary a user record 800 is provided, of which one or more may be associated with or resident in the search system database 120 (FIG. 1). The user record 800 may include a user ID field 805, a user profile ID field 810, a user request ID field 815, a user result ID field 820, a user purchase ID field 825, a user advocate ID field 830, a user communication info field 835, a user security info field 840, a user vendor ID field 845, and a user vendor info field 850.

The user ID field 805 preferably contains a unique identifier of a user, which is preferably used consistently. For example, in at least one embodiment, the user ID field 805 can include a randomly generated numerical code, and/or a text string indicating a name associated with a user. A user ID serves to distinguish a user record associated with a user from a user record associated with other users. Other unique identifiers of a user may be utilized without departing from the spirit and scope of the embodiments. In at least one embodiment, a user ID may include a phone number associated with a user. Using the example illustrated in FIG. 8, ‘User1’ is the user ID associated with the user record 800.

The user profile ID field 810 may include information of a profile associated with a user. Content of the user profile ID field 810 may be modified based on actions of a user. A person may select a profile which is associated with a user. For example, a user may select a profile to be associated with the user during a registration process. A profile may be associated with a user based on testing of a user and/or information from users. For example, a user may be required to demonstrate knowledge relevant to a profile in order to be associated with the profile, or a user may take a test which is used to generate a profile, or a user may provide information such as demographic, geographic, personality or other information which may be indicated in a profile associated with the user. Information indicated in a user profile may be obtained from an external database and/or system. A profile associated with a user may be used to select and/or rank a user for voting. Using the example illustrated in FIG. 8, the profiles ‘DemoprofileU1’, ‘GeoprofileU1’ and ‘PersprofileU1’ are associated with the user ‘User1’. This may indicate that ‘User1’ has indicated and/or generated information indicated in the profiles ‘DemoprofileU1’ which may be a demographic profile, ‘GeoprofileU1’ which may be a geographic profile and ‘PersprofileU1’ which might indicate personality information regarding the user ‘User1’.

The user request ID field 815 may include information of a request associated with a user. The content of the user request ID field 815 may be modified based on actions of a user. If a user submits a search request to the search system 130 (FIG. 1) an identifier of the search request may be included in the user request ID field 815. Using the example illustrated in FIG. 8, the requests ‘Request1’ and ‘Request2’ are associated with the user ‘User1’. This may indicate that ‘User1’ has submitted the requests ‘Request1’ and ‘Request2’.

The user result ID field 820 may include information of a result associated with a user. Content of the user result ID field 820 may be modified based on action of a user and/or a guide. If a user receives a search result responsive to a search request, an identifier of the search result may be included in the user result ID field 820. A usage indicator associated with a search result provided to a user may affect a rating and/or ranking associated with a guide. Using the example illustrated in FIG. 8, the results ‘Result1.1’, ‘Result1.2’ and ‘Result2.1’ are associated with the user ‘User1’. This may indicate that ‘User1’ has been presented with the results ‘Result1.1’, ‘Result1.2’, and ‘Result2.1’.

The user purchase ID field 825 may include information of a purchase associated with a user. Content of the user purchase ID field 825 may be modified based on actions of a user. If a user submits a purchase request to the search system 130 (FIG. 1) an identifier of the purchase may be included in the user purchase ID field 825. Using the example illustrated in FIG. 8, the purchases ‘Purchase1’ and ‘Purchase5’ are associated with the user ‘User1’. This may indicate that ‘User1’ has submitted the purchases ‘Purchase1’ and ‘Purchase5’ to the search system 130 (FIG. 1). Information indicated in the user purchase ID field 825 may be used to ‘look up’ information indicated in a purchase record such as the purchase record 700 (FIG. 7). Information of a purchase associated with a user may be used to determine compensation, and/or other information associated with a user.

The user advocate ID field 830 may include information of an advocate associated with a user. If an advocate has provided a purchase offer to a user, an indicator of the advocate may be included in the user advocate ID field 830. The probability that an advocate will be selected to respond to a purchase request associated with a user may be affected by a rating or ranking of an advocate associated with a purchases associated with a user. Using the example illustrated in FIG. 8, the advocates ‘Advocate1’ and ‘Advocate4’ are associated with the user ‘User1’. Information indicated in the user advocate ID field 830 may be used to ‘look up’ information of an advocate using an advocate record such as the advocate record 1000 (FIG. 10).

The user communication info field 835 may include information of a device and/or service associated with a user. Content of the user communication info field 835 may be modified based on actions of a user. If a user establishes communications with the search system 130 (FIG. 1) using a device and/or service, information regarding the device and/or service may be included in the user communication info field 835. Any type of communication service and/or system may be indicated in the user communication info field 835. For example, a username and/or password associated with a user may be indicated in the user communication info field 835. Communication services such as IM, e-mail, SMS, MMS, EMS, telephone, wireless or wired communication, etc., may be indicated in the user communication info field 835. A telephone number, an email address, an IM provider and login ID, a keyword associated with a service, etc., may be indicated in the user communication info field 835. Using the example illustrated in FIG. 8, the login ‘user1’, the email ‘user1@chacha.com’, the Twitter™ service account ‘twitter:user1’ and the phone number ‘317.924.2242’ are associated with the user ‘User1’. This may indicate that ‘User1’ may be contacted using the login ID ‘user1’, via email at ‘user1@chacha.com’, via Twitter as ‘user1’ and/or via voice, text, and/or other service associated with the phone number ‘317.924.2242’.

The user security info field 840 may include information of security information associated with a user. For example, a password, a PIN, or any other type of security information which may be required to access a user account associated with the search system 130 (FIG. 1) may be indicated in the user security info field 840. Using the example illustrated in FIG. 8, the password ‘wordchacha’ and the PIN ‘12345’ are associated with the user ‘User1’. Any type of security information may be indicated in the user security info field 840.

The user vendor ID field 845 may include information of a vendor associated with a user. Information indicated in the user vendor ID field 845 may be used to indicate vendors associated with a user and the search system 130 (FIG. 1) which may allow a use to complete a purchase transaction. Information indicated in the user vendor ID field 845 may be used to ‘look up’ information of a vendor using a vendor record such as the vendor record 1100 (FIG. 11). Using the example in FIG. 8, the vendors ‘Vendor1’ and ‘Vendor6’ are associated with the user ‘User1’.

The user vendor info field 850 may include information of a vendor associated with a user. Information indicated in the user vendor info field 850 may be used to indicate a shared identifier of a user which may be used by the search system 130 (FIG. 1) to access a user account with a vendor. In at least one embodiment, the user vendor ID field 845 and the user vendor info field 850 may be linked by for example a pointer. Using the example illustrated in FIG. 8, the login ID ‘chachauser1@yahoo.com’ and the password ‘user1amazonword’ are associated with the vendor ‘Vendor1’ and the user ‘User1’. Likewise, the login ID ‘chachauser1’ and the password ‘user1password’ are associated with the vendor ‘Vendor6’ and the user ‘User1’.

As illustrated in FIG. 9, an exemplary guide record 900 is provided, of which one or more may be associated with or resident in the search database 120 (FIG. 1). The guide record 900 may include a guide ID field 905, a guide category ID field 910, a guide profile ID field 915, a guide result ID field 920, a guide communication info field 925, a guide request ID field 930, and guide purchase ID field 935.

The guide ID field 905 preferably contains a unique identifier of a guide, which is preferably used consistently. For example, in at least one embodiment, the guide ID field 905 can include a randomly generated numerical code, and/or a text string indicating a name associated with a guide. A guide ID serves to distinguish the guide record associated with a guide from a guide record associated with other guides. Other unique identifiers of a guide may be utilized without departing from the spirit and scope of the embodiments. Using the example illustrated in FIG. 9, ‘Guide1’ is the guide ID associated with the guide record 900.

The guide category ID field 910 may include information of a category and/or keyword associated with a guide. Content of the guide category ID field 910 may be modified based on action(s) of a guide. A person may select a category and/or keyword which is associated with a guide. A category may be associated with a guide based on testing of a guide. A category may be associated with a guide based on an affiliate group associated with a guide. For example, if a guide has chosen to be affiliated with affiliate groups associated with a type of music, a category associated with the type of music might be associated with the guide. A category associated with a guide may be used to select item(s) which are to be presented to a guide. A guide may be selected for any activity based on the association of a guide with a category. Using the example illustrated in FIG. 9, the categories ‘Category1’ and ‘Category3’ are associated with the guide ‘Guide1’. While particular examples of a guide's association to a category are described herein, the present invention is not limited to any association technique. For example, a guide may be associated with a category based on information associated with how the guide was referred to registering with the system 100 (FIG. 1).

The guide profile ID field 915 may include information of a profile associated with a guide. Content of the guide profile ID field 915 may be modified based on actions of a guide. A person may select a profile which is associated with a guide. For example, a guide may select a profile to be associated with the guide during a registration process. A profile may be associated with a guide based on testing of a guide. For example, a guide may be required to demonstrate knowledge relevant to a profile in order to be associated with the profile, or a guide may take a test which is used to generate a profile, or a guide may provide information such as demographic, geographic, personality or other information which may be indicated in a profile associated with the guide. Information indicated in the content of the guide profile ID field 915 may be compared to information indicated in the content of a profile associated with a search request in order to determine a ranking of a guide for responding to a search request. Likewise, a profile associated with a guide may be used to select and/or rank a guide for voting. Using the example illustrated in FIG. 9, the profiles ‘DemoprofileG1’, ‘GeoprofileG1’ and ‘PersprofileGl’ are associated with the guide ‘Guide1’. This may indicate that ‘Guide1’ has indicated and/or generated the profiles ‘DemoprofileG1’ which may be a demographic profile including demographic data such as age, sex, race, income, education, etc., ‘GeoprofileG1’ which may be a geographic profile which may include information of locations and ‘PersprofileGl’ which might indicate personality, transaction, affiliation, etc., information regarding the guide ‘Guide1’.

The guide result ID field 920 may include information of a result associated with a guide. Content of the guide result ID field 920 may be modified based on actions of a guide. If a guide produces a search result responsive to a search request, an identifier of the search result may be included in the guide result ID field 920. A rating and/or ranking associated with a search result associated with a guide may affect compensation for a guide. Likewise a usage indicator associated with a search result provided by a guide may affect a rating or ranking associated with a guide. Using the example illustrated in FIG. 9, the results ‘Result1.1’, ‘Result3.1’ and ‘Result3.2’ are associated with the guide ‘Guide1’. This may indicate that ‘Guide1’ has provided the results ‘Result1.1’, ‘Result3.1’, and ‘Result3.2’ responsive to a search request.

The guide communication info field 925 may include information of a device and/or service associated with a guide. Content of the guide communication info field 925 may be modified based on action(s) of a guide. If a guide establishes communications with the system 100 (FIG. 1) using a device and/or service information regarding the device and/or service may be included in the guide communication info field 925. Any type of communication service and/or system may be indicated in the guide communication info field 925. For example, a username and/or password associated with a guide may be indicated in the guide communication info field 925. Communication services such as Instant Messaging, e-mail, SMS, MMS, EMS, telephone, wireless or wired communication, etc., may be indicated in the guide communication info field 925. A telephone number, an email address, an IM provider and login ID, a keyword associated with a service, an IP address, a MAC address, a URL, etc., may be indicated in the guide communication info field 925. Using the example illustrated in FIG. 9, the login ‘guide1’, the email ‘guide1@chacha.com’, the IM credential ‘guide1@AIM’ and the phone number ‘317.224.2242’ are associated with the guide ‘Guide1’. This may indicate that ‘Guide1’ may be contacted using the login ID ‘guide1’, via email at ‘guide1@chacha.com’, via IM as ‘guide1@AIM’ and via voice, text, or other service associated with the phone number ‘317.224.2242’.

The guide request ID field 930 may include information of a request associated with a guide. Content of the guide request ID field 930 may be modified based on actions of a guide. If a guide produces a search result responsive to a search request, an identifier of the search request may be included in the guide request ID field 930. An indicator of a request may be added to the guide request ID field 930 associated with a guide if the guide responds to a request. A rating and/or ranking associated with a search request associated with a guide may affect compensation for a guide. Using the example illustrated in FIG. 9, the requests ‘Request1’ and ‘Request3’ are associated with the guide ‘Guide1’. This may indicate that ‘Guide1’ has responded to, been selected to respond to, and/or has voted regarding one or more item associated with the requests ‘Request1’ and ‘Request3’.

The guide purchase ID field 935 may include information of a purchase associated with a guide. Content of the guide purchase ID field 935 may be modified based on actions of a guide. If a guide produces a search result responsive to a search associated with a purchase, an identifier of the purchase may be included in the guide purchase ID field 935. A rating and/or ranking associated with a purchase associated with a guide may affect compensation and/or ranking and/or rating of a guide. If a guide transfers a request determined to indicate intent to purchase to an advocate, an identifier of the purchase may be included in the guide purchase ID field 935. Using the example illustrated in FIG. 9, the purchases ‘Purchase1’, ‘Purchase3’ and others are associated with the guide ‘Guide1’. This may indicate that ‘Guide1’ has responded to a request associated with the purchases ‘Purchase1’ and ‘Purchase3’. Information indicated in the guide purchase ID field 935 may be used to ‘look up’ information of a purchase using a purchase record such as the purchase record 700 (FIG. 7).

As illustrated in FIG. 10, an exemplary advocate record 1000 is provided, of which one or more may be associated with or resident in the search database 120 (FIG. 1). The advocated record 1000 may include an advocate ID field 1005, an advocate category ID field 1010, an advocate profile ID field 1015, an advocate purchase ID field 1020, an advocate communication info field 1025, and an advocate security info field 1030, and advocate vendor ID field 1035.

The advocate ID field 1005 preferably contains a unique identifier of an advocate, which is preferably used consistently. For example, in at least one embodiment, the advocate ID field 1005 can include a randomly generated numerical code, and/or a text string indicating a name associated with an advocate. An advocate ID serves to distinguish the advocate record associated with an advocate from an advocate record associated with other advocates. Other unique identifiers of an advocate may be utilized without departing from the spirit and scope of the embodiments. Using the example illustrated in FIG. 10, ‘Advocate1’ is the advocate ID associated with the advocate record 1000.

The advocate category ID field 1010 may include information of a category associated with an advocate. Content of the advocate category ID field 1010 may be modified based on action(s) of an advocate. A person may select a category and/or keyword which is associated with an advocate. A category may be associated with an advocate based on testing of an advocate. A category may be associated with an advocate based on an affiliate group associated with an advocate. For example, if an advocate has chosen to be affiliated with affiliate groups associated with a type of food, a category associated with the type of food might be associated with the advocate. An advocate may be affiliated with a vendor, as described herein below, which may cause a category to be associated with an advocate. A category associated with an advocate may be used to select items which are to be presented to an advocate. An advocate may be selected to vote regarding an item based on the association of an advocate with a category. For example, opinions of an advocate regarding a vendor, a resource and/or other item associated with a category may be requested. Using the example illustrated in FIG. 10, the categories ‘Category3’ and ‘Category8’ are associated with the advocate ‘Advocate l’.

The advocate profile ID field 1015 may include information of a profile associated with an advocate. Content of the advocate profile ID field 1015 may be modified based on actions of an advocate. A person may select a profile which is associated with an advocate. For example, an advocate may select a profile to be associated with the advocate during a registration process. A profile may be associated with an advocate based on testing of an advocate. For example, an advocate may be required to demonstrate knowledge relevant to a profile in order to be associated with the profile, or an advocate may take a test which is used to generate a profile, or an advocate may provide information such as demographic, geographic, personality or other information which may be indicated in a profile associated with the advocate. Information indicated in the content of the advocate profile ID field 1015 may be compared to information indicated in the content of a profile associated with a search request and/or a purchase in order to determine a ranking of an advocate for responding to a search request and/or a purchase. Likewise, a profile associated with an advocate may be used to select and/or rank an advocate for voting. Using the example illustrated in FIG. 10, the profiles ‘DemoprofileAv1’, ‘GeoprofileAv1’ and ‘PersprofileAv1’ are associated with the advocate ‘Advocate1’. This may indicate that ‘Advocate1’ has indicated and/or generated the profiles ‘DemoprofileAv1’ which may be a profile including demographic data such as age, sex, race, income, education, etc., ‘GeoprofileAv1’ which may be a geographic profile which may include information of locations and ‘PersprofileAv1’ which might indicate personality, transaction, affiliation, etc., information regarding the advocate ‘Advocate1’.

The advocate purchase ID field 1020 may include information of a purchase associated with an advocate. Content of the advocate purchase ID field 1020 may be modified based on actions of an advocate. If an advocate initiates a purchase responsive to a request, an identifier of the purchase may be included in the advocate purchase ID field 1020. A rating, ranking, purchase value, success indicator, and/or other information associated with a purchase associated with an advocate may affect compensation of an advocate. Using the example illustrated in FIG. 10, the purchases ‘Purchase1’ and ‘Purchase4’ are associated with the advocate ‘Advocate1’. This may indicate that ‘Advocate1’ has facilitated the purchases ‘Purchase1’ and ‘Purchase4’.

The advocate communication info field 1025 may include information of a device and/or service associated with an advocate. Content of the advocate communication info field 1025 may be modified based on action(s) of an advocate. If an advocate establishes communications with the search system 130 (FIG. 1) using a device and/or service, information regarding the device and/or service may be included in the advocate communication info field 1025. Any type of communication service and/or system may be indicated in the advocate communication info field 1025. For example, a username and/or password associated with an advocate may be indicated in the advocate communication info field 1025. Communication services such as IM, e-mail, SMS, MMS, EMS, telephone, wireless or wired communication, etc., may be indicated in the advocate communication info field 1025. A telephone number, an email address, an IM provider and login ID, a keyword associated with a service, an IP address, a MAC address, a URL, etc., may be indicated in the advocate communication info field 1025. Using the example illustrated in FIG. 10, the login ‘Advocate1’, the email ‘Advocate1@chacha.com’, the IM credential ‘Advocate1@AIM’ and the phone number ‘555.924.2242’ are associated with the advocate ‘Advocate1’. This may indicate that ‘Advocate1’ may be contacted using the login ID ‘Advocate1’, via email at ‘Advocate1@chacha.com’, via IM as ‘Advocate1@AIM’ and via voice, text, or other service associated with the phone number ‘555.924.2242’.

The advocate security info field 1030 may include information of security information associated with an advocate. For example, a password, a PIN, or any other type of security information which may be required to access an advocate account associated with the search system 130 (FIG. 1) may be indicated in the advocate security info field 1030. Using the example illustrated in FIG. 10, the advocate ID ‘Advocate1’ and the password ‘wordadvocate1’ are associated with the advocate ‘Advocate1’. Any type of security information may be indicated in the advocate security info field 1030. Advocate security information may be required to be provided if an advocate initiates a purchase.

The advocate vendor ID field 1035 may include information of a vendor associated with an advocate. Content of the advocate vendor ID field 1035 may be modified based on actions of an advocate and/or a vendor. If an advocate initiates or facilitates a purchase associated with a vendor, an identifier of the vendor may be included in the advocate vendor ID field 1035. A rating and/or ranking associated with a vendor associated with an advocate may affect compensation of an advocate. In at least one embodiment, an advocate may elect to be associated with a vendor. In at least one embodiment, a vendor may select an advocate associated with the vendor. In at least one embodiment, the search system 130 may associate an advocate with a vendor. Using the example illustrated in FIG. 10, the vendors ‘Vendor1’, ‘Vendor4’ are associated with the advocate ‘Advocate1’. This may indicate that ‘Advocate1’ has responded to, been selected to respond to, and/or has voted regarding one or more item such as a purchase request, and advertisement, etc., associated with the vendors ‘Vendor1’ and ‘Vendor4’.

As illustrated in FIG. 11, an exemplary vendor record 1100 is provided, of which one or more may be associated with or resident in the search database 120 (FIG. 1). The vendor record 1100 may include a vendor ID field 1105, a vendor category ID field 1110, a vendor profile ID field 1115, a vendor purchase ID field 1120, a vendor advocate ID field 1125, a vendor advocate rating field 1130 and a vendor communication info field 1135.

The vendor ID field 1105 preferably contains a unique identifier of a vendor, which is preferably used consistently. For example, in at least one embodiment, the vendor ID field 1105 can include a randomly generated numerical code, and/or a text string indicating a name associated with a vendor. A vendor ID serves to distinguish the vendor record associated with a vendor from a vendor record associated with other vendors. Other unique identifiers of a vendor may be utilized without departing from the spirit and scope of the embodiments. Using the example illustrated in FIG. 11, ‘Vendor2’ is the vendor ID associated with the vendor record 1100.

The vendor category ID field 1110 may include information of a category and/or keyword associated with a vendor. Content of the vendor category ID field 1110 may be modified based on actions of a vendor. A person may select a category and/or keyword which is associated with a vendor. A category may be associated with a vendor based on testing of a vendor. A category may be associated with a vendor based on an affiliate group associated with a vendor. For example, if a vendor has chosen to be affiliated with affiliate groups associated with a type of product, a category associated with the type of product might be associated with the vendor. An advocate and/or guide may be affiliated with a vendor, as described herein, which may cause a category to be associated with a vendor. A category associated with a vendor may be used to select items which are to be presented to a vendor. A vendor may be selected to vote regarding an item based on the association of a vendor with a category. For example, opinions of a vendor regarding an advocate, a resource, a guide, or other item associated with a category may be requested. Using the example illustrated in FIG. 11, the categories ‘Category1’ and ‘Category3’ are associated with the vendor ‘Vendor2’.

The vendor profile ID field 1115 may include information of a profile associated with a vendor. Content of the vendor profile ID field 1115 may be modified based on actions of a vendor. A person may select a profile which is associated with a vendor. For example, a guide may select a profile to be associated with a vendor during a registration process. A profile may be associated with a vendor based on testing of a vendor. For example, a vendor may be required to demonstrate knowledge relevant to a profile in order to be associated with the profile, or a vendor may take a test which is used to generate a profile, or a vendor may provide information such as demographic, geographic, personality or other information which may be indicated in a profile associated with the vendor. Information indicated in the content of the vendor profile ID field 1115 may be compared to information indicated in the content of a profile associated with a search request or other item in order to determine a ranking of a vendor for responding to a search request. Likewise, a profile associated with a vendor may be used to select and/or rank a vendor for any purpose such as providing an offer to a user. Using the example illustrated in FIG. 11, the profiles ‘DemoprofileV2’, ‘GeoprofileV2’ and ‘PersprofileV2’ are associated with the vendor ‘Vendor2’. This may indicate that ‘Vendor2’ has indicated and/or generated the profiles ‘DemoprofileV2’ which may be a profile including demographic data such as age, sex, race, income, education, etc., ‘GeoprofileV2’ which may be a geographic profile which may include information of locations and ‘PersprofileV2’ which might indicate personality, transaction, affiliation, etc., information regarding the vendor ‘Vendor2’.

The vendor purchase ID field 1120 may include information of a purchase associated with a vendor. Content of the vendor purchase ID field 1120 may be modified based on actions of a vendor. If a vendor produces a purchase offer responsive to a search request, an identifier of the purchase may be included in the vendor purchase ID field 1120. If a user successfully completes a purchase from a vendor an identifier of the purchase and/or other information may be indicated in the vendor purchase ID field 1120. A rating and/or ranking associated with a purchase may affect compensation provided by a vendor. Using the example illustrated in FIG. 11, the purchases ‘Purchase1’ and ‘Purchase3’ are associated with the vendor ‘Vendor2’. This may indicate that ‘Vendor2’ has provided a purchase offer associated with ‘Purchase1’ and ‘Purchase3’ responsive to a user request and/or actions of an advocate.

The vendor advocate ID field 1125 may include information of an advocate associated with a vendor. Content of the vendor advocate ID field 1125 may be modified based on actions of an advocate. If an advocate produces a purchase responsive to a user request associated with a vendor, an identifier of the advocate may be included in the vendor advocate ID field 1125. A rating and/or ranking associated with an advocate associated with a vendor may affect compensation of an advocate. In at least one embodiment, an advocate may elect to be associated with a vendor. In at least one embodiment, a vendor may select an advocate associated with the vendor. In at least one embodiment, the search system 130 (FIG. 1) may associate an advocate with a vendor. Using the example illustrated in FIG. 11, the advocates ‘Advocate1’ and ‘Advocate3’ are associated with the vendor ‘Vendor2’. This may indicate that ‘Advocate1’ and ‘Advocate3’ have responded to, been selected to respond to, and/or has voted regarding one or more item associated with the vendor ‘Vendor2’. In at least one embodiment, an identifier of an advocate may be associated with a vendor in order to rank an advocate for responding to a purchase request.

The vendor advocate rating field 1130 may include information of a rating or ranking associated with a vendor and an advocate. In at least one embodiment, the vendor advocate ID field 1125 and the vendor advocate rating field 1130 are linked by for example a pointer. A rating associated with an advocate and a vendor may affect the probability that an advocate will be selected to respond to a purchase request associated with a vendor. Using the example illustrated in FIG. 11, the rating ‘A’ is associated with the advocate ‘Advocate1’ and the rating ‘B’ is associated with the advocate ‘Advocate3’, which may indicate that ‘Advocate1’ may be notified first of a request associated with ‘Vendor2’. Any type of rating and/or ranking information may be indicated in the vendor advocate rating field 1130.

The vendor communication info field 1135 may include information of a device and/or service which may include a location thereof associated with a vendor. Content of the vendor communication info field 1135 may be modified based on actions of a vendor. If a vendor establishes communications with the search system 130 (FIG. 1) using a device and/or service, information regarding the device and/or service may be included in the vendor communication info field 1135. Any type of communication service and/or system may be indicated in the vendor communication info field 1135. For example, a username and/or password associated with a vendor may be indicated in the vendor communication info field 1135. Communication services such as IM, e-mail, SMS, MMS, EMS, telephone, wireless or wired communication, etc., may be indicated in the vendor communication info field 1135. A telephone number, an email address, an IM provider and login ID, a keyword associated with a service, an IP address, a MAC address, a URL, etc., may be indicated in the vendor communication info field 1135. The vendor communication info field 1135 may include information of an API or other communication protocols which may be used to exchange information between the search system 130 (FIG. 1) and a vendor. Using the example illustrated in FIG. 11, the URL ‘https://Vendor2.com/login/’ and the API ‘Vendor2 API definitions’ are associated with the vendor ‘Vendor2’. In at least one embodiment, a published API of a vendor may be used to allow a purchase to be facilitated.

As illustrated in FIG. 12, an exemplary a vendor user record 1200 is provided, of which one or more may be associated with or resident in the vendor system database 180 (FIG. 1). The vendor user record may include a vendor user ID field 1205, a vendor user security info field 1210, a vendor user payment information field 1215, a vendor user fulfillment field 1220, a vendor user history field 1225, vendor personal info field 1230, and vendor user search system ID field 1235.

The vendor user ID field 1205 preferably contains a unique identifier of a user, which is preferably used consistently. For example, in at least one embodiment, the vendor user ID field 1205 can include a randomly generated numerical code, and/or a text string indicating a name associated with a user. A vendor user ID serves to distinguish a vendor user record associated with a user from a vendor user record associated with other users. Other unique identifiers of a user may be utilized without departing from the spirit and scope of the embodiments. In at least one embodiment, a vendor user ID may include a phone number associated with a user. Using the example illustrated in FIG. 12, ‘ChaChauser1’ is the vendor user ID associated with the vendor user record 1200. In at least one embodiment, the vendor user ID may be a user ID provided by the search system 130 (FIG. 1). For example, the search system may provide an anonymous identifier of a user to a vendor which may be used until a purchase is confirmed. In such a case, a vendor may provide pricing and/or other terms to the search system 130 which might otherwise be unavailable to a user. In at least one embodiment, the vendor user ID and the user ID of the search system 130 are identical.

The vendor user security info field 1210 may include security information associated with a user and a vendor. Information indicated in the vendor user security info field 1210 may be used to verify access to a user account with a vendor. In at least one embodiment, the vendor user security info field 1210 may include a shared identifier and/or other security information which may be provided to a vendor system such as the vendor system 170 (FIG. 1) by the search system 130 in order to facilitate a purchase from the vendor by a user.

The vendor user payment information field 1215 may include information of a payment method associated with a user. The vendor user payment information field 1215 may include information provided by the search system 130 (FIG. 1). For example, as payment information may be sensitive information, user payment information provided to a vendor may for example be a proxy provided by the search system. For example, if a user has provided payment information to the system 100 (FIG. 1), the search system 130 may make a purchase from a vendor on behalf of a user using payment information other than that provided by the user. In such an instance, aggregated sales might be charged to a payment account associated with the search system 130, and the search system 130 may track charges to users based on information indicated in the search system database 120 which is not accessible to a vendor system. This may for example allow a mark-up between a price paid to a vendor and a price paid by a user to be accounted by the search system 130. As full transaction information that is available to the search system 130 may not be available to a user and/or a vendor, the search system 130 may provide compensation to a guide, an advocate, and/or other person without disclosing compensation provided and/or payment by a user for an item and/or service. Using the example illustrated in FIG. 12, the payment information ‘Payment Type=VISA’ and ‘User Payment ID=9999.8888.9999.8888’ are associated with the vendor user ID ‘ChaChauser1’. This may indicate that a payment for a product and/or service ordered under the user ID ‘ChaChauser1’ is to be charged to an account associated with the payment information indicated. In at least one embodiment, payment information indicated in the vendor user payment information field 1215 may be provided to a vendor by a user.

The vendor user fulfillment information field 1220 may include information which allows a vendor to fulfill a user purchase request. For example, a delivery address and/or other contact information for providing a product and/or service, or a download destination information such as an IP address, an email address, or a telephone number for a software product, or other information which may be required to deliver a product or service which are well known in the relevant art may be indicated in the vendor user fulfillment information field 1220. Using the example illustrated in FIG. 12, the fulfillment information ‘Deliver to: 14550 Clay Terrace Blvd., Carmel, Ind. 46032’ is associated with the user ‘ChaChauser1’, which may indicate that a product purchased by ‘ChaChauser1’ is to be shipped to ‘14550 Clay Terrace Blvd., Carmel, IN 46032’.

The vendor user history field 1225 may include information of historical activities by a user. For example, a record of purchases and reservations of items may be indicated in the vendor user history field 1225. Information indicated in the vendor user history field 1225 may include any information regarding activities of a user. In at least one embodiment, information of purchases initiated and/or completed by a user may be indicated in the vendor user history field 1225. If a purchase is associated with an identifier of the search system 130 such as information indicated in the vendor user search system ID field 1235, a vendor may provide compensation to the search system 130 (FIG. 1) based on information indicated in the vendor user history field 1225. Using the example illustrated in FIG. 12 ‘PurchaseV1’, ‘PurchaseV2’, and ‘PurchaseV3’are associated with the user ‘ChaChauser1’.

The vendor user personal info field 1230 may include personal information associated with a user. Information indicated in the vendor user personal info field 1230 may be used for verification and/or other purposes. For example, a message may be sent to a user device associated with a phone number indicated in the vendor user personal info field 1230 in order to verify and/or confirm a purchase request and/or may be compared to a phone number associated with a user device which is associated with a purchase facilitated by the search system 130 (FIG. 1). For example, a request for an offer from a vendor may be declined if communication information associated with the request is not indicated in the vendor user personal information field 1230.

The vendor user search system ID field 1235 may include an identifier of a search system associated with a user account with a vendor. Content of the vendor user search system ID field 1235 may be used to determine how information may be exchanged between a vendor system (e.g., the vendor system 170 (FIG. 1)) and the search system 130. Information indicated in the vendor user search system ID field 1235 may be compared to information received by a vendor system in order to determine if a message has originated from the search system 130.

While payment information of a user has been illustrated as being stored in the vendor system database 180 (FIG. 1), payment information of a user may be stored in and/or associated with a user record indicated in the search system database 120. Any information which may be required to complete a transaction may be indicated in the vendor system database 180 (FIG. 1) and may be provided by the search system 130.

In at least one embodiment, a user may provide information which the user wishes to reveal selectively to the search system 130, which may be stored in the search system database 120. For example, a user may provide payment information which the search system 130 may provide to a vendor without having to reveal the payment information to a guide, who may be an advocate. Such stored information may for example allow a user to make a purchase request and/or to provide required information to a vendor without the need to explicitly provide the information to a guide. This may provide a more convenient processing of a transaction while preventing sensitive data from being revealed to a human assistant who is acting on behalf of a user for any reason.

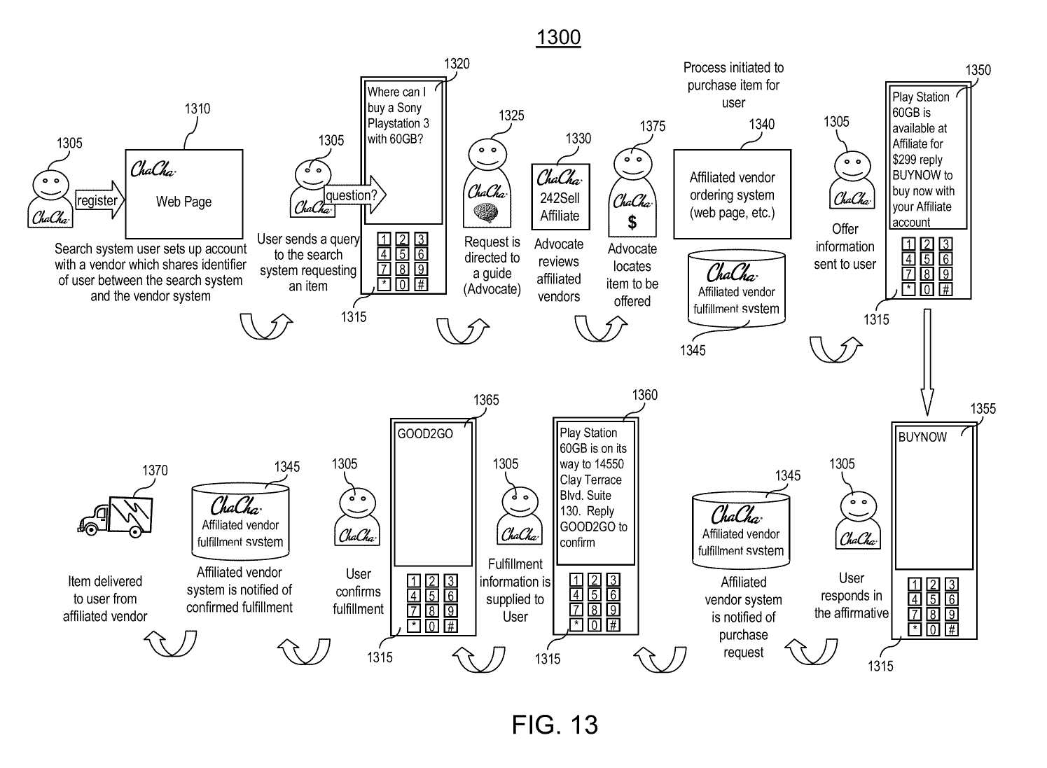

An exemplary sequence of actions 1300 for facilitating a purchase from an affiliated vendor by a user of a search system is illustrated in FIG. 13. The search system user 1305 may register with a search service and/or a vendor as described in FIG. 2, using a web page 1310 such as the GUI 400 (FIG. 4) or the GUI 500 (FIG. 5). Subsequently the user 1305 may submit a request message 1320 using a user device 1315. Information relating to the request message 1320 may be provided to a guide (advocate) 1325. If the guide 1325 determines that the user 1305 is able to make a purchase and has indicated intent to make a purchase, information of the request message 1320 may be provided to an advocate 1375. The advocate 1375 may select an item, for example, using a web page associated with a vendor ordering system 1340. The advocate 1375 may select an item determined to be a suitable response to the user 1305. The selected item number (or any other identifier) may be provided to the search system 130 (FIG. 1), which may submit a request to purchase the item to an affiliated vendor ordering system 1345. An offer message 1350 is provided to the user 1305 via the user device 1315.

The offer message 1350 may include information of a response message 1355 required to complete a purchase. The response message 1355 may, for example, include security information. If the user 1305 responds with the response message 1355 the vendor fulfillment system 1345 may analyze items such as a vendor user record associated with the user 1305 to respond with a confirmation message 1360. If the user accepts the confirmation message 1360, the user may respond with a delivery confirmation message 1365. If the vendor fulfillment system 1345 receives the delivery confirmation message 1365 the vendor fulfillment system 1345 may deliver the purchase through a fulfillment service 1370. While the example of a purchase of a product using text messaging is used for the purposes of illustration, no limitation is implied. Any service and/or product which may be purchased or acquired may be obtained using any available communication service(s) and device(s).

While examples provided herein in relation to a purchase and/or service describe a request directly pertaining to a purchase request, the present invention is not limited to facilitating a purchase/service only when a request directly indicating a purchase is received by the system 100 (FIG. 1). For example, a guide selected to process a request from a user may determine that the request may benefit from information of an offer for purchase/service and provide the same as part of a response to the request.

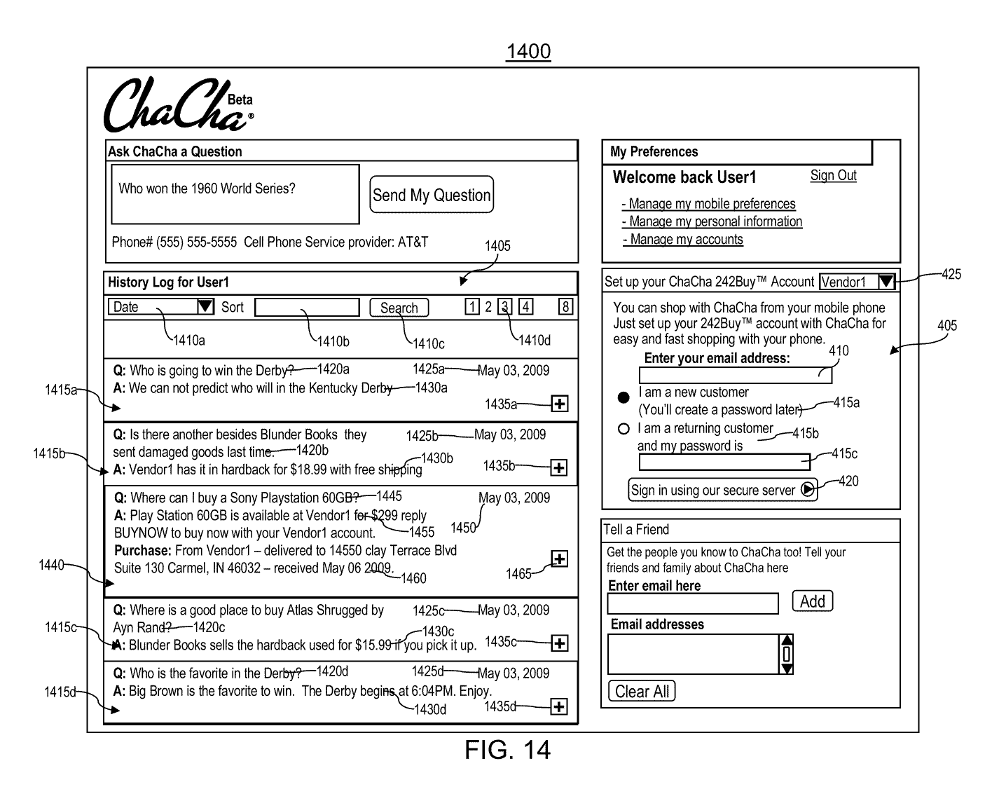

An exemplary GUI 1400 for providing a user history to a search system user is illustrated in FIG. 14. The GUI 1400 may be provided to a user who is logged in to the search system 130 (FIG. 1) using any suitable display device of a user system such as the user system 135.

The GUI 1400 may include the vendor sign up window 405 (FIG. 4), a user history window 1405, history filter controls 1410, historical query windows 1415, query indicators 1420, time stamp indicators 1425, response indicators 1430, response expansion controls 1435, a historical purchase window 1440, a purchase request indicator 1445, a purchase time stamp indicator 1450, a purchase response indicator 1455, a purchase fulfillment indicator 1460, and a purchase expansion control 1465.

The user history window 1405 may be used to provide information of historical activities. For example, previous queries, purchases, etc., associated with a user may be provided in the user history window 1405. The history filter controls 1410 may be used to control the display of information in the user history window 1405. The sort filter control 1410a may be used to affect sorting criteria applied to items in a user history. For example, activation of the sort filter may provide a ‘drop-down’ list of sorting criteria such as date, type of item (purchase, information request, etc.). Any number of sort filter controls may be provided. The filter search box 1410b may be used to provide a search target, the filter search button 1410c may be used execute a search based on content of the filter search box 1410b. The page filter controls 1410d may be used to select a page of results on demand.

The historical query windows 1415 may provide information of historical requests. The historical query window 1415a provides information of a historical search request. The ‘Who is going to win the Derby?’ historical query indicator 1420a provides information of a query. The ‘May 3, 2009’ time stamp indicator 1425a indicates a time associated with the ‘Who is going to win the Derby?’ query. The ‘We can not predict who will win the Kentucky Derby’ response indicator 1430a indicates a response to the query ‘Who is going to win the Derby?’ The response expansion control 1435a may be used to provide and/or hide additional information which may be associated with a request. For example, toggling the response expansion control 1435a might cause further text, a website, a guide, etc., associated with a response to the request indicated in the historical query window 1415a to be provided and/or hidden.

The historical query windows 1415b, 1415c, 1415d provide information of the queries indicated. Any number of historical query windows 1415 may be provided as needed in the GUI 1400.

The historical purchase window 1440 indicates information associated with a purchase. For example, a user might select to view all purchases, or might select purchases from a vendor, etc., using the history filter controls 1410. The purchase request indicator 1445 indicates information of a request which initiated a purchase. The purchase time stamp indicator 1450 indicates a time associated with a purchase. The purchase response indicator 1455 indicates a response associated with a purchase. The purchase fulfillment indicator 1460 indicates fulfillment information associated with a purchase. The purchase expansion control 1465 may be used to provide and/or hide information associated with a purchase. For example, toggling the purchase expansion control 1460 might cause further text, a website, a guide, etc., associated with a response to the request indicated in the historical purchase window 1440 to be provided and/or hidden.

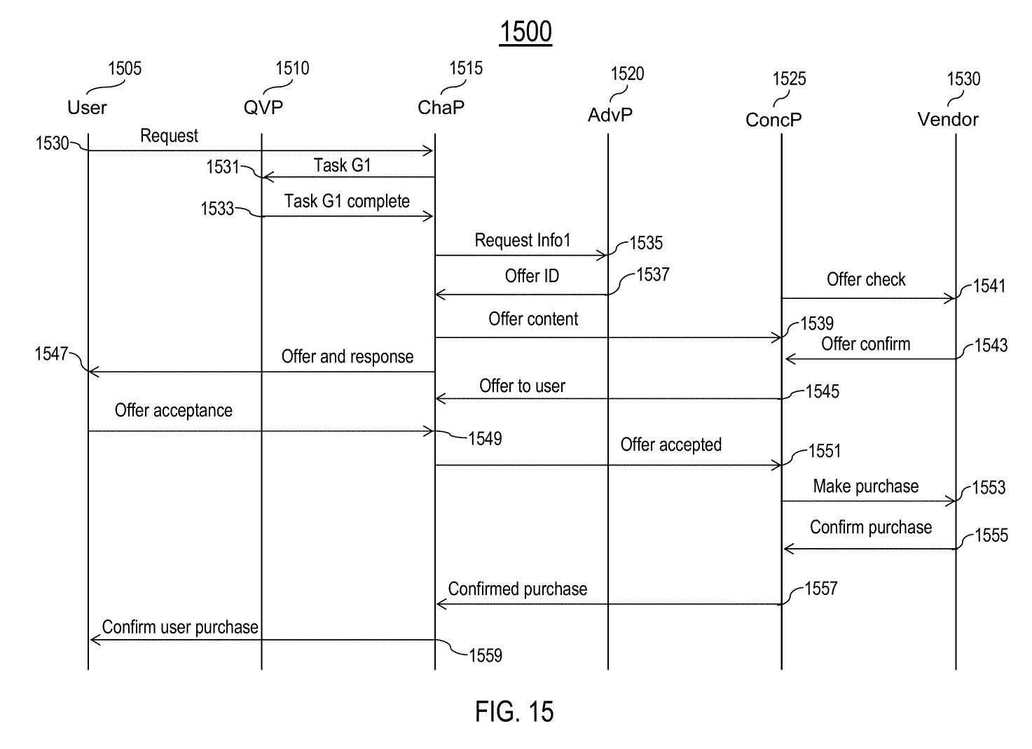

An exemplary message flow diagram 1500 for facilitating a purchase with an affiliated vendor responsive to a request is illustrated in FIG. 15. A user system 1505 sends a ‘Request’ (user request) message 1530 to a ‘ChaP’ process 1515. The ‘ChaP’ process 1515 may act to route messages, including such as selecting a guide, etc., and to record ‘persist’ information as needed. The ‘ChaP’ process 1515 may send a ‘Task G1’ message 1531 to a ‘QVP’ process 1510. The ‘QVP’ or query vetting process may, for example, provide a user query to a selected guide who may associate a category, keyword, profile, structured query and/or other information with a query. The selected guide or expediter may determine that a query indicates intent to purchase an item or service. An expediter may select a vendor associated with a request. Any or all of the QVP processing may be automated. When the task is completed, the ‘QVP’ process 1510 may transmit a ‘Task G1 complete’ message 1533 to the ‘ChaP’ process 1515. Responsive to the ‘Task G1 complete’ message 1533, the ‘ChaP’ process 1515 may transmit a ‘Request info1’ message 1535 to an ‘AdvP’ process 1520. The ‘AdvP’ process 1520 may provide information of a user request to a selected advocate who may select a vendor, and may identify a product and/or service available from a vendor which may be offered to a user. Any or all of the processing associated with the ‘AdvP’ process 1520 may be automated.

After completion of the processing of the request, the ‘AdvP’ process 1520 may transmit an ‘Offer ID’ message 1537 to the ‘ChaP’ process 1515. Responsive to the ‘Offer ID’ message 1537 the ‘ChaP’ process 1515 may transmit an ‘Offer content’ message 1539 to a ‘ConcP’ process 1525. The ‘Offer content’ message 1539 may include information such as an item ID, a vendor ID, a user ID, etc., which may be required by the ‘ConcP’ 1525 to complete a purchase transaction. The ‘ConcP’ process 1525 may include the services of a human assistant. Responsive to the ‘Offer content’ message 1539, the ‘ConcP’ process 1525 may transmit an ‘Offer check’ message 1541 to a ‘Vendor’ process 1530. The ‘Offer check’ message 1541 may conform to an API defined by the search system 130 (FIG. 1) and/or a vendor in order to pass required information to the ‘Vendor’ process 1530. The ‘Offer check’ message 1541 may include an identifier of a user, an identifier of the search system 130 (FIG. 1), and other information required for the ‘Vendor’ process 1530 to confirm availability of an offer to a user. Responsive to the ‘Offer check’ message 1541 the ‘Vendor’ process 1530 may transmit an ‘Offer Confirm’ message 1543 to the ‘ConcP’ process 1525. Responsive the ‘Offer confirm’ message 1543, the ‘ConcP’ process 1525 may transmit an ‘Offer to user’ message 1545 to the ‘ChaP’ process 1515. The ‘Offer to user’ message 1545 may include response information required to confirm a purchase, which may have been provided by the ‘Vendor’ process 1530 and/or the ‘ConcP’ 1525. Responsive to the ‘Offer to user’ message 1545 the ‘ChaP’ process 1515 may transmit an ‘Offer and response’ message 1547 to the user 1505. The ‘Offer and response’ message 1547 may include information of an offer and a response, as well as any other information required to deliver a message to a user.

Responsive to the ‘Offer and response’ message 1547, the user 1505 may transmit an ‘Offer acceptance’ message 1549 to the ‘ChaP’ process 1515. The ‘ChaP’ process 1515 may parse the ‘Offer acceptance’ message 1549 in order to confirm that content of a message identifies the message as the ‘Offer acceptance’ message 1549. Responsive to the ‘Offer acceptance’ message 1549 the ‘ChaP’ process 1515 may transmit an ‘Offer accepted’ message 1551 to the ‘ConcP’ process 1525. The ‘ConcP’ process 1525 may confirm that content of the ‘Offer accepted’ message 1551 includes any information required to confirm a purchase with the vendor. Responsive the ‘Offer accepted’ message 1551, the ‘ConcP’ process 1525 may transmit a ‘Make purchase’ message 1553 to the ‘Vendor’ process 1530. Responsive to the ‘Make purchase’ message 1553, the ‘Vendor’ process 1530 may transmit a ‘Confirm purchase’ message 1555 to the ‘ConcP’ process 1525. The ‘ConcP’ process 1525 may compare content of the ‘Confirm purchase’ message to information stored in the search system database 120 (FIG. 1) to verify that a purchase has been completed and is recorded in the search system database 120. Responsive to the ‘Confirm purchase’ message 1555, the ‘ConcP’ process 1525 may transmit a ‘Confirmed purchase’ message 1557 to the ‘ChaP’ process 1515. The ‘ChaP’ process may record information of a purchase in the search system database 120 associated with a guide and/or an advocate associated with a confirmed purchase. Responsive to the ‘Confirmed purchase’ message 1557, the ‘ChaP’ process 1515 may transmit a ‘Confirmed user purchase’ message 1559 to the user 1505. The ‘Confirmed user purchase’ message 1559 may include information of a completed purchase, as well as any other information required to deliver a message to a user.

The processes illustrated in FIG. 15 may reside in multiple instances on any suitable elements of the system 100 (FIG. 1). The ‘User’ process 1505 acts as a user communications object. Any type of user device and/or system might interface to the ‘User’ process 1505 in order that a user may submit a request and receive a response. The ‘QVP’ process 1510 acts to parse and categorize a request. If a guide is needed to process a query before it is provided to another guide, and/or a response is delivered to a user, the ‘QVP’ process manages the communication with the guide. The ‘ChaP’ process 1515 acts as a central task router. If a request is received, the ‘ChaP’ process analyzes the current status of the request and delivers it to the appropriate process such as the ‘User’ process 1505, the ‘QVP’ process 1510, etc. The ‘AdvP’ 1520 is used to obtain an offer responsive to a request. An offer may be obtained by the ‘AdvP’ 1520 automatically, or using the assistance of an advocate, who may also be a guide. As with the ‘QVP’ process 1510, the ‘AdvP’ manages communication with the human assistant. The ‘ConcP’ process 1525 performs communication with a vendor and ensures the private information of the user is not exposed to a guide. In at least one embodiment, a guide may participate in the activity of the ‘ConcP’ process 1525. In at least one embodiment, the ‘ConcP’ process is entirely automatic. The ‘Vendor’ process 1530 acts as an interface to a vendor system. In at least one embodiment, the ‘Vendor’ process 1530 allows data to be passed through various vendor API's without needing to adapt the rest of the communication flow 1500 as more vendors are added. While the message flows have been illustrated with a single message, it will be immediately obvious to one of ordinary skill in the relevant art that multiple messages may be exchanged between the processes and/or systems as part of a message. Any or all messages between processes and/or systems may include multiple messages according to suitable protocols.

Using the methods and systems described herein a user account with a search system is linked with a user account associated with one or more providers of item, product and/or service or vendors. The association between the user account with the search system and a user account with a vendor may be used to facilitate a purchase transaction with the vendor using the services of a guide and/or a human purchase assistant or advocate who may select a product and initiate a transaction on behalf of a user which may be completed by interaction between the user and the search system without revealing account information associated with a user to a guide and/or an advocate.

Vendors may elect to be associated with the search system and may provide a facility whereby a user may create an account with the search system which may be linked with a user account with the vendor. Likewise, a vendor may be associated with the search system, and the search system may allow a user to create an account with a vendor which is associated with a user account with the search system. In at least one embodiment, if a user has indicated interest in purchasing an item, the search system may identify one or more vendors who are associated with the item and may offer a user the opportunity to create an account with the vendor which is associated with the search system in order that future purchases may be facilitated by the search system.

As the search system may provide various types of information to a user, the generalized information portal of the search system may allow a vendor access to customers who would otherwise be frustrated by the difficulty of accessing information from a vendor and selecting a product while using for example, a mobile device. A ‘walk up’ facility may be provided whereby payment information provided to the search system may be utilized to facilitate a purchase with a vendor identified by the search system which may allow the user to create an account with the vendor including with limited information required from the user. By providing an API to a vendor, a transaction may be initiated by a guide on behalf of a user without requiring a user to interact extensively with a vendor. A guide and/or advocate facilitating a purchase/service may be compensated by the search system and/or a vendor based on measurements associated with a purchase. A guide and/or advocate may be ranked and may be selected based on information associated with a request, such as content of the request, a categorization associated with the request, a geographic, demographic, personality, or historical profile associated with a request, etc.

A user may search information indicated in a personal database in various ways using current systems. For example, a user may organize information using an application such as Microsoft Outlook® which might include names, addresses, phone numbers, email messages, calendar information, etc. Likewise, a user might keep records of personal information such as financial data, documents, email messages, or other types of documents which may be indexed. Applications such as Google Desktop, Lucene, Swish-E, or others may be implemented to index documents of various types and may allow a user to organize information of various types. A user may be able to select various types of organizational paradigms such as designated fields in the case of contacts, keywords found in the body, header, name, etc., of a file, types of files and/or other indexing keys.

The ability to index personal information has proven to be valuable, and access to such information is desirable in various instances. For example, a user might synchronize a hand-held device such as a smart phone, a PDA, etc., with a file system maintained on another device such as a desktop PC in order to provide access to the indexed information in a repository on one device via the second device. However, such systems may encounter limitations. If a user does not have access to a device which contains the desired information, he may be unable to obtain information at need. Use of a human assistant who can search for confidential information is often desirable. For example, a person might call a trusted assistant to obtain information regarding contacts, or other types of documents by searching files on a PC or a server system which has access to the information. However, a trusted assistant who has access to the desired information may not always be available.

A user registers with a search system and may create or provide access information for a repository of information. A user may designate any or all elements of the content of the repository as information which may not be explicitly revealed to a human searcher or guide. A guide may be able to querying a database to locate information in the repository. Information indicated in the repository of ‘masked’ or redacted data may be indexed using conventional indexing methods. A user may be presented with various types of organizational paradigms such as folders, tags, keywords, etc., which may be used to identify items within a corpus of documents of various types which are included in a repository. A user may add, delete, or modify content of an information repository. A user may designate information which may be accessed under various conditions.

If a request is received, a unique identifier is associated with the request. A user submitting the request is identified based on an identifier associated with the source of the request. If the user is identified and the user's identity is verified, the user may be granted access to information associated with the user. A determination is made as to whether a request includes a request for information indicated in a repository of redacted information which has been created and/or associated with a user. A guide may be selected to perform a search based on information of a request made by a user in order to obtain a search result which may include information in a repository of redacted records. If a search result is obtained by a searcher, a result may be provided to a user without revealing information which has been identified as being inaccessible to the searcher or ‘redacted’. A user may be anonymous. A user may interact with one or more guides in order to obtain a search result. Redacted information may be identified by the ‘handles’ or index keys which have been associated with the redacted information, which may be unrelated and/or cryptographically related to content of the redacted information. Different guides may have different levels of access to information indicated in an information repository based on actions of a user.

A system is provided which allows a user or requester, who may be any person to submit a search request or search query or request to a search service and receive a response to the search request. A system which allows communication to occur between a user, a guide or human assistant, a resource, and/or the search system allows requests to be processed. A database comprising information regarding users, guides, resources, requests, advertisements, redacted information, categories, keywords, tags, etc., is provided.

A request submitted by a user may receive a response which is produced automatically and/or utilizing assistance of one or more human searchers or guides. In at least one embodiment, a request submitted by a user is compared to a database of requests in order to determine if a matching request is found in the database. If a matching request is found, a result associated with the matching request may be presented to a user responsive to a request.

A user may elect to register with the search system in order that a user may access information which is accessible to the system which may be provided to the user. For example, a user may create a login ID and password which may allow the user to access information using the search system, which may be used to verify the identity of the user. A user may choose to associate any number of communication services with the user in order that the user may access information associated with the user utilizing the communication services.

A user may elect to identify an item which is to be included in a repository of information which is associated with a user. A user may designate elements of the item which have restricted access and/or redacted elements. Redacted elements of an item may include items such as names, addresses, credit and/or banking information, etc. Redacted information is information which many not be explicitly revealed to a guide. Redacted data elements may be indexed and may be used to identify an item which includes the element, but the content of the element and other information associated with the element may not be explicitly revealed without suitable access rights. A guide may search for items which include a search term and/or meet one or more search criteria, but the content of the redacted element may not be revealed to the guide. A user may be provided with information indicated in the redacted elements of an item as a search result. Elements included in a repository of redacted data may be referred to as items and/or ‘objects’. The term ‘object’ is commonly used in programming systems. An ‘object’ is an instance of a ‘class’ which has defined attributes (e.g., fields and properties). A record may be used describe fields associated with an exemplary instance of an object. Methods or processes may operate on an object within a class, and the operations may modify content of a record or object, or may create a new object.

A “user” is any person or entity which may submit a request or search request. A “request” or “search request” or “query” is any request for information which may be originated by a person and/or a device or system. A user may be referred to as a “requester”, information seeker or InfoSeeker™.

A “guide” is any person who may be compensated and/or may be a volunteer who may respond to and/or assist with a request. An “ambassador” is a guide who may perform processing of a request and/or a search result. A “searcher” is a guide who may perform an information search responsive to a request. A “transcriber” who may also be a guide may convert a spoken portion of a request into text, and/or may otherwise convert information of a request from one form to another. A guide may be referred to as a “human assistant” or “human searcher” or “searcher”. A guide may perform any type of task. Any guide may act in any defined guide role. However, a human assistant who performs a task and a guide who conducts a search may not necessarily be the same. For example, a human assistant may perform a task to facilitate a search which is conducted by another person who is registered as a guide. A “guided request” is a request which uses the assistance of one or more guides.

An “identifier” or ID may include character, number and/or other type of information which may be used to identify an item including item of a database. Items may include but are not limited to a guide, a user, a resource, an advertisement, a keyword, a category, a search result, a search request, a query, a rating, ranking, a message and/or a profile.

A “result” or “search result” or “answer” is any information which may be provided responsive to a request. A result includes, but is not limited to, any of an advertisement, a link to a web page, a message of any sort, image, audio, text, games, interactive media and/or software of any sort.

A “search resource” or “resource” is any source of information which may be used to obtain a search result. A search resource includes automated and/or human-assisted systems, any repository of information, and any type of media and/or systems which may provide information. A resource may be a provider or source of item and/or service. For example, a resource might provide an item such as a ringtone, a media file (e.g., audio, video, images, games, etc.), information such as news, lyrics, song titles, translations or any other type of information. A resource may be automated, and/or may utilize the assistance of a person.

A “profile” is one or more characteristics which may be associated with a person. Profile characteristics include but are not limited to demographic, geographic, personality, affiliations, areas of interest, historical actions, preferences, memberships, associations, etc.

An “advertisement” is any information which may be delivered to a user including to promote a provider, a product, a service, etc. An advertisement may include text, links, audio, video, images, printed materials, interactive media such as a game, or other forms of media which may be provided to a user device.

A “category” or “taxonomy branch” or “categorization” is a unique node within an index which may be associated with any number of items. If a request is associated with a category, items associated with the category may be more likely to be selected responsive to the request.

The terms voice and speech are used interchangeably herein. A user, a resource, and/or a guide may establish a communication session using a voice service, a messaging service such as Short Messaging Service (SMS), Enhanced Messaging Service (EMS), Multi-media Messaging Service (MMS), Instant Messaging (IM), email, an internet portal or web page, regular mail or any other type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session. A landline phone, a specialized communication terminal, or any other communication device might be used to establish a communication session.

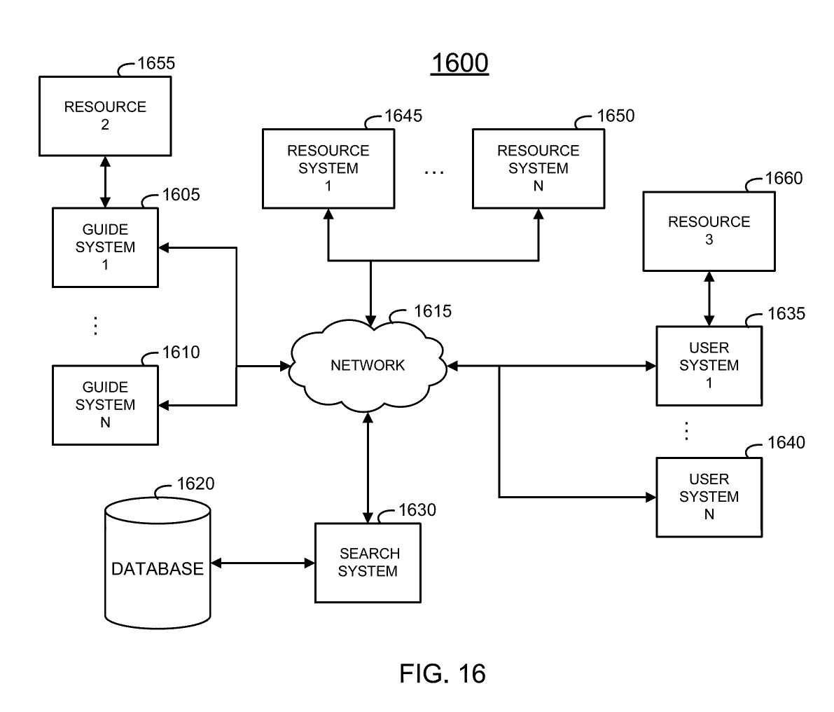

Communication between a guide, a user, a resource and/or a search system may include conversion of text to speech and speech to text. Any type of conversion and/or other processing of information which may facilitate communication between a user, a guide, a resource and/or a search system may be performed by an element of the system 1600 (FIG. 16). Any type of media which can be sent and/or received using a communication system may be part of a communication session. A communication session may be conducted using any or all communication service associated with a user, a resource and/or a guide. Any communication session may include communication via multiple service and/or device. For example, a request may be submitted as a voice query, which might indicate an image located on a resource accessible to a user and/or a guide, the voice query might be converted to a text message, the image might be processed in order to associate a tag and/or other images with the image, and a response might be provided as a spoken reply to a mobile phone associated with a user, and a video presentation which is accessible via a high-speed connection, which might be delivered to a browser functionality of a different user device.

An advertisement may be transmitted including during any or all communication sessions between a user, a guide and/or a search system. A resource, a guide, and/or an advertisement may be rated. Rating information may be obtained from a user, a guide, a resource and/or a search system. Rating information may be used to select a resource, a guide, an advertisement and/or any item based on information associated with an item indicated in a database. A search service may be compensated by advertising revenue. Advertising or content may be delivered to a user, and/or guide using any service associated with a user and/or guide

As illustrated in FIG. 16, system 1600 includes guide system 1605, 1610, a network 1615 such as the Internet, a search system 1630, user system or information seeker system 1635, 1640, a database 1620, which may comprise various records, a resource 1655, and resource systems 1645, 1650, and a resource 1660.

While only a limited number of systems associated with a guide (also referred to as a human searcher or human assistant), resource (also referred to as a search resource), user (also referred to as an information seeker or requester) and as a search system are depicted in FIG. 16, it is within the scope of the disclosure for multiple systems for guide, resource, information seeker and search systems to be utilized.

Any user system (e.g., the user systems 1635, 1640) can be operated by an information seeker, who may be any person, to submit a search request to the search system 1630 and/or receive a search result and/or other information. Any guide system (e.g., the guide systems 1605, 1610) can be operated by a human searcher to obtain a search result responsive to a request which may have been submitted by an information seeker located at a user system (e.g., the user systems 1635, 1640). Any resource system (e.g., the resource systems 1645, 1650) may be operated by a human provider of information and/or may be an automated system which may provide a search result and/or other information to a guide and/or a user, such as a search engine, a database, a local information source of a guide system such as a disk or removable memory, etc. A resource may not be accessible using the network 1615. For example, a resource such as the resource 1655 may be accessible to a guide operating a guide system such as the guide system 1605, or a resource such as the resource 1660 ‘Resource 3’ may be accessible to a user operating the user system 1635. A resource might include printed materials, images, video, and/or audio information, a software application, any information accessible to a guide, a user, a database, a system and/or any combination thereof.

The network 1615 (FIG. 16) may be a global public network of networks (the Internet) and/or consist in whole or in part of one or more private networks and communicatively couples the guide systems 1605, 1610, the resource systems 1645, 1650 and the user systems 1635, 1640 with the other components of the system such as the search system 1630, and the database 1620. The network 1615 may include one or more wireless networks which may enable wireless communication between the various elements of the system 1600. For example, a mobile phone carrier network might be used to connect a user device to the search system 1630.

The search system 1630 allows interaction to occur among the guide systems 1605, 1610, the resource systems 1645, 1650 and the user systems 1635, 1640. For example, an information search query can be transmitted from the user systems 1635, 1640 to the search system 1630, where a search query can be accessed by the guide systems 1605, 1610 and/or the resource systems 1645, 1650. Similarly, a search result or response produced from the resource systems 1645, 1650 using the guide systems 1605, 1610 in response to a search query submitted by the user systems 1635, 1640 may be transmitted to the search system 1630, where it may be stored by the search system 1630 and/or may be transmitted to the user systems 1635, 1640. Any type of communication between a user, a guide, and a resource may be mediated and/or facilitated by the search system 1630, and/or other elements of the system 1600.

The search system 1630 is communicatively coupled with the database 1620. As will be described herein in further detail below, the database 1620 includes data that is processed in association with operation of the embodiments. Although FIG. 16 illustrates the database 1620 as a separate component of the system, the database 1620 may be integrated with the search system 1630. Further, the records maintained in the database 1620 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 1620 may reside in any suitable elements of the system 1600. Any or all elements of the system 1600 may include any or all of the database 1620.

The user systems 1635, 1640, the guide systems 1605, 1610, the search system 1630 and the resource systems 1645, 1650 may include equipment, software, systems and personnel required to send and/or receive messages between a user system, a guide system, a resource system and/or the search system using the network 1615. The database 1620 includes information which may allow the search system 1630 to establish communication between any or all of the elements of the system 1600.

A user system, a guide system, and/or a resource may be a desktop or mobile PC or Mac®, a mobile phone, a smart phone, a PDA, a server system, a landline phone, a specialized communication terminal, a terminal connected to a mainframe, or any other communication device and/or system. The search system 1630 may include one or more servers, computers, etc. For example, servers such as the PowerEdge® 2900 by Dell, or the BladeCenterJS22 by IBM, or equivalent systems might be used to implement elements of the search system 1630. The search system 1630 may utilize an operating system (OS) such as Microsoft Windows XP, or Linux, etc. Voice routing and packet switching may be accomplished using well established technologies such as those provided by Cisco®, or other networking companies. After being presented with the disclosure herein, one of ordinary skill in the relevant art will immediately realize that any viable computer systems and/or communication devices known in the art may be used as user systems, guide systems, resources, and/or to implement the search system 1630.

A guide may be required to register with the search system 1630. As part of a registration process, at least one communication method is associated with a guide. In at least one embodiment, a guide may register with the search system 1630 and establish a username and password which are associated with the guide. A guide may login to the search system 1630 using a web browser functionality of guide system 1605, 1610 in order to communicate with the search system 1630. Multiple communication services may be associated with a guide and may allow a communication session to be established between a guide system such as the guide system 1605 and a user system, a resource system and/or the search system 1630. Multiple identifiers of a guide may be associated with each other. Information such as IM credential, an email address, a phone number, a URL, a username, etc., of a guide may be identified which may allow the search system 1630 to establish a communication session between a guide system and a user system, a resource system, and/or the search system 1630.

When a guide registers with the search system 1630 the guide may be associated with one or more keywords, categories, and/or other information. For example a keyword or category may be selected by a guide, or may be associated with a guide based on a test administered to a guide and/or other information provided during and/or after a registration process. Information associated with a guide may be stored in the database 1620 and may be used for purposes such as matching a guide to a user request, determining and/or providing compensation for a guide, communicating with a guide, etc., as will be described further herein.

A user may be identified by the search system 1630. When a user system such as the user system 1635 establishes a communication session with the search system 1630, an identifier of a user system is determined. An identifier of a user system may be associated with other information regarding a user. A user system may be identified using an email address, a telephone number, an IM credential, a username, or any other identifier which may be used to associate information with a user. Multiple identifiers of a user may be associated with each other. Using information of communication services associated with a user, a communication session may be established between a user system such as the user system 1635 and a guide system, a resource system and/or the search system 1630. Information such as a keyword, a category, a user profile, a previous search request, a search result, etc., may be associated with a user. Information of a user may be stored in the database 1620.

A resource, which may be a person, an entity, a search engine, a database, a software application, a corpus of one or more types of media such as text or printed information, images, audio, video, etc., or a combination thereof may be identified by the search system 1630. Any source of information may be a resource within the context of the disclosure herein. Information of at least one method of communication is associated with a resource system which allows a communication session to be established between the search system 1630, a user system 1635, 1640, and/or a guide system 1605, 1610 and a resource system such as the resource systems 1645, 1650. An identifier of a resource system may be associated with other information regarding a resource. A resource system may be identified using an email address, a telephone number, an IM credential, a resource username, a URL or other persistent identifier which may be used to associate information with a resource. Multiple identifiers of a resource may be associated with each other. Using the information of communication services associated with a resource, a communication session may be established between a resource system such as the resource system 1645 and a user system, a guide system, and/or the search system 1630. Information such as a keyword, a category, a profile, or other information may be associated with a resource. Information of a resource may be stored in the database 1620.

A resource such as the resources 1655 and/or resources accessible via the resource systems 1645, 1650 may include any system, software, hardware, personnel and/or other facility which may provide information to a guide, a user, and/or the search system 1630. For example, a resource may be a search engine, a database system, a library, a personal hard drive and/or other local storage, printed materials, recordings of any sort, a software program, a person or person, an organization, etc. A resource may be freely accessible to any user and/or guide and/or may be available on a restricted basis. The resource system 1645, 1650 may include resources which are available on an unrestricted and/or restricted basis. A resource may not be accessible using the network 1615, but may be accessible to selected guide. For example, a resource such as the resource 1655 may be accessible to one or more guide operating a guide system such as the guide system 1605 using any type of communication. For example, a guide may obtain information of an event to provide a search result. Information in any form, such as printed media, audio and/or visual information, software, hardware, etc., which may be accessible to a guide, a user and/or an operator of a resource system may be a resource.

The search system 1630 may establish a communication session between any user system, guide system, or resource system using information indicated in the database 1620. For example, the user system 1635 may establish a voice communication session with the search system 1630, the search system 1630 may establish a voice communication session between the user system 1635 and the guide system 1605, and the search system 1630 may establish a voice communication session between the user system 1635 and the resource system 1645. While a voice communication session is used in this example, any type of communication session using one or more services such as SMS, EMS, MMS, email, IM, chat, web based communication, etc., may be established between any user system, guide system, and/or resource system and/or the search system 1630.

Information associated with a user, a guide and/or a resource may be obtained in various ways. For example, a registration process may be performed using a web form provided by the search system 1630, and/or information may be obtained from an external database, and/or information may be obtained based on analysis of information indicated by a user, a guide, and/or a resource. A ‘profile’ is one or more characteristics which may be associated with one or more individuals. A profile may include geographic data such as a street address, latitude and longitude, etc., may include demographic information such as age, gender, race, income, family size, political affiliations, etc., may include personality information such as results of psychometric testing, subjective evaluations of an individual, etc., may include affiliation information such as employment, club, activity, societal membership information, information of a device, service, transaction and/or any information which might be associated with a user and/or a guide.

A resource may include information which is included in a repository of ‘private’ or redacted data as designated by a user. A resource which has restricted access may include information associated with a repository of redacted data records. For example, banking information which is accessible under password control might be included in a repository of redacted data, or documents in a company private, or personal collection might be included in a repository of redacted data. Information from social networking sites, blogs, etc., may be indicated in a repository of redacted data or information.

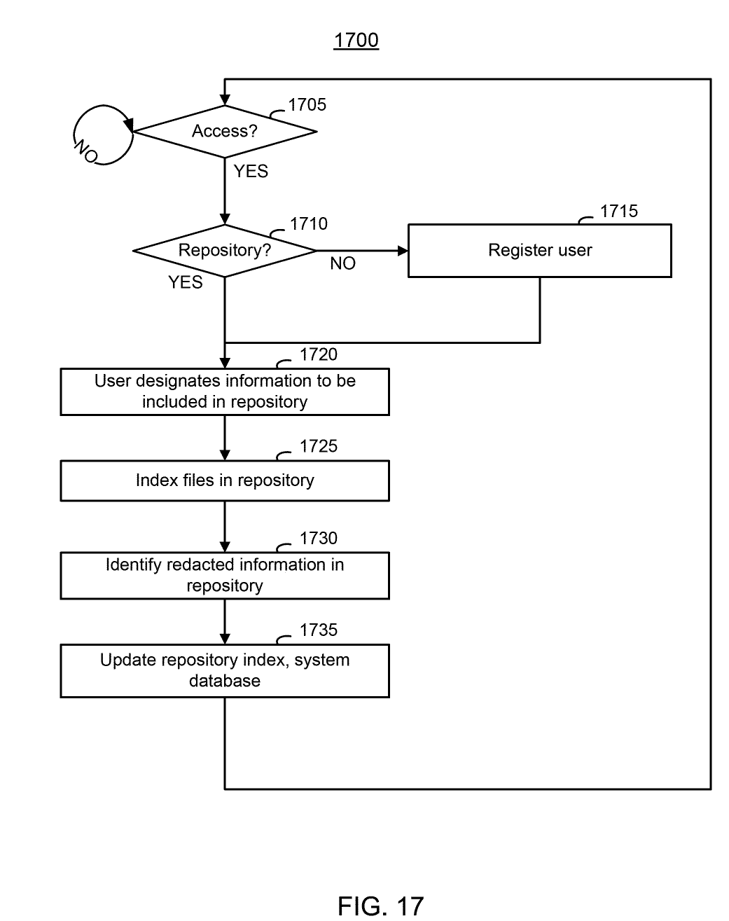

As illustrated in FIG. 17, a process 1700 for creating and indexing a repository of redacted information is provided. The process 1700 may for example be operative on a server associated with the search system 1630 (FIG. 16).

In operation 1705 (FIG. 17) a determination is made as to whether a request for access is received. If it is determined in operation 1705 that a request for access is not received control remains at operation 1705 and process 1700 continues. If it is determined in operation 1705 that a request for access is received, control is passed to operation 1710 and process 1700 continues.

The determination in operation 1705 may be made based on various criteria. It may be determined that a request for access is received based on receiving a message at any device associated with the search system 1630 (FIG. 16). For example, a voice message might be received at telephone number, an SMS message might be received, an IM might be received, an email might be received, a web request might be received, and/or a message using any services associated with the search system 1630 might be used to determine that a request has been received. A request may be received through an API. Security information may be obtained from a user in order to verify that a request for access is associated with the user.

In operation 1710 (FIG. 17) a determination is made as to whether a repository of redacted information is associated with a user who is associated with the access request. If it is determined in operation 1710 that a repository of redacted information is not associated with a user control is passed to operation 1715 and process 1700 continues. If it is determined in operation 1710 that a repository of redacted information is associated with a user, control is passed to operation 1720 and process 1700 continues.

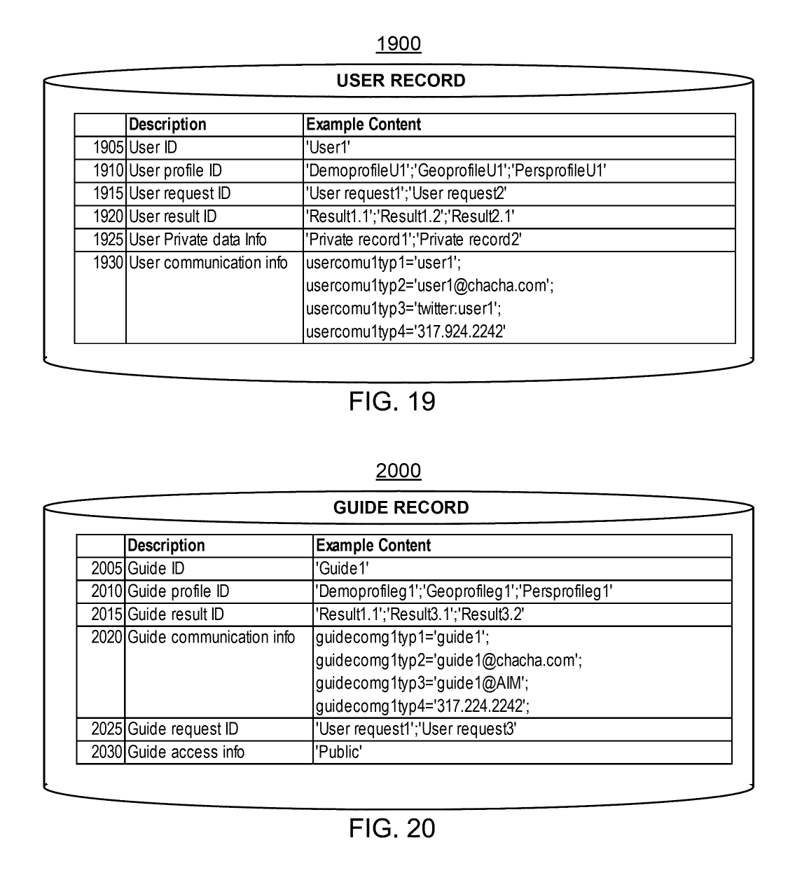

The determination in operation 1710 may be made based on various criteria. In at least one embodiment, information indicated in a user record such as the user record 1900 (FIG. 19) may be used to determine if a repository of redacted information is associated with a user. For example, a username associated with a user may be used to ‘look up’ information in a user record.

In operation 1715 a user is registered. A user may for example be required to provide personal information, which may be used to verify the identity of the user. Information may be obtained which may be used to associate a communication service with the user which may be used to access information associated with the user. For example, a URL associated with a resource, and access information of the resource, or an email account and security information associated with the account may be obtained. In at least one embodiment, a web form may be provided by the search system 1630 (FIG. 16) in order that a user may register. Control is passed to operation 1720 and process 1700 continues.

In operation 1720 a user designates information which is to be included in a repository of redacted information. For example, a user may designate various items which are to be indexed in order to allow a searcher to locate information in the repository of redacted information. The items designated may or may not be stored in the database 1620 (FIG. 16). Some or all of the items designated may remain in storage associated with a user system, and/or a resource. Likewise a user may elect to identify items which are currently included in a repository of redacted information which are to be removed from the repository index. In such an instance, the item itself is not necessarily deleted, but associations between the item and the index of the repository are deleted. Alternatively, item(s) of information generally perceived to be secure may be automatically included in the repository. Control is passed to operation 1725 and process 1700 continues.

In operation 1725 an index of the files (items) indicated in the repository of personal information is updated and/or created. Items which are included in the repository may be scanned using a search facility which may create various types of indexes of information indicated in the repository. For example, structured documents such as a ‘.pst’ file which may include email files, contacts, calendar data, etc., may be indexed based on content of any or all fields which are included in a database structure associated with a file. An indexing functionality such as Lucene, which may be utilized in a framework such as Microsoft.NET may for example be used to locate keywords, determine keyword frequency, etc. in order to allow rapid retrieval of information which is indicated in a personal repository. Information associated with any sort of object may be indexed based on the content of any element of the object. For example, the body, the title, etc., of a document such as a spreadsheet, a text file, etc., may be scanned for keywords, or media files such as image, audio or video files may be scanned to locate tags and/or other metadata associated with the files, or music files may be scanned and/or analyzed to associate metadata with the content of a file, etc. If no index exists associated with a user, a new index may be created. If objects have been added to the repository, the objects may be scanned in order to add relevant information to the index. An index may be used for various purposes as further described herein. Multiple indexes of information may be maintained, which may allow different levels of searching and/or use of redacted information. Control is passed to operation 1730 and process 1700 continues.

In operation 1730 redacted information associated with item(s) included in the repository is identified. For example, fields associated with a particular type of information in structured data may default to being redacted. For example content of any or all fields in a.pst file may be identified as redacted by a user and any new contacts added to the repository may default to have content of the same fields redacted. Alternately, an unstructured document may be indexed and a user may be allowed to select information which is to be redacted. For example, a text document might be scanned and a list of keywords located in the document might be created. In at least one embodiment, named entities, which may include persons in a contact list, may be used to identify named entities in objects indicated in a repository of redacted records. A user might for example designate that any names included in a group of contacts, and/or other information associated with the contacts should be redacted from information provided to a guide. Control is passed to operation 1735 and process 1700 continues.

In operation 1735 a database of information associated with a redacted information repository is updated. For example, if an item is removed from the repository, fields which contain a pointer to the item may have that pointer removed, information of an item and indexing information associated with the item may be recorded, information regarding conditions under which content of an item may be provided to a guide may be recorded, or information of fields associated with a type of item may be recorded. Any or all information which may be modified based on designating, identifying, and/or indexing conducted as part of the process 1700 may be recorded. Control is passed to operation 1705 and process 1700 continues.

The process 1700 may be applied to any type of item which an indexing facility may be capable of processing. An item which have been added to a resource which may for example be the ‘Resource 3’ resource 1660 which is accessible to a user may be identified and presented to a user to determine whether a user wishes to add the item to a redacted information repository. A user may for example designate that any or all items of a given type should be added to a redacted information repository and that the index of the repository should be updated if a user accesses and/or modifies any items associated with the repository.

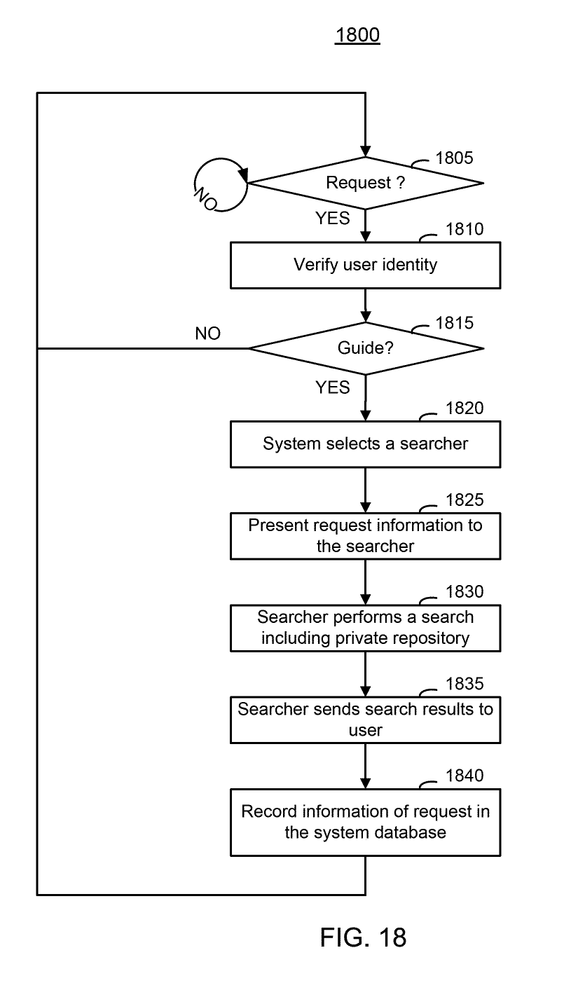

As illustrated in FIG. 18, a process 1800 for performing a search utilizing information indicated in a repository of redacted information is provided. The process 1800 may for example be operative on a server associated with the search system 1630 (FIG. 16), and/or a resource system.

In operation 1805 (FIG. 18) a determination is made as to whether a request for information indicated in a redacted information repository is received. If it is determined in operation 1805 that a request for information which includes information indicated in a redacted information repository is not received control remains at operation 1805 and process 1800 continues. If it is determined in operation 1805 that a request for information which includes information indicated in a redacted information repository is received, control is passed to operation 1810 and process 1800 continues.

The determination in operation 1805 may be made based on various criteria. It may be determined that a request is received based on receiving a message at any device associated with the search system 1630 (FIG. 16). For example, a voice message might be received at telephone number, an SMS message might be received, an IM might be received, an email might be received, a web request might be received, and/or a message using any services associated with a search system might be used to determine that a request has been received. A request may be received through an API provided in association with a resource system. In at least one embodiment, a condition which has been identified based on information indicated in the database 1620 (FIG. 16) may be used to determine whether a request for information indicated in a redacted information repository is received.

In operation 1810 an identifier of a user associated with a request is obtained and verified. In at least one embodiment, a persistent identifier of a user is obtained such as a telephone number associated with the user, a login ID associated with the user, or an identifier associated with a communication service associated with a user may be obtained. A user identifier may be used to identify information associated with a user, such as an index of a redacted information repository. A user may be required to provide security and/or identity verification information in order to gain access to a search result obtained from information indicated in a redacted information repository. Control is passed to operation 1815 and process 1800 continues.

In operation 1815 a guide or searcher is selected if indicated in the request. For example, the search system 1630 (FIG. 16) may select a searcher. A searcher may be selected in various ways. For example, a user profile may be compared to a profile associated with a searcher, a list of searchers may be ranked relative to the profile, and searchers may be notified of a request in an order based at least in part on the ranking. In at least one embodiment, a guide who is geographically separated from a user may be preferentially selected to handle a request associated with access to redacted information. Likewise, if a request associated with access to redacted information is received from a user which is related to a previous request, a searcher who has responded to the previous request may be ranked higher and/or lower when selecting a searcher to respond to the request. In at least one embodiment, a guide who has previously responded to a request associated with access to redacted data of a user may be excluded from receiving subsequent queries associated with access to redacted data of the user. In at least one embodiment, a searcher may be selected based on access rights to redacted information associated with the searcher. A guide who has access rights to read any or all of the content of redacted information may be selected based on user actions. For example, if a user requests to access sensitive data, a guide who is certified to access such information may be selected. A guide who has been certified to handle payment information and/or other personal information may be selected to respond to a query preferentially over a guide who does not have a certification. If determined that a guide is not needed at 1815, the process 1800 proceeds to 1805. Control is passed to operation 1820 and process 1800 continues.

In operation 1820 system selects a searcher (guide). For example, content of a query, content of previous queries, resources which may be associated with a query, and/or other information associated with a user associated with a query may be provided to a guide. An exemplary GUI for presenting information of a request to a guide is illustrated herein below. Control is passed to operation 1825 and process 1800 continues.

In operation 1825, a searcher is presented with information of a user request. Information provided to a guide may include a query as submitted by a user, context information such as previous queries, location information associated with a user, a category, a structured query, etc. Information of resources which may be used to obtain a search result may be provided to a searcher, including access and/or other information regarding a repository of redacted information. A request and/or a query history may include indicators which are substituted in place of redacted information as further described herein. Control is passed to operation 1830 and process 1800 continues.

In operation 1830 a searcher performs a search which may include a search of information indicated in a repository of redacted information. For example, a user may request to know ‘who do I know under 40 in Indianapolis?’ In such an instance, a searcher may query an index of a redacted information repository associated with a user to identify items associated with the location ‘Indianapolis’, and the age criteria ‘below 40’. An indicator of search result obtained based on a query submitted by a searcher may be presented to the guide. For example, information of items associated with a ‘name’ field, and/or the keyword ‘name’ may be provided to a searcher. In some instances, no records may be returned responsive to a request submitted by a searcher. Any type of search query may be submitted and/or any search activity may be performed by a guide. For example a guide might perform a first search of a public resource, and subsequently perform a search of a private repository. Control is passed to operation 1835 and process 1800 continues.

In operation 1835 a search result is provided to a user. For example, a searcher may select information of one or more item indicated in a search result obtained in operation 1830 which may be presented to a user. Actual content of a search result may not be presented to a searcher however the searcher may identify a pointer to information indicated in a redacted information record which may cause redacted information to be presented to a user. In at least one embodiment, an encrypted version of redacted content may be provided to a guide in order that the guide may utilize and/or provide redacted content to a user and/or a resource. For example an encrypted version of a person's name might be provided to a guide, who might submit the encrypted name for a search of a resource. Likewise, a result obtained by a first guide might be encrypted, which might be presented as part of a request provided to a second guide. Control is passed to operation 1840 and process 1800 continues.

In operation 1840 information of the process 1800 is recorded. For example, information associated with a request, such as a resource, a guide, a user, and/or rating, ranking and/or historical and/or usage information as further described herein associated with a resource, a user, and/or a guide may be recorded and/or associated and information of the associations may be recorded in the database 1620 (FIG. 16). In at least one embodiment, information of a search result provided to a user and/or redacted information provided by a guide may be recorded. For example, a user may be notified via a communication service associated with a user which is different from the communication service associated with a request if redacted information is provided to a user via any communication service. As previously mentioned herein above, elements of the database 1620 may be resident in any suitable systems within the system 1600 and any storage comprised in whole or in part within a resource system, a user system and/or a guide system may be considered to be an element of the database 1620. For example, information of a request, transactions associated with the request, and resources associated with the request might be recorded in storage associated with the user system 1635 responsive to a request which originated from the user system 1640 if the user system 1635 is associated with a user operating the user system 1640. Control is passed to operation 1805 and process 1800 continues.

As illustrated in FIG. 19, an exemplary a user record 1900 is provided, of which one or more may be associated with or resident in the search database 1620 (FIG. 16). The user record 1900 may include a user ID field 1905, a user profile ID field 1910, a user request ID field 1915, a user result ID field 1920, a user private data info field 1925, and a user communication info field 1930.

The user ID field 1905 preferably contains a unique identifier of a user, which is preferably used consistently. For example, in at least one embodiment, the user ID field 1905 can include a randomly generated numerical code, and/or a text string indicating a name associated with a user. A user ID serves to distinguish a user record associated with a user from a user record associated with other users. Other unique identifiers of a user may be utilized without departing from the spirit and scope of the embodiments. In at least one embodiment, a user ID may include a phone number associated with a user. Using the example illustrated in FIG. 19, ‘User1’ is the user ID associated with the user record 1900.

The user profile ID field 1910 includes information of a profile associated with a user. The content of the user profile ID field 1910 may be modified based on actions of a user. A person may select a profile which is associated with a user. For example, a user may select a profile to be associated with the user during a registration process. A profile may be associated with a user based on testing of a user and/or information from users. For example, a user may be required to demonstrate knowledge relevant to a profile in order to be associated with the profile, or a user may take a test which is used to generate a profile, or a user may provide information such as demographic, geographic, personality or other information which may be indicated in a profile associated with the user. Information indicated in a user profile may be obtained from an external database. A profile associated with a user may be used to select and/or rank a user for voting. Using the example illustrated in FIG. 19, the profiles ‘DemoprofileU1’, ‘GeoprofileU1’ and ‘PersprofileU1’ are associated with the user ‘User1’. This may indicate that ‘User1’ has indicated and/or generated the profiles ‘DemoprofileU1’ which may be a demographic profile, ‘GeoprofileU1’ which may be a geographic profile and ‘PersprofileU1’ which might indicate information regarding ‘User1’.

The user request ID field 1915 includes information of a request associated with a user. The content of the user request ID field 1915 may be modified based on actions of a user. If a user submits a search request to the search system 1630 (FIG. 16) an identifier of the search request may be included in the user request ID field 1915. Using the example illustrated in FIG. 19, the requests ‘User request1’ and ‘User request2’ are associated with ‘User1’. This may indicate that ‘User1’ has submitted the requests ‘User request1’ and ‘User request2’.

The user result ID field 1920 includes information of a result associated with a user. The content of the user result ID field 1920 may be modified based on action of a user and/or a guide. If a user receives a search result responsive to a search request, an identifier of the search result may be included in the user result ID field 1920. A usage indicator associated with a search result provided to a user may affect a rating or ranking associated with a guide. Using the example illustrated in FIG. 19, the results ‘Result1.1’, ‘Result1.2’ and ‘Result2.1’ are associated with the user ‘User1’. This may indicate that ‘User1’ has been presented with the results ‘Result1.1’, ‘Result1.2’, and ‘Result2.1’ responsive to a search request.

The user private data info field 1925 includes information of items which may be included in a repository of redacted information. The content of the user private data info field 1925 may be modified based on actions of a user. If a user designates an item to be included in a repository of redacted information, information of the item may be indicated in the user private data info field 1925. Content of the user private data info field 1925 may include any type of information which identifies an item. For example, a URL which allows access to an item, security information, a pointer to an item in a database, or any other indicator of an item may be included in the user private data info field 1925. Any number of items may be indicated in the user private data info field 1925. Using the example illustrated in FIG. 19, the files ‘Private record1’ and ‘Private record2’ are associated with ‘User1’. This may indicate that ‘User1’ has designated the items ‘Private record1’ and ‘Private record2’ to be included in a repository of redacted data.

The user communication info field 1930 includes information of a device and/or service associated with a user. The content of the user communication info field 1930 may be modified based on actions of a user. If a user establishes communications with the search system 1630 (FIG. 16) using a device and/or service, information regarding the device and/or service may be included in the user communication info field 1930. Any type of communication service and/or system may be indicated in the user communication info field 1930. For example, a username and/or password associated with a user may be indicated in the user communication info field 1930. Communication services such as Instant Messaging (IM), e-mail, SMS, MMS, EMS, telephone, wireless or wired communication, etc., may be indicated in the user communication info field 1930. A telephone number, an email address, an IM provider and login ID, a keyword associated with a service, etc., may be indicated in the user communication info field 1930. Using the example illustrated in FIG. 19, the login ‘user1’, the email ‘user1@chacha.com’, the Twitter™ service account ‘twitter:user1’ and the phone number ‘317.924.2242’ are associated with the user ‘User1’. This may indicate that ‘User1’ may be contacted using the login ID ‘user1’, via email at ‘user1@chacha.com’, via Twitter as ‘user1’ and/or via voice, text, and/or other service associated with the phone number ‘317.924.2242’. Security information associated with a user account may be indicated in the user communication info field 1930.

As illustrated in FIG. 20, an exemplary guide record 2000 is provided, of which one or more may be associated with or resident in the search database 1620 (FIG. 16). The guide record 2000 may include a guide ID field 2005, a guide profile ID field 2010, a guide result ID field 2015, a guide communication info field 2020, a guide request ID field 2025, and a guide access information field 2030.

The guide ID field 2005 preferably contains a unique identifier of a guide, which is preferably used consistently. For example, in at least one embodiment, the guide ID field 2005 can include a randomly generated numerical code, and/or a text string indicating a name associated with a guide. A guide ID serves to distinguish the guide record associated with a guide from a guide record associated with other guides. Other unique identifiers of a guide may be utilized without departing from the spirit and scope of the embodiments. Using the example illustrated in FIG. 20, ‘Guide1’ is the guide ID associated with the guide record 2000.

The guide profile ID field 2010 includes information of a profile associated with a guide. The content of the guide profile ID field 2010 may be modified based on action of a guide. A person may select a profile which is associated with a guide. For example, a guide may select a profile to be associated with the guide during a registration process. A profile may be associated with a guide based on testing of a guide. For example, a guide may be required to demonstrate knowledge relevant to a profile in order to be associated with the profile, or a guide may take a test which is used to generate a profile, or a guide may provide information such as demographic, geographic, personality or other information which may be indicated in a profile associated with the guide. Information indicated in a guide profile may be obtained from an external database. Information indicated in the content of the guide profile ID field 2010 may be compared to information indicated in the content of a profile associated with search request or request in order to determine a ranking of a guide for responding to a search request. Likewise, a profile associated with a guide may be used to select and/or rank a guide. Using the example illustrated in FIG. 20, the profiles ‘Demoprofileg1’, ‘Geoprofileg1’ and ‘Persprofileg1’ are associated with the guide ‘Guide1’. This may indicate that ‘Guide1’ has indicated and/or generated the profiles ‘Demoprofileg1’ which may be a demographic profile, ‘Geoprofileg1’ which may be a geographic profile and ‘Persprofileg1’ which might indicate personality information regarding the guide ‘Guide1’. Any or all information indicated in the profile associated with a guide may be used to determine a rating and/or ranking of a guide.

The guide result ID field 2015 includes information of a result associated with a guide. The content of the guide result ID field 2015 may be modified based on actions of a guide. If a guide produces a search result responsive to a search request, an identifier of the search result may be included in the guide result ID field 2015. A rating and/or ranking associated with a search result associated with a guide may affect compensation for a guide. Likewise a usage indicator associated with a search result provided by a guide may affect a rating or ranking associated with a guide. Using the example illustrated in FIG. 20, the results ‘Result1.1’, ‘Result3.1’ and ‘Result3.2’ are associated with the guide ‘Guide1’. This may indicate that ‘Guide1’ has provided and/or reviewed the results ‘Result1.1’, ‘Result3.1’, and ‘Result3.2’ responsive to a request.

The guide communication info field 2020 includes information of a device and/or service associated with a guide. The content of the guide communication info field 2020 may be modified based on action of a guide. If a guide establishes communications with the search system 1630 (FIG. 16) using a device and/or service, information regarding the device and/or service may be included in the guide communication info field 2020. Any type of communication service and/or system may be indicated in the guide communication info field 2020. For example, a username and/or password associated with a guide may be indicated in the guide communication info field 2020. Communication services such as Instant Messaging (IM), e-mail, SMS, MMS, EMS, telephone, wireless or wired communication, etc., may be indicated in the guide communication info field 2020. A telephone number, an email address, an IM provider and login ID, a keyword associated with a service, etc., may be indicated in the guide communication info field 2020. Using the example illustrated in FIG. 20, the login ‘guide1’, the email ‘guide1@chacha.com’, the IM credential ‘guide1@AIM’ and the phone number ‘317.224.2242’ are associated with the guide ‘Guide1’. This may indicate that ‘Guide1’ may be contacted using the login ID ‘guide1’, via email at ‘guide1@chacha.com’, via IM as ‘guide1@AIM’ and/or via voice, text, and/or other service associated with the phone number ‘317.224.2242’.

The guide request ID field 2025 includes information of a request associated with a guide. The content of the guide request ID field 2025 may be modified based on actions of a guide. If a guide produces a search result responsive to a search request, an identifier of the search request may be included in the guide request ID field 2025. A rating and/or ranking associated with a search request associated with a guide may affect compensation for a guide. Likewise a usage indicator associated with a search request and a guide may affect a rating or ranking associated with the guide. A request may be associated with a guide based on a vote cast by a guide regarding items associated with the search request. Using the example illustrated in FIG. 20, the requests ‘User request1’, ‘User request3’ are associated with the guide ‘Guide1’. This may indicate that ‘Guide1’ has responded to and/or been selected to respond to the requests ‘User request1’ and ‘User request3’.

The guide access info field 2030 may include information regarding access rights granted to a guide. For example, a guide may be allowed to access only public information associated with a repository of redacted information. Alternately, a user may designate a guide who is granted access to any or all information indicated in an item associated with a repository of redacted information. Using the example, illustrated in FIG. 20, the access information ‘Public’ has been associated with the guide ‘Guide1’. This may indicate that ‘Guide1’ may only access public information indicated in a redacted data repository. Various levels of access may be allowed for guides. For example, a guide might be allowed to handle financial information, content of various types of documents, content of a web page such as a private profile in an application such as FaceBook®, Linked-In, etc., based on access rights allowed to the guide. A user may designate a specific guide, or a type of guide who may be permitted to view certain types of documents, resources, etc. Access information may be managed by the search system 1630, which may allow a guide to access a resource without knowledge of access information of the resource.

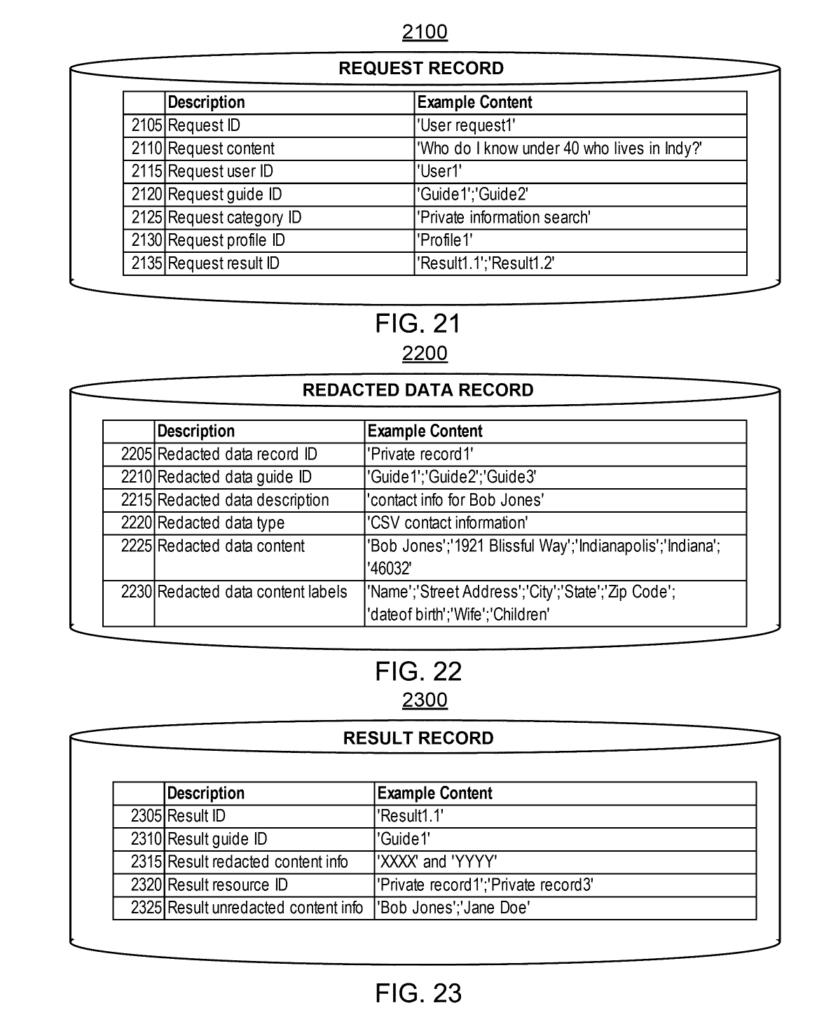

As illustrated in FIG. 21, an exemplary request record 2100 is provided, of which one or more may be associated with or resident in the search database 1620 (FIG. 16). The request record 2100 may include a request ID field 2105, a request content field 2110, a request user ID field 2115, a request guide ID field 2120, a request category ID field 2125, a request profile ID field 2130, and a request result ID field 2135.

A request record may be created when a query is received from a communication service associated with a user. A request record may include information associated with multiple communications between a user and a guide. A request record may record any information associated with a request, such as an originating device, time information, etc., in addition to the information illustrated.

The request ID field 2105 preferably contains a unique identifier of a request, which is preferably used consistently. For example, in at least one embodiment, the request ID field 2105 can include a randomly generated numerical code, and/or a text string indicating the content of a request. A request ID serves to distinguish the request record associated with a request from a request record associated with other requests. Other unique identifiers of a request may be utilized without departing from the spirit and scope of the embodiments.

A unique identifier is assigned to a request when it is entered into the search database. A user request record may include information that is not explicitly entered by a user/requester. For example, location information, profile information, etc., may be associated with a request automatically and/or based on actions of a guide. If a message received from a user is determined to be associated with a previous request associated with the user, information of the message may be added to the request record associated with the previous user request. The association of a request with a user may be used to provide context information to a guide based on previous requests associated with a user. As illustrated in FIG. 21, ‘User request1’ is the user request ID associated with the user request record 2100 (FIG. 21).

The request content field 2110 includes information regarding content of a request. For example, text associated with a query submitted by a user may be indicated in the request content field 2110. Such information may be processed in order to associate a keyword and/or category or other information with a request. In at least one embodiment, a structured query which conforms to a specific context may be indicated in the request content field 2110. Information such as audio recordings, images, etc., which are associated with a request may be indicated in the request content field 2110. Using the example illustrated in FIG. 21, the query ‘Who do I know under 40 who lives in Indy?’ is the content associated with the request record 2100. This may indicate that the query ‘Who do I know under 40 who lives in Indy?’ may be the content of the request ‘User request1’. If a user request is determined to match a previous request, the user may be presented with a search result based on stored information associated with the matching request. Automated processing of a user request may be preferentially performed.

The request user ID field 2115 includes information of a user associated with a query. The request user ID field 2115 may be used to associate a user with a query. For example, a telephone number associated with a device which was used to submit a request may be compared to content of the user communication info field 1930 (FIG. 19) to associated a user ID with a request. Information indicated in the request user ID field 2115 may be used to obtain information of a user using a record such as the user record 1900 (FIG. 19). For example, security information used to verify access to a search result obtained using a repository of private information may be obtained based on a user ID associated with a request. Using the example illustrated in FIG. 21 ‘User1’ is associated with ‘User request1’. This may indicate that ‘User1’ submitted the request ‘User request1’.

The request guide ID field 2120 includes information of a guide who is associated with a request. For example, if a guide obtains a search result responsive to the request ‘Request1’, an identifier of the guide may be indicated in the request guide ID field 2120. Likewise, if a guide is selected to respond to a request, an identifier of the guide may be indicated in the request guide ID field 2120. Information indicated in the request guide ID field 2120 may be used to obtain information associated with a guide using a record such as the guide record 2000 (FIG. 20). For example, access privileges of a guide may be obtained based on content of the guide access info field 2030, which may be used to determine a resource and/or parameters for display of information which is provided to the guide for responding to a request. Using the example illustrated in FIG. 21 the guides ‘Guide1’ and ‘Guide2’ have been associated with the request ‘Request1’. For example, ‘Guide1’ may have reviewed a user request and determined that the request required access to information indicated in a repository of redacted information associated with ‘User1’. The guide ‘Guide2’ may have been selected to respond to the request ‘Request1’ based at least in part on a ranking of guides associated with ‘Request1’. For example, information indicated in the profile ‘Profile1’ may be used to rank guides based on information indicated in the profile ‘Profile1’ and information indicated in a profile associated with a guide, and a guide may be selected based at least in part on a ranking of the guide associated with ‘Profile1’. In at least one embodiment, a guide may be selected based on access privileges associated with the guide. Using the example above, a guide with a higher level of access privileges, may be more likely to be selected to respond to a request for information associated with access to a repository of private information.

The request category ID field 2125 includes information of a category and/or keyword associated with a request. The content of the request category ID field 2125 may be modified by an automated classification of a request. For example, if a user submits a request to a particular communication service address, or if a request includes a keyword, the request may be associated with a category. In at least one embodiment, a short code, a phone number, a keyword, and/or a URL may be associated with a request for information indicated in a repository of private information. A human may select a category and/or keyword which is associated with a request. For example, a user and/or a guide may select a category which is associated with a request. A category may be associated with a resource such as a repository of redacted information. For example, the category ‘private information search’ may be associated with resources associated with a user indicated in the request ser ID field 2115. An item associated with a category may be presented to a guide and/or a user if a request associated with the category is submitted. A category may be associated with a request based on any type of information associated with a request. Using the example illustrated in FIG. 21, the category ‘Private information search’ is associated with the request ‘User request1’. This may indicate that ‘User request1’ requires a search of information indicated in a repository of redacted or private information.

The request profile ID field 2130 includes information of a profile which is associated with a request. For example, a profile may be associated with a request based at least in part on a profile associated with a user associated with a request. For example, a geographic profile which is common to one or more users associated with a request may be associated with a request, or a guide may determine that a profile is to be associated with a request based on the content or subject matter of a request associated with a user. A guide selected to respond to a request may be selected at least in part based on a profile associated with the request. In at least one embodiment, if a request is determined to require a search of a repository of private information, a profile associated with a request may be used to select a guide who is differentiated from a user and/or a guide who has previously searched a request for a user. For example, a guide with a location profile which is far from a location associated with a user may be preferentially selected. Using the example illustrated in FIG. 21, ‘Profile1’ is associated with ‘User request1’.

The request result ID field 2135 includes information of a result which is associated with a request. For example, a search result may be associated with a request when a guide obtains the search result responsive to the request. For example, if a request is submitted to the search system 1630 (FIG. 16), a guide may be selected, and the guide may provide a result responsive to the request. Alternately, a result may be associated with a request if the request is submitted to a resource such as a search engine, or other resource system. In at least one embodiment, a result may be associated with a request based on a match between a request and a database of previous requests. Any number of search results may be associated with a request. Using the example illustrated in FIG. 21, the result ‘Result1.1’, and the result ‘Result1.2’ have been associated with the request ‘User request1’. This may indicate that ‘Result1.1’ and ‘Result1.2’ have been provided to a user responsive to ‘User request1’.

As illustrated in FIG. 22, an exemplary a redacted data record 2200 is provided, of which one or more may be associated with or resident in the search database 1620 (FIG. 16). The redacted data record 2200 may include a redacted data ID field 2205, a redacted data guide ID field 2210, a redacted data description field 2215, a redacted data type field 2220, a redacted data content field 2225, and a redacted data content label field 2230.

The redacted data ID field 2205 preferably contains a unique identifier of a redacted data object, which is preferably used consistently. For example, in at least one embodiment, the redacted data ID field 2205 can include a randomly generated numerical code, and/or a text string indicating a name associated with a redacted data object. A redacted data ID serves to distinguish the redacted data record associated with a redacted data object from a redacted data record associated with other redacted data objects. Other unique identifiers of a redacted data object may be utilized without departing from the spirit and scope of the embodiments. In at least one embodiment, a redacted data ID may include a description associated with a redacted data object. Using the example illustrated in FIG. 22, ‘Private record1’ is the redacted data ID associated with the redacted data record 2200. Information indicated in the redacted data ID field 2205 may be used to ‘look up’ information associated with a redacted data object. For example, a keyword search which identifies content of the redacted data content field 2225 may be used to determine a redacted data record ID indicated in the redacted data record ID field 2205 which may be used to determine access privileges and information associated with the redacted data record.

The redacted data guide ID field 2210 may include information of a guide associated with a redacted data object. For example, a guide who has provided a search result based on information indicated in a redacted data object may be indicated in the redacted data guide ID field 2210. In at least one embodiment a guide ID associated with a guide who may have permission to access redacted data indicated in a redacted data record may be indicated in the redacted data guide ID field 2210. Information contained in the redacted data guide ID field 2210 may be used to obtain information regarding a guide associated with a redacted data object based on records such as the guide record 2100 (FIG. 21). Using the example illustrated in FIG. 22, the guide IDs ‘Guide1’;‘Guide2’ and ‘Guide3’ are associated with the redacted data ‘Private record1’ which may indicate that the guides ‘Guide1’;‘Guide2’ and ‘Guide3’ may have produced a search result which included information indicated in ‘Private record2’.

The redacted data description field 2215 may include information of a description of a redacted data object. For example, a text snippet associated with a search resource may be indicated in the redacted data description field 2215. A URL or other information associated with a redacted data object may be indicated in the redacted data description field 2215. Information contained in the redacted data description field 2215 may be used to provide a description of a redacted data object to a user and/or a guide. Using the example illustrated in FIG. 22, the text snippet ‘Contact info for Bob Jones’ is associated with the redacted data ‘Private record1’, which may indicate that ‘Private record1’ may include contact information associated with a person. The redacted information description field 2215 may be indexed by a search facility which is used to create an index of item or object which are included in a repository of redacted information. Information indicated in the redacted data description field 2215 may be provided to a user and/or a guide.

The redacted data type field 2220 may include type information associated with redacted data. For example, a description of an object may be indicated in the redacted data type field 2220. Information which may describe properties of redacted data may be indicated in the redacted data type field 2220. Information contained in the redacted data type field 2220 may be used to associate labels, or other information which may be exposed to a guide with content of a redacted data object by the search system 1630 (FIG. 16). Using the example illustrated in FIG. 22, the type ‘CSV contact information’ is associated with the redacted data ‘Private record1’. This may for example define one or more field labels which may be associated with content indicated in a redacted data record. While a specific description of a type of file has been used in FIG. 22 for the purposes of illustration and simplicity, no limitation is implied thereby. Any information required to provide information regarding a redacted data object may be indicated in the redacted data type field 2220. For example, access information to a resource may be provided, which may be used to access content of the resource while only an index of the resource is maintained for providing a search capability. For example, a user document repository might be located on a resource such as BaseCamp® or other collaboration tool. An index of keywords, categories, or any sort associated with documents included in a repository might be accessible to a guide and/or an automated search, but content of a document and/or complete text of the document might only be available to an authorized user.

The redacted data content field 2225 may include information regarding content, which may be associated with content labels indicated in the redacted data content labels field 2230. For example, information indicated in a field name indicated in the redacted data content labels field 2230 may be indicated in the redacted data content field 2225. In at least one embodiment, the content of the redacted data content field 2225 may be a pointer to information which is located in a resource such as the ‘Resource 3’ resource 1660 (FIG. 1). Using the example illustrated in FIG. 22, the text ‘Bob Jones’, ‘1921 Blissful Way’, ‘Indianapolis’, ‘Indiana’, and ‘46038’ is the redacted data content associated with ‘Private record1’. In at least one embodiment, the content of the redacted data content field 2225 may be linked by for example a pointer to the redacted data content labels field 2230, as described further herein below. Information indicated in the redacted data content field 2225 may not be provided to a guide, and/or may be conditionally provided to a guide, but may be provided to a user.

The redacted data content labels field 2230 may include information of a label associated with redacted data. For example, a label associated with a type of information which may be indicated in the redacted data content field 2225 may be indicated in the redacted data content labels field 2230. Using the example illustrated in FIG. 22, the labels ‘Name’, ‘Street Address’, ‘City’, ‘State’, ‘Zip Code’, ‘date of birth’, ‘Wife’, and ‘Children’. Are associated with ‘Private record1’. This may for example indicate that ‘Name’ is associated with ‘Bob Jones’, ‘Street Address’ is associated with ‘1921 Blissful Way’, ‘City’ is associated with ‘Indianapolis’, ‘State’ is associated with ‘Indiana’, ‘Zip Code’ is associated with ‘46038’ and that null (i.e. no content) is associated with ‘date of birth’, ‘Wife’, and ‘Children’. The relationship between labels indicated in the redacted data labels field 2230 and the content indicated in the redacted data content field 2225 may be used to locate redacted information based on a search terms which may identify matching records in a repository of redacted information. For example, a search for records with ‘State=Indiana’ might locate ‘Private record1’ based on an inverted index, and/or other index of items indicated in a repository of private information.

As illustrated in FIG. 23, an exemplary a result record 2300 is provided, of which one or more may be associated with or resident in the search database 1620 (FIG. 16). The result record 2300 may include a result ID field 2305, a result guide ID field 2310, a result redacted content info field 2315, a result resource ID field 2320 and a result review information field 2325.

The result ID field 2305 preferably contains a unique identifier of a result, which is preferably used consistently. For example, in at least one embodiment, the result ID field 2305 can include a randomly generated numerical code, and/or a text string indicating a name associated with a result. A result ID serves to distinguish the result record associated with a result from a result record associated with other results. Other unique identifiers of a result may be utilized without departing from the spirit and scope of the embodiments. In at least one embodiment, a result ID may include a description associated with a result. Using the example illustrated in FIG. 23, ‘Result1.1’ is the result ID associated with the result record 2300.

The result guide ID field 2310 may include information of a guide associated with a result. For example, a guide who obtained a search result may be indicated in the result guide ID field 2310. Information contained in the result guide ID field 2310 may be used to obtain information regarding a guide associated with a result based on records such as the guide record 2000 (FIG. 20). Using the example illustrated in FIG. 23, ‘Guide1’ is associated with ‘Result1.1’ which may indicate that ‘Guide1’ has provided ‘Result1.1’.

The result redacted content info field 2315 may include information of content of a result which may be exposed to a guide. For example, a text snippet associated with a result may be indicated in the result content info field 2315. The result content information field may indicate any type of information. In at least one embodiment, the content of the result redacted content info field 2315 may indicate pseudonymous and/or encrypted labels associated with redacted content which is provided to a user. Information indicated in the result redacted content info field 2315 may be presented to a user and/or may be incorporated in a future request as a place-holder to represent redacted content. In at least one embodiment, the result redacted content info field 2315 and the result content info field 2315 may be linked by for example a pointer. Using the example illustrated in FIG. 23, the result redacted content info ‘XXXX’ and ‘YYYY’ are associated with the result ‘Result1.1’ which may have been provided to ‘User1’ responsive to the request ‘User request1’as indicated in the request record 2100 (FIG. 21).

The result resource ID field 2320 may include information of a resource associated with a result. For example, a pointer to one or more records which indicate content of a redacted data record may be indicated in the result resource ID field 2320. Any type of information associated with a search resource may be indicated in the result resource ID field 2320. Information contained in the result resource ID field 2320 may be used to provide access to resource for a user, a guide and/or the search system 1630 (FIG. 16) using information indicated in a record such as the redacted data record 2200 (FIG. 22). Using the example illustrated in FIG. 23, ‘Private record1’ and ‘Private record3’ are associated with the result ‘Result1.1’. This may indicate that the resource “Private record1’ and ‘Private record3’ were used to obtain the search result ‘Result1.1’. While the example of multiple private records has been used for the purposes of illustration, no limitation is implied. Any number of public, restricted and/or private resources may be used to obtain a search result.

The result content info field 2325 may indicate information of a result which may be presented to a user. In at least one embodiment, the content of the result content info field 2325 may be linked to the result redacted content info field 2315. Using the example illustrated in FIG. 23, the content ‘Bob Jones’ and ‘Jane Doe’ are associated with the result ‘Result1.1’. This may indicate that ‘Bob Jones and Jane Doe’ will be provided to ‘User 1’ responsive to the query ‘Who do I know under 40 who lives in Indianapolis?’. This may further indicate that ‘XXXX’ may be used as a pseudonym for ‘Bob Jones’ and/or that ‘YYYY’ may be used as a pseudonym for ‘Jane Doe’.

As the repository of redacted information may include various types of files and objects, a search facility which may use cross-references between various files in order to assist a user in identifying information which may be redacted. For example, names which are associated with contacts included in a ‘.pst’ file might be identified within the body text of unstructured documents such as ‘.doc’ file. In such an instance a user might be offered the option of redacting those names in all instances in order that text of a ‘.doc’ file might be presented to a guide while the names of individuals, companies, etc., might be obscured. A user may be provided with various tools to determine types of information which may be revealed to a guide. A set of default conditions may be provided in order that a user may avoid the need for extensive effort to use functionalities of the system.

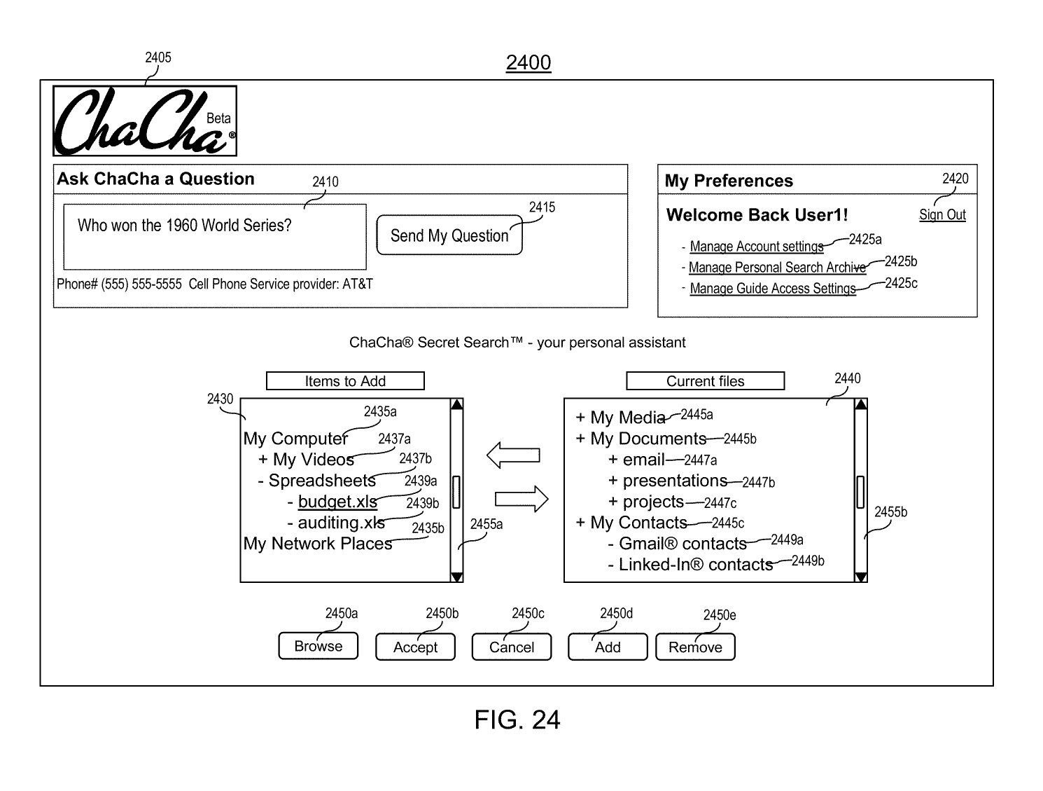

A GUI 2400 for designating information to be included in a repository of redacted information is illustrated in FIG. 24. The GUI 2400 may be presented to a user responsive to a user action which may indicate that a user elects to create and/or edit content of a repository of redacted information. The GUI 2400 may be displayed on a suitable display device of a user system such as the user system 1640 (FIG. 16). The GUI 2400 may include an advertising window 2405, a query submission box 2410, a search button 2415, a login control 2420, personal information selection controls 2425, a file addition window 2430, a current files window 2440, and action buttons 2450.

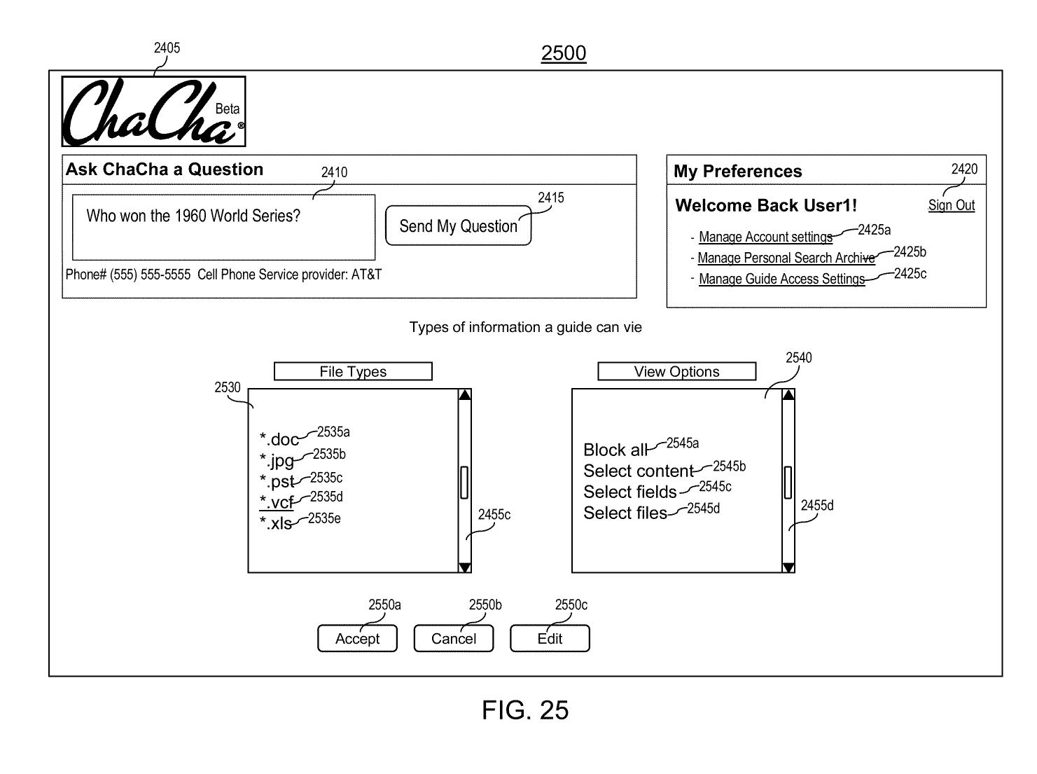

The advertising window 2405 may include an advertisement targeted to a user. The query submission box 2410 may be used to indicate a request for information. The search button 2415 may be used to submit a request for information. The logoff control 2420 may be used to log on or off of a search system. The personal information selection controls 2425 may be used to manage a personal data archive which may be searched by a guide. The ‘Manage Account Settings’ selection control 2425a may be used to select personal account information such as email, address, etc., which might be recorded in the user record 1900 (FIG. 19). The ‘Manage Personal Search Archive’ selection control 2425b may be used to cause the GUI 2400 to be provided. The ‘Manage Guide Access Settings’ selection control 2425c may be used to cause the GUI 2500 (FIG. 25) to be provided.

The file addition window 2430 may indicate information of files which a user may elect to add to a repository of redacted information. For example, ‘double-clicking’ the ‘My Computer’ file addition control 2435a may cause the files indicated in the resource ‘My Computer’ to be added to the repository and indexed by transferring the ‘My Computer’ indicator to the current files window 2440. Likewise, a user may expand the file addition control 2435 in order to access a file folder control such as ‘My Videos’ file folder control 2437a, or the ‘Spreadsheets’ file folder control 2437b. File indicators 2439 may be provided to select an individual file, such as the ‘budget.xls' file indicator 2439a and the ‘auditing.xls’ file indicator 2439b. The ‘My network places’ file addition control 2435b may be used to select a file located on remote storage. For example, photo, email, websites, etc., may be indicated using the ‘browse’ action control 2450a and the file addition control 2435b.

The current files window 2440 may indicate information of files currently associated with a repository of redacted information. The indexed file selection controls 2445 may be used to select any or all files included in a database of redacted information. The ‘My Media’ indexed file selection control 2445a may be used to select files associated with media such as audio, video, images, etc., which may be designated by any URL. Likewise, the ‘My Documents’ indexed file selection control 2445b may be used to select files associated with ‘My Documents’. Activation of the indexed file selection control 2445b may cause the indexed subdirectory indicators 2447 to be provided. The ‘email’ indexed subdirectory indicator 2447a may include a list of email files. The ‘presentations’ indexed subdirectory indicator 2447b may include a list of presentation files. The ‘projects’ indexed subdirectory indicator 2447c may include a list of project files. The ‘My Contacts’ current file selection control 2445c may be used to select files associated with contact information. The ‘Gmail’ indexed file indicator 2449a may include a list of Gmail® contacts. The ‘Linked-In’ indexed file indicator 2449b may include a list of Linked-In® contacts. Alternate controls and information display techniques which are well known in the art may be utilized for selecting and unselecting files as are well known in the relevant art. Individual files, and or groups of files may be added to and/or removed from a repository of redacted files which may be searched by a guide.

The action buttons 2450 may be used to take actions regarding information indicated in the file selection window 2430 and the current files window 2440. The ‘Accept’ button 2450b may be used to record changes and cause an index of files indicated in the current files window to be updated. The ‘Cancel’ button 2450b may be used to clear the content of the GUI without recording changes. The ‘Add’ button 2450c may be used to indicate that a file selected using the file addition controls 2435, the subdirectory selection indicators 2437, or the file indicators 2439 is to be added to the files indicated in the current files window 2440. The ‘Remove’ button 2450d may be used to indicate that file selected using the indexed file selection controls 2445, indexed subdirectory indicators 2447, or the indexed file indicators 2449 is to be removed from the files indicated in the current files window 2440. The navigation controls 2455a, 2455b may be used to navigate within the content of the file addition window 2430, and the current files window 2440.

A GUI 2500 for designating information to which is to be provided to a guide from a repository of redacted information is illustrated in FIG. 25. The GUI 2500 may be presented to a user responsive to activation of the personal information selection control 2425c. The GUI 2500 may be displayed on any suitable display device of a user system such as the user system 1640 (FIG. 16). The GUI 2500 may include an advertising window 2405, a query submission box 2410, a search button 2415, a login control 2420, a file type selection window 2530, file type selection controls 2535, a file options window 2540, file type option controls 2545, and action buttons 2550.

The advertising window 2405 may include an advertisement targeted to a user. The query submission box 2410 may be used to indicate a request for information. The search button 2415 may be used to submit a request for information. The logoff control 2420 may be used to log on or off of a search system. The personal information selection controls 2425 may be used to manage a personal data archive which may be searched by a guide. The ‘Manage Account Settings’ selection control 2425a may be used to select personal account information such as email, address, etc., which might be recorded in the user record 1900 (FIG. 19). The ‘Manage Personal Search Archive’ selection control 2425b may be used to cause the GUI 2400 to be provided. The ‘Manage Guide Access Settings’ selection control 2425c may be used to cause the GUI 2500 (FIG. 25) to be provided.

The file type selection window 2530 may indicate information of file types which a may exist in a repository of redacted information. In at least one embodiment, a list of supported file types is indicated in the file type selection window 2530. For example, activating the ‘.doc’ file type selection control 2535a may allow a user to view and/or edit options for exposing redacted information associated with ‘.doc’ files to a guide. The file type ‘.jpg’ may be selected using the file type selection control 2535b. The file type ‘.pst’ may be selected using the file type selection control 2535c. The file type ‘.vcf’ may be selected using the file type selection control 2535d. The file type ‘.xls’ may be selected using the file type selection control 2535e. If a file type selection control is activated, as indicated by the underline in the file type selector 2535d, the content of the file options window 2540 may be modified to reflect current options associated with the file type selected.

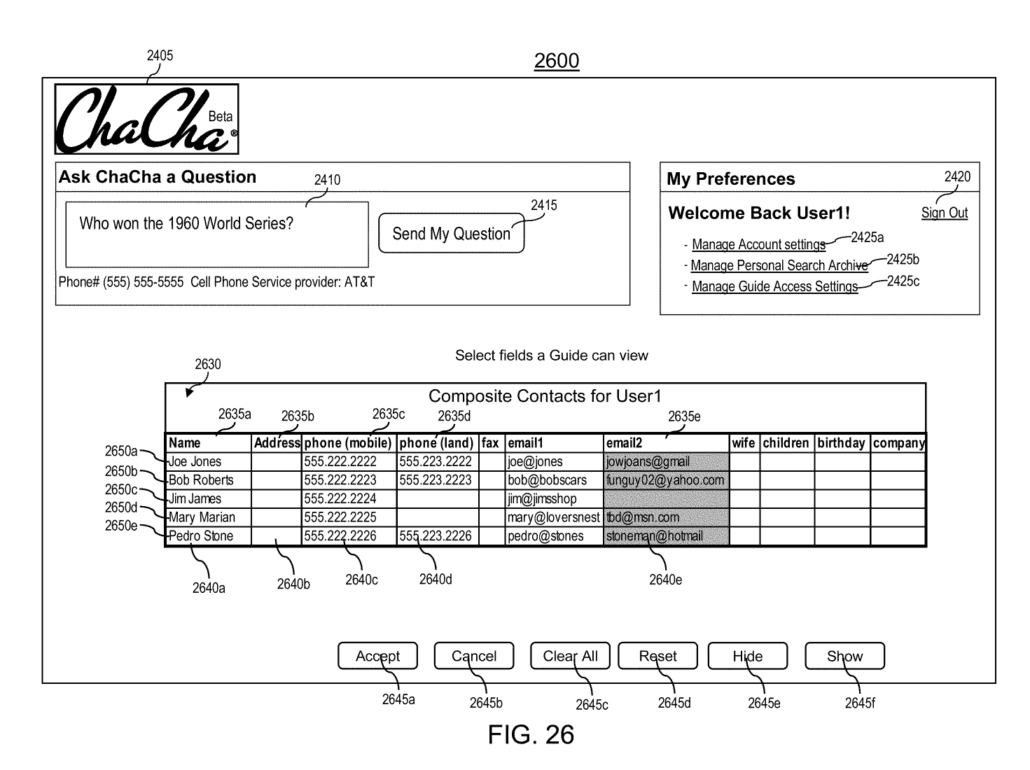

The file options window 2540 may indicate information of rules associated with a type of files included in a repository of redacted information. The file option selection controls 2545 may be used to create viewing rules associated with a type of file included in a database of redacted information. The ‘Block all’ file option selection control 2545a may be used to block all content associated with a type of file selected in the file type selection window 2530 from being viewed by a guide. Likewise, the ‘Select content’ file option selection control 2545b may be used to select to designate specific content of a file selected in the file type window 2530. For example, a GUI such as a text editor which may be used to designate any or all content of files currently associated with a repository of redacted data which is not to be revealed to a guide. The ‘Select fields’ file option selection control 2545c may be use to select the option to designate fields associated with a file or type of file indicated in the file type selection window 2530. For example, a GUI such as the GUI 2600 (FIG. 26) may be provided in order that a user may select types of data which may not be revealed to a guide. The ‘Select files’ file option selection control 2545d may be use to select the option to designate files associated with a file or type of file indicated in the file type selection window 2530. For example, a user may designate a group of files which are to be treated in a way which may be different than other files of the same file type.

The action buttons 2550 may be used to take actions regarding information indicated in the file type selection window 2530 and the file options window 2540. The ‘Accept’ button 2550a may be used to record changes associated with the GUI 2500. The ‘Cancel’ button 2550b may be used to clear the content of the GUI 2500 without recording changes. The ‘Edit’ button 2550c may cause a GUI for editing content which is to be revealed to a guide such as the GUI 2600 (FIG. 26) be presented.

A GUI 2600 for designating information to be revealed to a guide from information indicated in a repository of redacted information is illustrated in FIG. 26. The GUI 2600 may be presented responsive to various user actions. For example, subsequent to selection of an option in the GUI 2500 (FIG. 25), a user may be provided with the GUI 2600. The GUI 2600 may be displayed on a suitable display device of a user system such as the user system 1640 (FIG. 16). The GUI 2600 may include an advertising window 2405, a query submission box 2410, a search button 2415, a logoff control 2420, a content selection window 2630, field selection controls 2635, a field content windows 2640, record selection controls 2650, and action buttons 2645.

The advertising window 2405 may include an advertisement targeted to a user. The query submission box 2410 may be used to indicate a request for information. The search button 2415 may be used to submit a request for information. The logoff control 2420 may be used to log on or off of a search system. The personal information selection controls 2425 may be used to manage a personal data archive which may be searched by a guide. The ‘Manage Account Settings’ selection control 2425a may be used to select personal account information such as email, address, etc., which might be recorded in the user record 1900 (FIG. 19). The ‘Manage Personal Search Archive’ selection control 2425b may be used to cause the GUI 2400 to be provided. The ‘Manage Guide Access Settings’ selection control 2425c may be used to cause the GUI 2500 (FIG. 25) to be provided.

The content selection window 2630 may display information of content of a file indicated in a repository of redacted information. The field selection controls 2635 may be used to select content which is to be displayed or redacted based on index terms which are associated with the content. For example, the ‘Full Name’ field selection control 2635a may be used to designate that content associated with the label ‘Full Name’ is to be hidden or revealed to a guide. Likewise the field selection controls 2635b, 2635c, 2635d, and 2635e may be used to designate that content associated with the ‘Address’, ‘phone (mobile)’,‘phone (land), and ‘email2’ labels respectively may be hidden or revealed to a guide. The field content windows 2640 may be used to display the content of a field associated with a label indicated in the field selection controls 2635. For example, an alternate associated with each contact record is displayed in the field content window 2640e. Toggling the field selection control may change an indication that the information in a given field is to be revealed to a guide. For example, the shading in the field content window 2640e may indicate that the information indicated is not to be revealed to a guide. The record selection controls 2650 may be used to select individual records which may be revealed and/or hidden from a guide. For example the record selection control 2650a may be use to reveal and/or hide the content of the ‘Joe Jones’ record. Likewise, the record selection control 2650b may be use to reveal and/or hide the content of ‘Bob Roberts’ record. In this way individual records, and/or general types of information may be selectively blocked from access by a guide. Likewise, a single cell in the content selection window might be selected with a ‘click’ or other form of pointing.

The action buttons 2645 may be used to take actions regarding information indicated in the content selection window 2630. The ‘Accept’ button 2645a may be used to record changes associated with the GUI 2600. The ‘Cancel’ button 2645b may be used to clear the content of the GUI without recording changes. The ‘Clear All’ button 2645c may cause all content of the records indicated in the content selection window 2630 to be displayed. The ‘Reset’ button 2645d may be used to reset the rules for display of information indicated the content selection window 2630 to be returned to a default setting. The ‘Hide’ button 2645e may be used to hide the content of any item selected in the content selection window 2630. The ‘Show’ button 2645f may be used to unhide the content of any item selected in the content selection window 2630.

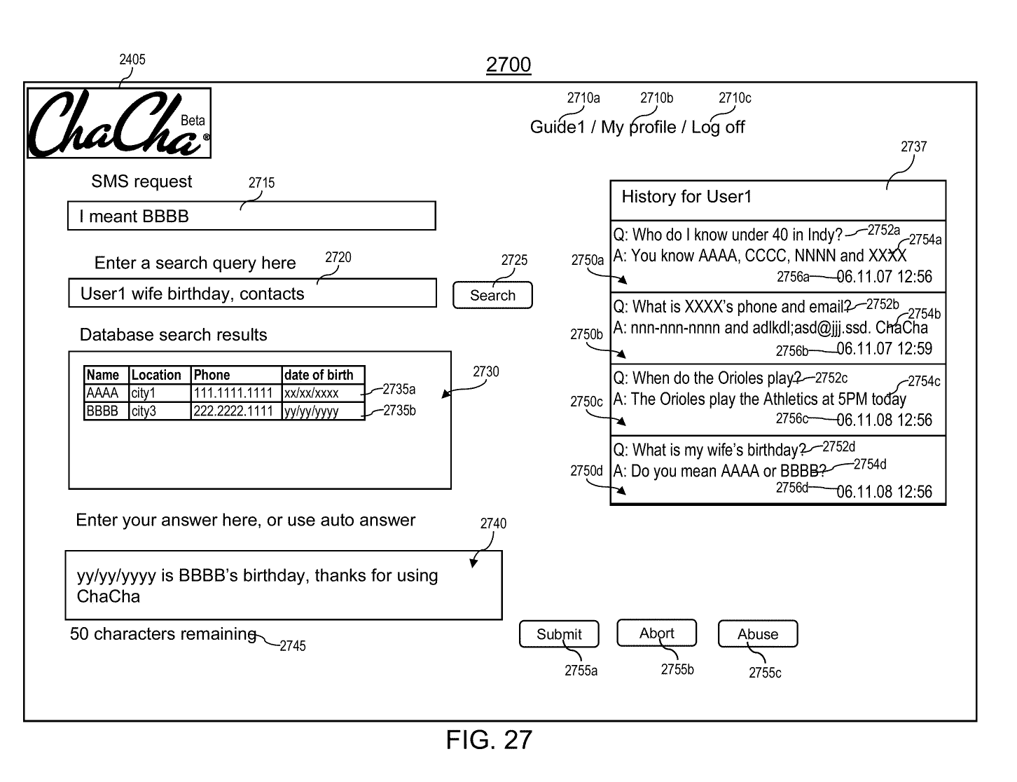

An exemplary GUI 2700 for performing a search by a guide is illustrated in FIG. 27. The GUI 2700 may be presented to a guide including upon receipt of a user request. The GUI 2700 may be displayed on a suitable display device of a guide system such as the guide system 1605 (FIG. 16). The GUI 2700 may include an advertising window 2405, guide activity controls 2710, a user request box 2715, a guide search query box 2720, search button 2725, a search result window 2730, search result indicators 2735, a search history window 2737, a guide result window 2740, a result constraint indicator 2745, a result transmit button 2750, and action buttons 2755.

The advertising window 2405 may include an advertisement targeted to a guide and/or a user. The guide activity controls 2710 may be used to select an activity by a guide. For example, the ‘Guide 1’ guide activity 2710a may cause a GUI (not shown) for viewing information associated with ‘Guide 1” to be presented. The ‘My profile’ guide activity control 2710b may be used to display personal and/or other information associated with a guide to be presented. The ‘Log off’ guide activity control 2710c may be used to log on or log off the search system 1630 (FIG. 16). The user request box 2715 may be used to indicate information associated with a user request. While a text message is used for the purposes of illustration, any type of information associated with a user request may be indicated in the user request box 2715. Using the example in FIG. 27, the request ‘I meant BBBB’ is displayed to a guide, which may be related to a previous response provided to a user as indicated in the search history window 2737.

The guide search query box 2720 may be used to indicate information of a search query which has been created by a guide responsive to a user request. Using the example illustrated in FIG. 27, the search query ‘User1 wife birthday, contacts’ which may have been entered by a guide responsive to the previous search request ‘What is my wife's birthday?’ as indicated in the user search history box 2737 and the new search request is presented in the guide search query box 2720. The search button 2725 may be used to execute a search responsive to a search query indicated in the guide search query box 2720. The search result window 2730 may be used to indicate a search result associated with a search request indicated in the guide search box 2720. The search result indicators 2735 may be used to indicate information associated with a search result presented in the search result window 2730. For example, the search result indicator 2735a indicates that the result ‘AAAA’ and ‘xx/xx/xxxx’ have been returned, and the search result indicator 2735b indicates that the result ‘BBBB’ and ‘yy/yy/yyyy’ have been returned. The search result indicators 2735 may allow a guide to copy ‘tokens’ which represent information indicated in a redacted record in order that the hidden information associated with the result may be provided to a user.

The search history window 2737 may be used to provide information of previous requests which may be associated with a user. Historical search information may be provided to a guide in order that context associated with a search is available to a guide who may not have responded to a previous request from a user. The historical query windows 2750 may be used to provide information of previous user activities. The historical query window 2750a indicates a query including information from a redacted record. The query indicator 2752 a displays an open query, and the response indicator 2754a indicates pseudonyms due to redacting of the identifiable information. The time stamp indicator 2756a indicates a time associated with the query. The historical query window 2750b indicates a query including information from a previous redacted record. The query indicator 2752b displays an encoded query, and the response indicator 2754b indicates pseudonyms due to redacting of the identifiable information. The time stamp indicator 2756b indicates a time associated with follow-up the query. The historical query window 2750c indicates a query which does not include information from a redacted record. The query indicator 2752c displays an open query, and the response indicator 2754c indicates a plain text response. The time stamp indicator 2756c indicates a time associated with the open query. The historical query windows 2750 may be used to provide information of previous user activities. The historical query window 2750d indicates a query including information from a redacted record. The query indicator 2752d displays an open query, but the response indicator 2754d indicates pseudonyms due to redacting of the identifiable information. The time stamp indicator 2756d indicates a time associated with the query.

The guide result window 2740 may be used to indicate information associated with a search result which has been prepared by a guide. The result constraint indicator 2745 may be used to indicate any constraints which may be placed on a search result which is indicated in the guide result window 2740. In at least one embodiment, selection of a search result indicator 2735 may cause an answer to be automatically generated in the guide result window 2740. For example, activation of the search result indicator 2735b may cause the message indicated in the guide result window 2740 to be generated. The action buttons 2755 may be used to various actions. The ‘Submit’ action button 2755a may be used to send a result to a user. The ‘Abort’ action button 2755b may be used to transfer a request to a different guide. The ‘Abuse’ button 2755c may be used to report inappropriate queries or actions by a user to system administrators.

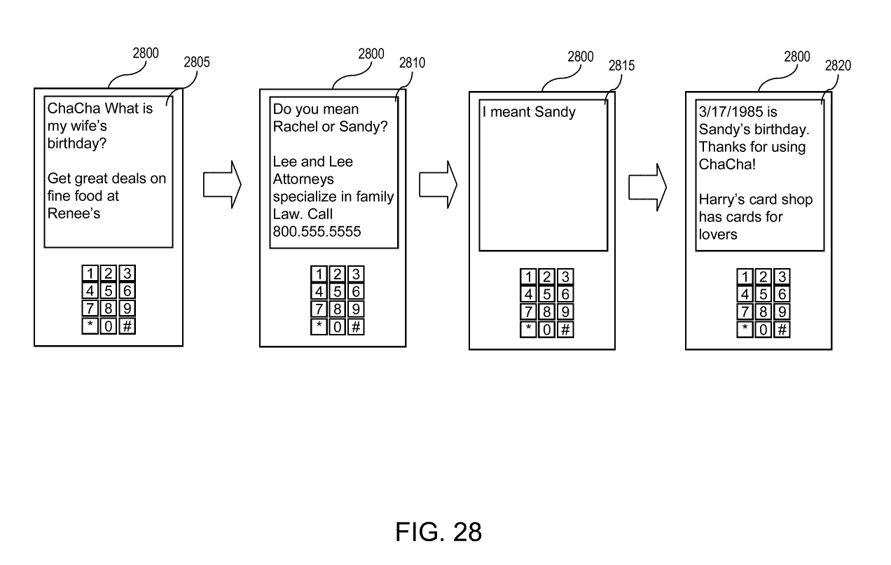

An exemplary sequence of messages between a user device and the system 1630 (FIG. 16) is illustrated in FIG. 28. Referring to FIG. 28, a user device 2800 may include a display device. A first user message 2805 is provided by the user. The first user message 2805 may include a request for information which may be indicated in a repository of redacted or private records. The search system 1630 (FIG. 16) may respond with a clarification request message 2810. The clarification request message 2810 may include decrypted information based on tokens selected by a guide (i.e. ‘Rachel’ and ‘Sandy’). The user device 2800 may respond with a user clarification message 2815. The user clarification message may include a name which is equivalent to the decrypted name (i.e. ‘Sandy) which is encrypted prior to being presented for use by a guide. If a result is located, the search system 1630 may reply with a conclusive response message 2820. The conclusive response message 2820 may include information included in a redacted portion of a record (i.e. ‘3/17/1985’ and ‘Sandy’) which are provided without being revealed to a guide.

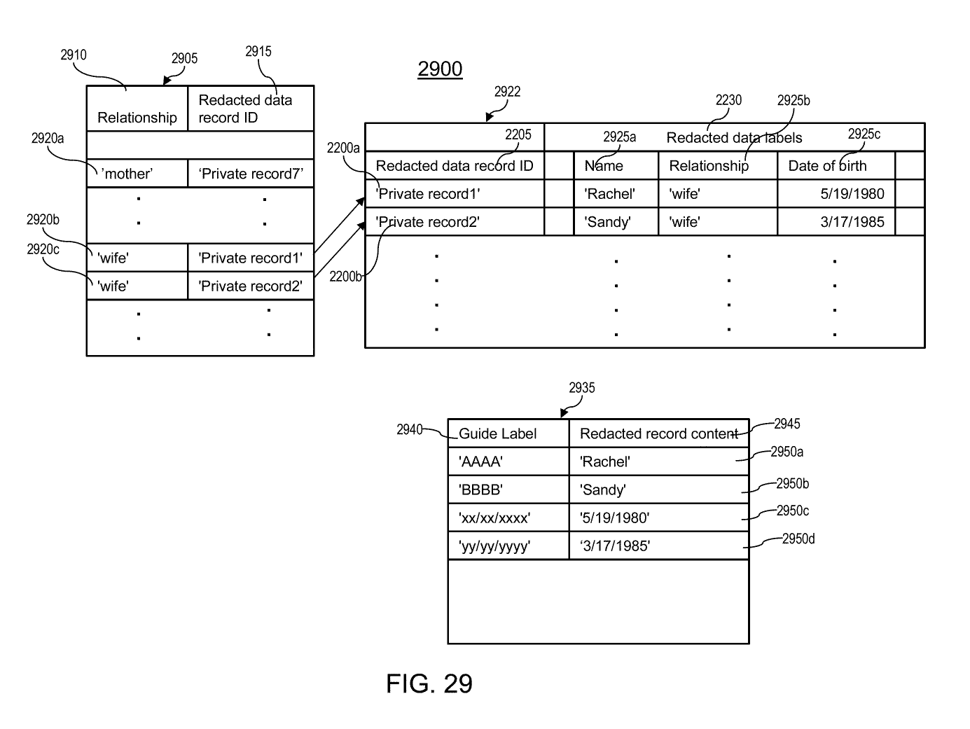

A database relationship 2900 for identifying information indicated in a redacted data record is illustrated in FIG. 29. An index table 2905 may be created which includes a label field 2910, and a redacted data record ID field 2915. The ‘Relationship’ label field 2910 may be associated with content in a redacted data label indicated in the redacted data labels field 2230 (FIG. 22) of the redacted data record table 2922 which may be composed of one or more redacted data records such as the redacted data records 2200a, 2200b. The content of the label field 2910 may be sorted, and a match between a search request such as the guide search request indicated in the guide search query box 2720 (FIG. 27) may be used to ‘look up’ a redacted data record ID indicated in the redacted data record ID field 2915. For example the look-up record 2920a indicates that ‘mother’ is associated with ‘Private record7’. The lookup record 2920 b and the lookup record 2920 c indicate that ‘wife’ is associated with ‘Private record1’ and ‘Private record2’, respectively. As multiple records may be associated with a match, the content of the redacted data records 2200a, 2200b may be encoded using a cross reference table 2935 and presented to a guide. The cross reference table 2935 may be used to match keywords of a user request in order that redacted data indicated in a user request may be encoded and not revealed when it is presented to a guide. The guide label field 2940 may indicate content which is to be presented to a guide. The redacted record content field 2945 may indicate content of a redacted record which may be presented to a user if a guide selects the corresponding content indicated in the guide label field 2940.

Content of fields which were not the subject of a specific search parameter of redacted data records which are selected using the index table 2905 may be encoded in order that information of the redacted data record may be presented to a guide. Using the example illustrated, the content of the ‘Relationship’ label field 2925b is matched as it was the subject of the query ‘relationship=wife’, and it is not encoded. The content of the ‘Name’ label field 2925a and the ‘date of birth’ label field 2925c is encoded in order that it may be presented to a guide if a follow-on request is received from a user.

While a simple example has been used for the purpose of illustration, no limitation is implied thereby. Any number and/or types of files may be identified, indexed and searched using the assistance of a guide. A user may select to reveal as much or as little information as may be desired.

A system is disclosed whereby a user may create and edit a repository of redacted information which may be searched using the assistance of a human guide. A user is registered with a search system, and may designate one or more files which are to be indexed in order that the user may access information indicated in the file using a human assistant without revealing the content of the redacted data explicitly to a guide.

If a request is determined to require access to a repository of redacted information a guide is selected to respond to the request. A guide may query a database which indicates content of redacted data records in order to obtain a search result. Information which a user has designated as hidden or ‘redacted’ may be encoded in order to obscure the actual content form a guide. The encoding may be used to provide the actual content of a redacted record to a user as a guide may select a corresponding label from a guide search result which may be sent to a user. User interfaces, data structures, and a system embodiment are described.

Any or all of the operations described herein may be implemented via one or more hardware components. However, the present invention is not limited to any specific implementation of an operation. For example, one or more operations discussed herein may be implemented via software executed on a device while others may be executed via a specific hardware device.

The present invention may be implemented using a program stored, for example, in a computer-readable storage medium such as a CD-ROM, etc., or using one or more specialized terminals, devices or systems that is enabled to execute operation(s) described herein. The storage or recording medium used in an embodiment can be selected from among various computer-readable media including, a disk, a DVD, an internal storage device (memory such as RAM or ROM) in a computer, etc.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A computer-implemented method of facilitating a purchase, comprising:
registering a user in association with a vendor;
registering the user in association with a search system;
receiving a request from the user at the search system;
determining whether the request is a purchase request;
selecting an item from the vendor based on the request; and
completing a purchase of the item from the vendor.

2. The method of claim 1, further comprising:
determining by a human assistant who is independent of the user whether the request is the purchase request.

3. The method of claim 1, further comprising:
selecting a human assistant who is independent of the user.

4. The method of claim 1, further comprising:
selecting the vendor based on a category associated with the request; and
selecting an item from the vendor by a human assistant who is independent of the user.

5. The method of claim 1, further comprising:
performing an information search in parallel with a purchase transaction.

6. The method of claim 1, further comprising:
completing the purchase using stored information of the user which is not revealed to a human assistant who selects the item.

7. The method of claim 1, further comprising:
receiving the request as an SMS message; and
registering the user with the search service using an SMS message.

8. The method of claim 1, further comprising:
registering a human assistant with the vendor; and
providing access to a resource associated with the vendor to the human assistant.

9. The method of claim 1, further comprising:
selecting a human assistant who is independent of the user;
determining by the human assistant whether the request is a request for purchase;
selecting the vendor based on a category associated with the request;
selecting an item from the vendor by the human assistant;
performing an information search in parallel with a purchase transaction;
completing the purchase using stored information of the user which is not revealed to the human assistant selecting the item;
obtaining the stored information from a repository indicated by the user;
receiving the request as an SMS message;
registering the user using an SMS message;
registering the human assistant with the vendor;
providing access to a resource associated with the vendor to the human assistant; and
selecting, by the human assistant, the item using the resource.

10. A system, comprising:
a search service device registering a user, receiving a request, communicating with a guide device, a vendor device, and a user device and providing a response to the request;
a user device submitting a query;
a vendor device fulfilling a purchase request; and
a database recording information of queries, guides, users, vendors, and purchases.

11. The system of claim 10, further comprising:
a guide device for selecting an item and responding to the query.

12. A computer readable storage medium storing therein a program for causing a computer to execute an operation including optimizing usage of providers, comprising:
obtaining by a supplier a unique identifier of a user;
sharing by the supplier information associated with the unique identifier with a search service;
receiving a query by the search service;
selecting a guide using content of the query;
determining whether the query indicates a desire to acquire an article;
transmitting at least a portion of the query to the guide; and
selecting the article associated with the supplier.

13. The computer readable medium of claim 12, comprising:
delivering, by the search service, a request to acquire the article;
acquiring the article from the supplier; and
providing the article to the user.

14. The computer readable medium of claim 12, wherein the query is at least one of an SMS message, a voice message, an Instant Message, and a web form.

15. The computer readable medium of claim 12, wherein said determining is executed by the guide, and the operation further comprises:
selecting a purchase specialist who is independent of the guide;
choosing by the purchase specialist the article;
obtaining by the purchase specialist information of a payment method; and
acquiring the article using the payment method.

16. The computer readable medium of claim 13, wherein the request is provided by an API associated with the supplier.

17. The computer readable medium of claim 13, comprising:
selecting the guide based on a ranking of the guide associated with a purchase transaction;
selecting the supplier based on content of the query and a ranking of the supplier associated with a purchase transaction;
selecting a purchase assistant based on an action of the guide; and
selecting the article based on a choice by the purchase assistant.

18. The computer readable medium of claim 12, comprising:
obtaining information from the user;
receiving an indication of an element of the information which is obscured;
obtaining by the guide a search result which includes the element;
providing information of the element to the user; and
providing the element to the supplier based on an action of the user.

19. The computer readable medium of claim 18, comprising:
indicating a type of element which is obscured;
indicating a keyword which is obscured;
indicating a trustee who may view the element;
providing information of the element to the trustee; and
providing information of the element to the supplier based on an action of the trustee.

20. The computer readable medium of claim 12, wherein the query is at least one of an SMS message, a voice message, an Instant Message, and a web form, the request is provided by an API associated with the supplier and the operation further comprises:
delivering by the search service a request to acquire the article;
providing the article to the user;
determining by the guide whether the query indicates a desire to acquire the article;
selecting a purchase specialist who is not the guide;
choosing by the purchase specialist the article;
obtaining by the purchase specialist information of a payment method;
acquiring the article using the payment method;
selecting the guide based on a ranking of the guide associated with the query;
selecting the supplier based on content of the query and a ranking of the supplier associated with a purchase transaction;
selecting a purchase assistant based on an action of the guide and a ranking of the purchase assistant;
selecting the article based on a choice by the purchase assistant and a ranking of the article;
obtaining information from the user;
receiving an indication of an element of the information which is obscured;
obtaining by the guide a search result which includes the element;
providing information of the element to the user;
providing the element to the supplier based on an action of the user;
wherein the information is a payment method, a user name, an address, a telephone number, and a password.

21. A computer-implemented method, comprising:
linking an existing account information of a user associated with a first provider with information for a second provider; and
implementing a purchase from the second provider using the account information during a search conducted in response to a search request from the user.
